(19) United States
(12) Patent Application Publication
(10) Pub. No.: US 2026/0362085 A1
(43) Pub. Date: Nov. 12, 2026

(54) SYSTEM AND METHOD FOR TEMPORALLY SEGMENTED PREDICTION OF VENUE ATTENDANCE PATTERNS FOR FACILITATION OF IN-PERSON SOCIALIZATION

(71) Applicant: Z GUIDE LLC

(72) Inventors: Roberto ZAYAS; Niraj KUMAR; Mariia KAPINOS

(21) Appl. No.: 19/651,575

(22) Filed: Apr. 17, 2026

Related U.S. Application Data
(63) Continuation-in-part of application No. 19/647,801, filed on Apr. 14, 2026.
Application No. 19/647,801 is a continuation of application No. 18/370,860, filed on Sep. 20, 2023, now abandoned.
(60) Provisional application No. 63/408,347, filed on Sep. 20, 2022.

(51) Int. Cl. H04W 4/021; G06Q 10/42; H04L 67/306

(52) U.S. Cl. CPC H04W 4/021; G06Q 10/42; H04L 67/306

(57) ABSTRACT

Disclosed are a platform and related service that provide users location information, both historical and real-time, of social prospects a user desires to meet in person. A user searches for potential social prospects based on desired characteristics, and results are presented as establishments and social prospects matching those characteristics. Identified establishments may be assigned a composite rating score comprising an objectively quantifiable component and a subjectively quantifiable component, the latter derived from ratings submitted by similarly situated users and weighted according to temporal and seasonal conditions. The platform maintains leaderboard data structures ranking users by a computed popularity score within one or more geographic regions, filterable by socialization category, with higher-ranked users able to monetize access to their profiles. Additional features include hotspot establishment identification, direct messaging for in-person meeting planning, a service worker availability designation, establishment verification, and continuous temporally segmented updating of the platform's scoring and inference models.

### PRIORITY CLAIM AND RELATED APPLICATIONS

This application is a continuation-in-part of U.S. Non-Provisional Patent Application No. 19/647,801 filed Apr. 14, 2026, U.S. Non-Provisional Patent Application No. 18/370,860, filed Sep. 20, 2023, which claims the benefit of priority to U.S. Provisional Patent Application No. 63/408,347, filed Sep. 20, 2022, the content of which are incorporated herein by reference in their entirety.

### TECHNICAL FIELD

The present disclosure relates in general to the field of in-person social networking, and more particularly to a platform and related service or process for providing location information, both historical and real-time, of social prospects for users.

### BACKGROUND

For many years, social media applications, social networking websites, and messaging applications have been created to assist people to interconnect with other people with whom they presumably have some common interest(s). Typically, such conventional platforms and services function by having users of the platform or service create a profile that includes a number of details about themselves and their interests in the hope that other users find them when searching for such characteristics. Similarly, on other conventional platforms or services, the user searches for potential social prospects based on their desired search criteria. Thus, “matches” between users and potential social prospects are provided based on matching one or more such characteristics and/or interests. Moreover, such searches may also be limited to potential social prospects that are within a geographically desirable area of the searching user.

However, in such conventional platforms or services, communication or even meeting potential social prospects is limited to those situations where matching prospects agree to have direct contact with the searching user, typically via the platform or service. As a result, a searching user can only “meet” potential social prospects if they reply to attempts by the searching user to contact them. Accordingly, what is needed in the art is a socialization platform or related service that permits users to not only search for potential social prospects that match the searching user’s desirable criteria, but also provides a searching user a means for determining where potential social prospects could be located so that they can meet them in person without the requirement that prospects first communicate with the user. The disclosed principles provide such a socialization platform or service.

### SUMMARY

In order to overcome the deficiencies of the prior art, the disclosed principles a platform and related service that provide users location information, both historical and real-time, of social prospects, who are other users of the platform or service, a searching user desires to meet. Using a platform or service, a searching user may search for potential social prospects based, at least in part, on characteristics desirable to a searching user. Search results may be presented to a searching user in the form of establishments/locations historically and/or currently having social prospects that match some or all of a searching user’s desired characteristics for their social prospects. Search results may be alternatively presented to a searching user in the form of social prospects that match some or all of a searching user’s desired characteristics for their social prospects, and who are currently located at an establishment. As used herein, the term “social prospect” means any person whom a user desires to meet in-person for any of a number of social-based reasons. These may include, but are not limited to, one or more people a user seeks to meet for romantic reasons, business reasons, friendly reasons, etc. Thus, the term social prospect is not intended to be limited to a particular person, gender, occupation, age, race, religious, sexual orientation, etc., but instead is intended to be broad enough to encompass any person who is capable of meeting in-person with a user.

Search results may be filtered using a unique rating factor pertaining to how likely or unlikely social prospects matching a searching user’s desired characteristics will be or are at a specific location. This rating factor may be comprised, for example, of an objective component based, at least in part, on data gathered by a platform or service pertaining to characteristics desired by a searching user of social prospects at a specific location, and a subjective component based, at least in part, on data provided by other users of the platform or service also pertaining to those characteristics desired by a searching user of social prospects at a specific location. As a result, this rating factor may change based, at least in part, on specific characteristics of social prospects a specific user is searching for based, at least in part, on the density of prospects at a specific location that match those specific characteristics.

In one or more embodiments, a platform may maintain one or more leaderboard data structures ranking users by a computed popularity score within one or more geographic regions. A popularity score may be based, at least in part, on profile access demand, frequency of appearance in search results, community-contributed ratings, or the like. A leaderboard may be filtered according to one or more socialization categories, such as friendship, business networking, romance, etc. Higher -ranked users may designate their profile and/or associated network as monetized, conditioning access thereto upon payment of a user-specified fee.

In one or more embodiments, a rating factor described herein may comprise a first score and a second score. A first score may comprise a substantially objectively quantifiable value derived from artificial intelligence analysis, third-party data inputs, or the like. A second score may comprise a substantially subjectively quantifiable value derived from ratings submitted by users whose personal characteristics and/or socialization preferences correspond to those of a searching user, weighted according to temporal and/or seasonal conditions under which a particular rating was submitted.

In one or more embodiments, a platform may identify hotspot establishments at which a concentration of matching users are currently present, predicted to be present, and/or have historically been present during comparable temporal periods, and may present such establishments to a searching user with elevated prominence. A platform may additionally support direct messaging between users comprising invitations to meet in person at a specified establishment, date, and time, as well as a service worker designation where a user may publish a schedule of upcoming availability at one or more establishments without disclosing personally identifiable information (PII). New establishments may be added to a platform through an onboarding and/or verification process prior to inclusion in search results and/or composite score calculations. A platform's computational inference model and/or composite score calculations may be continually updated based, at least in part, on incoming data in a temporally segmented manner, preserving the integrity of time-specific behavioral patterns across different search conditions.

### BRIEF DESCRIPTIONS OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 illustrates a system-level block diagram of a social networking system 100 in accordance with an embodiment of the disclosed principles;

FIG. 2 illustrates a screen view of a login screen 200 for a platform or service in accordance with an embodiment of the disclosed principles;

FIG. 3A illustrates a screen view of an account screen 300A for a platform or service in accordance with an embodiment of the disclosed principles;

FIG. 3B is a screen view illustration of a personal profile screen 300B for a platform or service in accordance with an embodiment of the disclosed principles;

FIG. 3C is a screen view illustration of a social media account screen 300C for a platform or service in accordance with an embodiment of the disclosed principles;

FIG. 4 is a screen view illustration of a user interface having a search screen 400 for a platform or service in accordance with an embodiment of the disclosed principles;

FIG. 4A is a screen view illustration of an additional search criterion 400A that may be include with a search screen 400 such as the screen of FIG. 4;

FIG. 5 is a screen view illustration of a search result detail screen 500, which may be among the results of a search conducted using the user interface of FIG. 4;

FIG. 6A is a screen view illustration of a Check In feedback screen 600A that may be employed by a user of a platform or service in accordance with an embodiment of the disclosed principles;

FIG. 6B illustrates a screen view of an additional Check In screen 600B;

FIG. 7A is a screen view illustration of a User Management screen 700A accessible by an administrator of a platform or service in accordance with an embodiment of the disclosed principles;

FIG. 7B is a screen view illustration of a Location Data Feed screen 700B accessible by an administrator or user of a platform or service in accordance with an embodiment of the disclosed principles;

FIG. 7C is a screen view illustration of a close up view 700C of a dropdown menu for selecting an establishment type from the Location Data Feed screen of FIG. 7B;

FIG. 7D is a screen view illustration of an Establishment Sub-Type selection screen 700D;

FIG. 8 is a screen view illustration of a Promoted Locations screen 800 accessible by a user of a platform or service in accordance with an embodiment of the disclosed principles;

FIG. 9 illustrates a block diagram of a social networking system 900 incorporating a platform or system in accordance with an embodiment of the disclosed principles;

FIG. 10 illustrates a block diagram of a social networking system database 1000 for use with a platform or service in accordance with an embodiment of the disclosed principles;

FIG. 11 illustrates a block diagram of a social networking location database 1100 for use with a platform or service in accordance with an embodiment of the disclosed principles;

FIG. 12 illustrates a block diagram of a social networking user database system 1200 for use with a platform or service in accordance with an embodiment of the disclosed principles;

FIGS. 13A-13C illustrate example screenshots of various account login and signup options from a mobile device application for use with a platform or service in accordance with the disclosed principles;

FIG. 14A illustrates an example screenshot from a mobile application of an interactive map presenting establishments matching search criteria of a user of the mobile application;

FIG. 14B illustrates an example screenshot from a mobile application of a list of establishments matching search criteria of a user of the mobile application;

FIG. 15A illustrates an example screenshot from a mobile application of an interactive map presenting social prospects matching search criteria of a user of the mobile application;

FIG. 15B illustrates an example screenshot from a mobile application of a list of social prospects matching search criteria of a user of the mobile application;

FIG. 16A illustrates an example screenshot from a mobile application of details associated with a single establishment matching search criteria of a user of the mobile application, and selected by the user;

FIG. 16B illustrates an example screenshot from the mobile application of FIG. 16A of a detailed “Check In” screen of the mobile application;

FIG. 16C illustrates an example screenshot from a mobile application of a “Check out” feature associated with a single establishment matching search criteria of a user of the mobile application;

FIG. 17 illustrates an example screenshot from a mobile application presenting a user of the mobile application an option to integrate one or more social media profiles of the user;

FIG. 18 illustrates an example screenshot from a mobile application presenting a user of the mobile application an option to have an Artificial Intelligence engine determine profile details on behalf of the user;

FIG. 19 illustrates an example screenshot from a mobile application presenting a user of the mobile application selection options from available search criteria for finding social prospects;

FIG. 20 illustrates an example screenshot from a mobile application of the profile page of the user of the application who has checked in at a particular establishment;

FIG. 21 illustrates an example screenshot from a mobile application of a QR Code associated with the user of the mobile application;

FIG. 22 illustrates an example screenshot from a mobile application presenting the user of the mobile application a profile of a social prospect matching the search criteria of the user as well as their current location at an establishment;

FIG. 23 illustrates an example screenshot from a mobile application presenting the user of the mobile application a public profile of the social prospect of FIG. 22; and

FIG. 24 illustrates an example screenshot from a mobile application of a messaging feature for the user of the mobile application to communicate with potential social prospects associated with a platform or service as disclosed herein.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized, in whole or in part. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

### Overview

As discussed above, example embodiments of the disclosed principles provide platforms and services that allow a user to provide search criteria for the type of person or persons he or she would like to meet in-person. For example, if a user would like to meet females that are single, within a desired age range, of a selected ethnicity and/or race, and within a selected geographic location, a platform or service as disclosed herein may provide a geographic display of locations within a selected geographic search area having a concentration of people who meet the user’s search criteria. Moreover, a disclosed platform or service may provide temporal search results to a user, such as when people matching the user's search criteria would be (or have been) at geographic locations within the user’s search area. A user may thus use such search results to travel to presented locations previously or currently having a concentration of such matching people, thus increasing the likelihood that a user will be able to meet matching people in person.

In example embodiments, users employ an application executing on a particular user’s mobile device, where this plurality of mobile applications are in communication with a centralized platform. In some embodiments, one or more users may instead communicate with a centralized platform via a network interface, such a web browser executing on a user’s computing device and communicating with the platform via a computer network such as the internet.

The disclosed principles, embodied in a platform or service, leverage databases of personal information corresponding to search parameters of users to provide geographic locations of people matching selected search parameters, thus ensuring users may meet such matched people in person at revealed locations. This could include searching for potential social prospects that not only include possible dating or other romantic interest, but could also include search for prospects for business purposes, searching for playmates for a user’s children, searching for prospects who have similar interests in a sport or activity, and any other type of social prospect. As mentioned above, large numbers of databases exist that store demographic data of individual people. While a number of databases exist that provide general data such as a person's name, gender, address, and telephone number, there are also databases that store much more personal demographic data that are not typically used by conventional computer-based platforms, systems, services, or the like. Such more atypical demographic data includes people’s age, income, marital status, prior marital history, race, ethnicity, height, weight, body dimensions, body-mass index, hair color, eye color, skin color, religious affiliation, occupation, number of children, credit score, income, outstanding debt, debt to income ratio, property ownership, involvement in past or present legal proceedings and in what capacity, judgements against, judgements in favor of, and other more personal details than the typical data used by conventional systems and services. The disclosed principles can employ all such databases having personal information regarding potential social prospects that a user may want to meet if they match most or all of a user’s desired characteristics.

In one or more embodiments, a host application of a platform and/or service may, for example, electronically process one or more digital signals to generate a plurality of in-memory configurations that may be maintained in one or more processors and/or memory devices associated with the platform. A plurality of in-memory configurations may include at least a plurality of first in-memory configurations, for example, and a plurality of second in-memory configurations. A first in-memory configuration may comprise, for example, a corresponding first set-data structure having a respective first collection of elements specific to an on-line representation of an off-line individual identity, such as, for example , a digital user profile corresponding to a real-world person. A second in-memory configuration may comprise, for example, a corresponding second set-data structure having a respective second collection of elements specific to an on-line representation of an off-line establishment identity, such as, for example, a digital establishment profile corresponding to a real-world venue and/or location. As used herein, the terms “first in-memory configuration” and “user profile” may be used interchangeably, as may be the terms “second in-memory configuration” and “establishment profile.” A first collection of elements associated with a first in-memory configuration may include personal characteristics of a corresponding individual, such as, for example, age, gender, interests, socialization preferences, and/or other identifying and/or descriptive attributes. A second collection of elements associated with a second in-memory configuration may include socialization characteristics of a corresponding establishment, such as, for example, venue type, atmosphere, historical attendance patterns, and/or other attributes that may be relevant to social matching.

A structured string of values comprising one or more input parameters may be received from a requesting remote user device via a communications network in connection with a requesting first in-memory configuration, i.e., a user profile of a searching user. One or more input parameters may include one or more personal characteristic parameters reflecting desired characteristics a searching user seeks in potential social prospects or establishments, and may optionally include one or more temporal parameters, such as a desired date, time, day of week, etc. A structured string of values may correspond to what is described herein as an electronic search query submitted by a searching user via their remote user device.

However, many of these demographic details are precisely the details that people may want to know when looking to meet people in-person in a social situation. Importantly, many of these demographic details are the details that many people will tend to lie or exaggerate about in an effort to broaden their chances of meeting other people that meet their own search criteria, even though that might be inconsiderate of the desires of people they are hoping to meet. In other cases, some potential prospects or targets may simply have an unrealistic self-view. As a result, if such more personal demographic details were objectively verifiable, then the likelihood that a user meets someone actually matching the criteria they are searching for may be increased, and in many cases guaranteed.

Additionally, the disclosed principles can further leverage real-time feedback data to provide additional accuracy or specificity in search results provided via a platform or service. In one embodiment, feedback may be provided, for example, by users in order to confirm that search results provided to a user are accurate. In such embodiments, a user/reviewer may provide real-time information to a platform or service as disclosed herein, such as through their mobile application or via a website affiliated with a platform or service. Also, such users may be specially designated as authorized reviewers by a platform as disclosed herein; however, in other embodiments such reviewers are simply random and voluntary. In some embodiments, such reviewers may actually be “targets” that users are hoping to meet using the disclosed principles. In such embodiments, these reviewer/targets matching a user’s search criteria can confirm that they are at a location provided to a searching user through the disclosed principles. Confirmation of a feedback provider’s location may also be confirmed using geolocation. For example, geolocation data provided by a provider’s mobile device executing a mobile application associated with a disclosed platform or service can provide such confirmation of geographic location, as well as a provider’s location at a time they are providing feedback. In some embodiments, provider(s) of feedback to a platform or service may be one or more of the locations that are searchable by querying users of the platform or service, such as provided by agents affiliated with specific locations.

In some embodiments employing data provided by such various types of reviewers, a feedback interface accessed by such a reviewer may present predetermined demographic fields to which a reviewer provides information. Also, demographic data may be provided for several categories of people. For example, for a category such as “females”, demographic data that may be provided by a reviewer could include the age, race, ethnicity, body size, style of dress, attractiveness, etc. that a particular reviewer perceives of the “females” he or she actually sees at that location. Similarly, for a category of “males”, demographic data that may be provided by a reviewer could include the age, race, ethnicity, body size, style of dress, attractiveness, etc. that a particular reviewer perceives of the “males” he or she actually sees at that location. In this respect, a platform or service in accordance with the disclosed principles may employ subjective data to assist in providing accurate search results to users. Additionally, the actual number, or an estimate thereof, of “females” or “males” a reviewer actually sees at a given location may also be provided, thus providing further details for a search user employing a platform or service.

In yet other embodiments, a category of “children” may be provided to a reviewer, in those situations in which a user is searching for social prospects that are children who their own child or children may meet and play with. In such embodiments, demographic information may include the age of children at a location, an approximate number of male versus female children, a level of activities of the children, and other information a reviewer may perceive at a given location. In still other embodiments, social prospects searched by a user may be for business network or other business interests, and/or even for participating together in a common sport or activity. Reviewers can therefore also provide real-time feedback to searching users to confirm whether social prospects a user is searching for, and having specific criteria desired by the user, are in fact present at geographic locations presented as search results to the searching user. As before, geolocation data associated with a reviewer’s physical location, such as via their mobile device executing an application associated with a disclosed platform or service, may again be used to confirm the reviewer’s location when providing such feedback.

### Example System and Platform

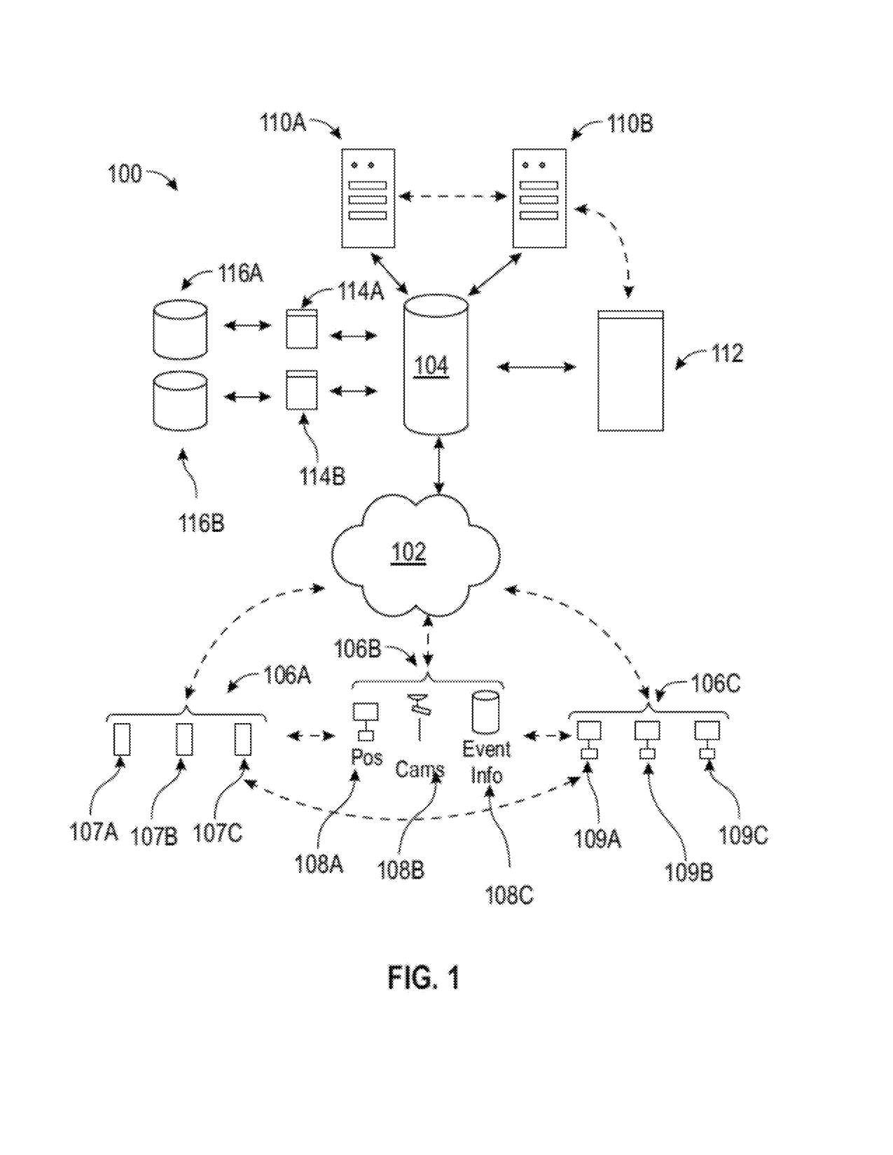

FIG. 1 illustrates a system-level block diagram of a social networking system 100 in accordance with one embodiment of the disclosed principles. A social networking system 100 as disclosed herein can allow for individuals or users to connect, interact with, and/or engage with companies, targets of interest, and/or other individuals or users that comprise possible social prospects having characteristics desired by a searching user. In some examples, a social networking system 100 may be implemented using a plurality of mobile applications running on users’ individual computing devices or mobile computing devices, and/or using access via a website via users’ computing devices. A social networking system 100 can include at least one database 104 that can be connected via a network 102. A network 102 may include packet-based networks, and/or other types of network equipment and components that allow for the transmission of data, images, video, audio, and other file types or formats. Similarly, such a database 104 can be configured to store and/or categorize data, images, video, audio, and/or other file types or formats. A database 104 may be any type of database, and can include but is not limited to sequel, non-sequel, centralized, distributed, cloud, relational, network, object-oriented, hierarchical, and/or other types or styles of databases.

The database 104 can be coupled to any number of devices and/or computing systems. For example, via the network 102, the one or more databases 104 may be coupled to mobile computing devices 106A, network connected devices 106B, and/or computing devices 106C (collectively device systems 106). In some examples, a mobile computing devices 106A can include, but are not limited to, mobile phones 107A, mobile computers, smartphones 107B, personal digital assistants (PDAs), media players, tablets 107C, and/or other devices containing at least one controller or processor and being able to connect to at least one computer-based network. Such mobile devices may be executing a mobile application configured to communicate with a platform as disclosed herein, and/or are part of a type of disturbed platform or service as disclosed herein. Similarly, computing devices 106C may include, but are not limited to, desktop computers 109A, laptop computers 109B, convertible computers 109C, tablet computers, and/or other devices having at least one processor and being able to connect to at least one computer-based network in order to communication with a disclosed platform. Still further, in an advantageous embodiment, a platform as disclosed herein may comprise, for example, a plurality of mobile applications executing on a corresponding plurality of user, reviewer, and/or social prospect mobile devices, where those applications are in communication with the platform, which may comprise, for example, one or more databases, one or more servers, one or more processors, via a communications network.

Additionally, there the system 100 can include network-connected devices 106B, such as but not limited to security systems, point of sale (POS) systems 108A, camera systems 108B, ticket or event management systems 108C, sensor systems, credit card payment systems, or other devices that are capable of being connected through a computer-based network. In at least one example, these network connected devices 106B may include a processor or controller to allow for processing or control of the data, images, video, audio, and/or other file types or formats that can be transmitted by the network connected devices 106B. The network connected devices 106B, in some examples, may include the ability to be edge-processed to allow for the transmission of pre-processed and/or categorized data, images, video, audio, and/or other file types or formats.

The device systems 106 may be connected via the network 102 to the at least one database 104 and server(s) 110A/110B. In at least one example, the database 104 may be stored and/or operated through server(s) 110A and/or 110B (collectively servers 110). The servers 110 may have at least one processor, at least one memory storage device, at least one data storage device, a network connection and/or transceiver, and/or an input/output bus device. The servers 110 may process and/or analyze data, images, video, audio, and/or other file types or formats prior to or after storage within the at least one database 104. For example, the servers 110 may process data, images, video, audio, and/or other file types or formats as it is placed and/or stored within the at least one database 104, to allow for categorization and/or tagging to the data, images, video, audio, and/or other file types or formats. A data organization system 112 can filter, tag, and/or categorize data, images, video, audio, and/or other file types or formats within the at least one database 104. The servers 110 may utilize the data organization system 112 to process and/or analyze the data, images, video, audio, and/or other file types or formats as it is received and/or after it is stored within the at least one database 104. One or more of the servers 110, databases 104, and data organization system 112, as well as one or more other devices and/or components of the system 100, may work together to provide a platform or service as disclosed herein.

Additional data sources 116A and/or 116B may be utilized to provide context and/or supplement the data, images, video, audio, and/or other file types or formats stored within the at least one database 104. For example, Global Positioning System (GPS) data may be supplemented with weather data to provide additional information that may allow for users to make additional decisions. In at least one example, the additional data sources 116A and/or 116B may have source filters 114A/114B that allows for specific information to be provided. For example, a data source may provide 1000 lines of data, but the source filters 114A/114B may reduce the data down to 100 lines of usable data. Additional details of example data sources that may be accessed for use by a platform or service in accordance with the disclosed principles are discussed below.

### Platform and Service Interfaces

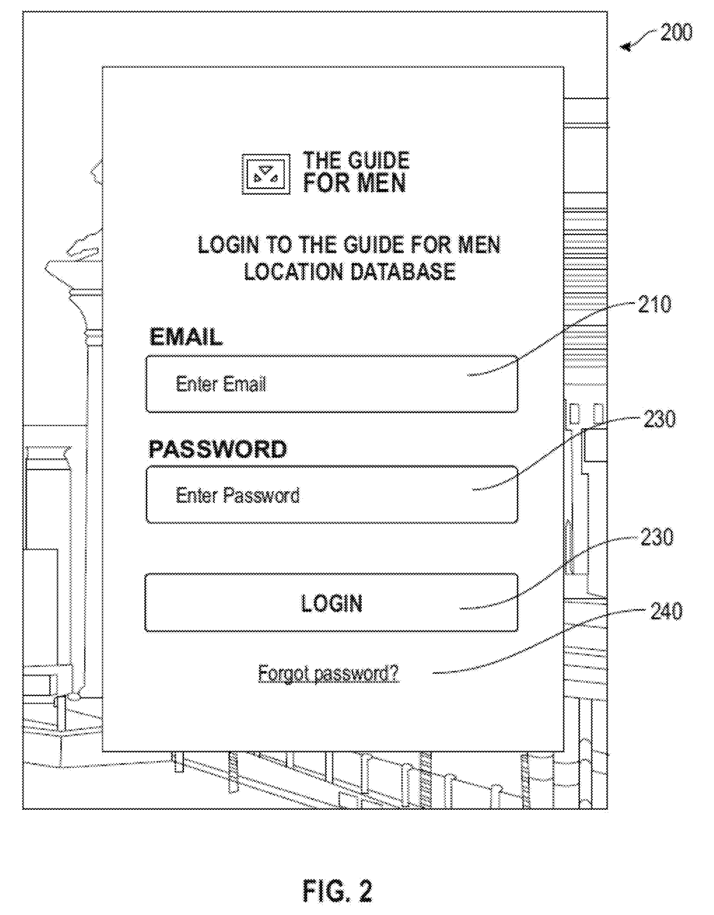

FIG. 2 illustrates a screen view of a login screen 200 for a platform or service in accordance with an embodiment of the disclosed principles. A login screen 200 may be used to prevent unauthorized access to a program, application (or “app”), and/or website used to access a disclosed platform or service. A User ID 210 may be utilized as part of multi-layer access process, where the User ID 210 may be an email or username used or created by a user. Additionally, users may provide a password 220 as part of a multi-layer access process. Once a user has provided these credentials via the login screen 200, the user may click on a login button 230. Alternatively, if a user has forgotten their username and/or password, the user may click a “Forgot Password” or other similar link 240 to access another page, window, and/or module that may require additional information to be entered or provided by the user in order to retrieve all or part of their login credentials.

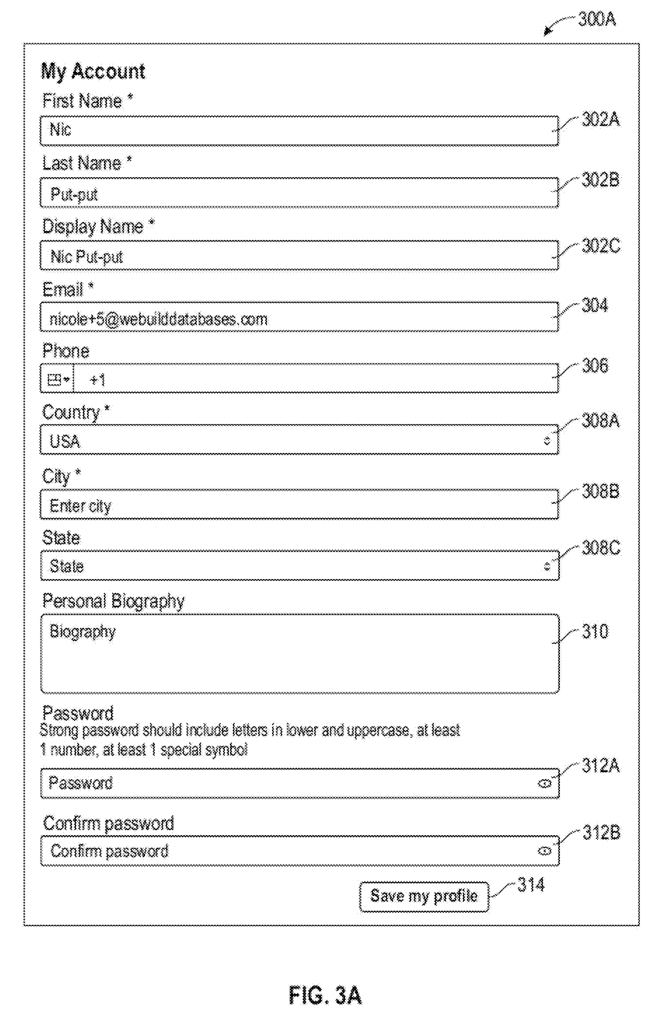

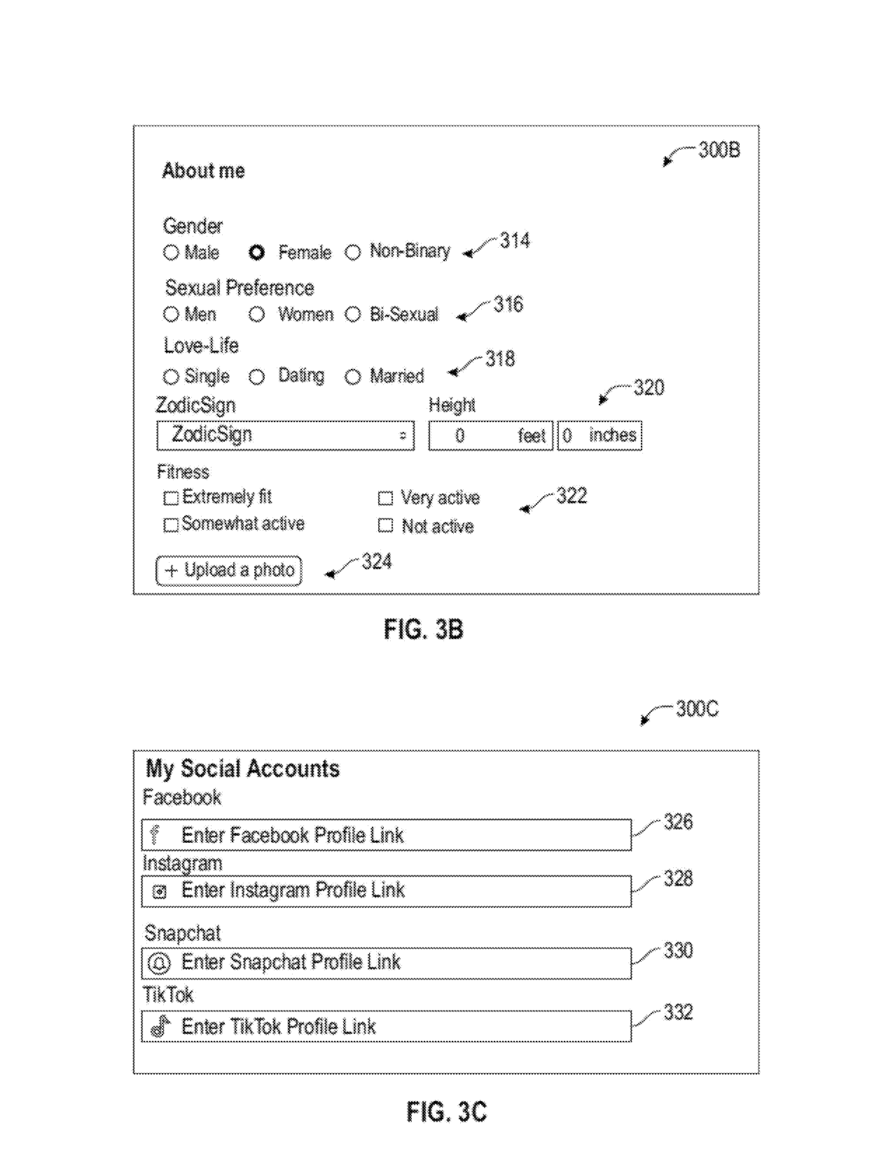

FIG. 3A illustrates a screen view of an account screen 300A for a platform or service in accordance with an embodiment of the disclosed principles. A platform or service as disclosed herein may utilize an account screen 300A for users to create and/or manage their account. There may be multiple pages, windows, and/or modules that allow a user to create, control, and/or manage their account through various fillable fields and/or selectable engagement areas. For example, a first name 302A, a last name 302B, and/or a username 302C. In at least one example, the username 302C may be utilized as a user id or a portion of a user id. A user id separate from the username 302C may be created in some examples. A user’s email address 304 may also be entered for receiving communications from a platform. A user’s phone number 306, address information such as but not limited to country 308A, city 308B, and/or state 308C may be utilized for geographical analysis and/or processing of information. A user may desire to include short biography information 310 that allows for a description of information the user would like known about themselves.

The user also may be prompted to create a unique password 312A, which typically may be a set of characters, numbers, special characters, etc., put in some ordered combination that is known only to a user, and a program, application or app, and/or website. In at least one example, there may be a minimum number of characters, or combination of characters, numbers, and/or special characters, as an example the user password 312A may have to include at least one of particular categories of possible variables to be used. Of course, other types of password for securing a user’s account with a platform may also be employed. Additionally, a user may be requested to repeat and/or confirm their selected password 312B. In other implementations, a program, application or app, and/or website in use with a platform or service as disclosed herein may have multiple information fields and/or buttons throughout the pages, windows, and/or modules, which may comprise, for example, a lesser or greater number than in the illustrated embodiment. Finally, a save button 314 may be provided to allow a user to save all fields of their profile.

FIG. 3B is a screen view illustration of a personal profile screen 300B for a platform or service in accordance with an embodiment of the disclosed principles. A platform or service as disclosed herein may utilize such a profile screen 300B for users to provide personal details that may be used to help match other users of a disclosed platform or method to a user based, at least in part, on personal characteristics provided in the user’s profile page. There may be multiple pages, windows, and/or modules that allow a user to provide any number of personal details that may be used to match the user to other users based, at least in part, on those other users’ desired personal characteristics. In the illustrated embodiment, a user may provide such personal details such as but not limited to gender 314, sexual preference 316, life status 318, zodiac sign 320, and fitness level 322. Additionally, a user may use an upload button 324 to upload a photo of themselves that may be seen by others employing a platform or service in accordance with the disclosed principles. Of course, a greater or lesser number of personal characteristics may be included in an example profile screen 300B.

FIG. 3C is a screen view illustration of a social media account screen 300C for a platform or service in accordance with an embodiment of the disclosed principles. More specifically, a user may use such a social media account screen 300C to provide other users their handles for their various social media account so that other users may connect and otherwise contact the user. Example social media handles may include but are not limited to a user’s Facebook 326, Instagram 328, Snapchat 330, and/or TikTok 332 account, as illustrated. Of course, other social media account handles may also be provided depending on the embodiment of the disclosed platform or service.

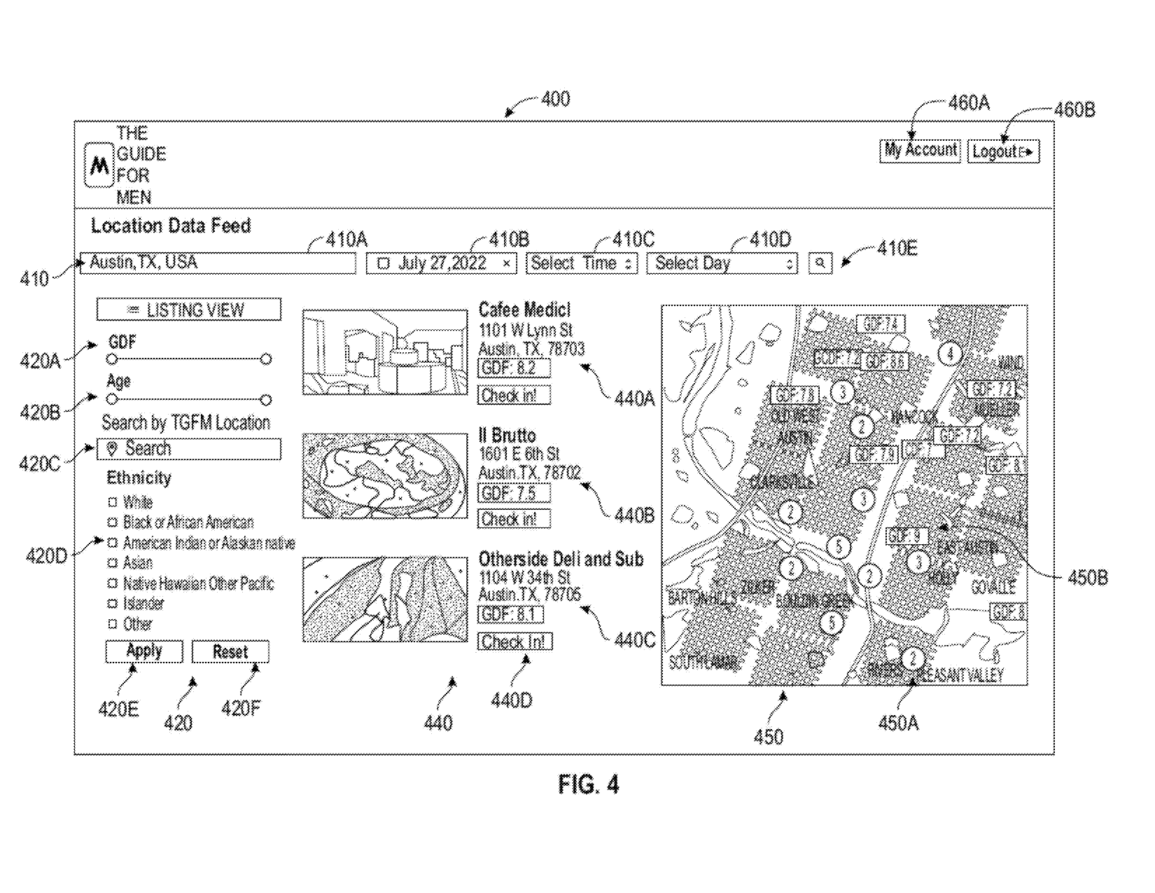

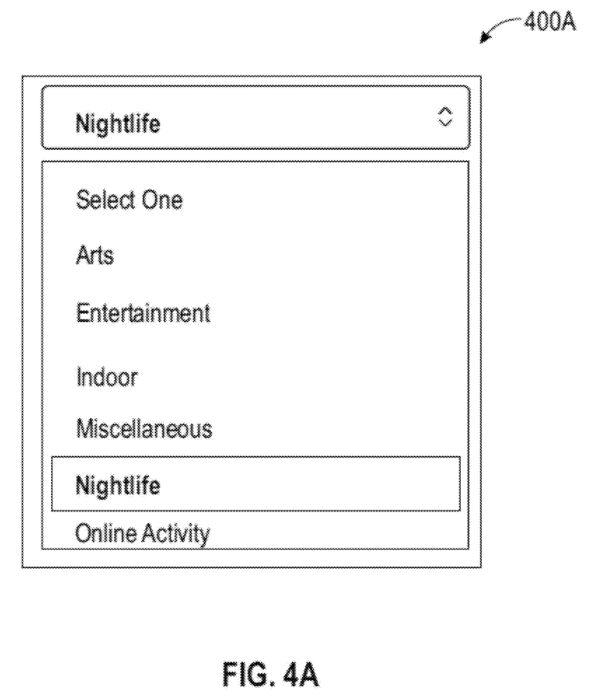

FIG. 4 is a screen view illustration of a user interface having a search screen 400 for a platform or service in accordance with an embodiment of the disclosed principles. In particular, such a search screen 400 may be used by a user to search for and find potential social prospects to meet. Specifically, a user may enter search criteria of desired social prospects, and a platform or service as disclosed herein may provide search results in the form of geographic locations where prospects matching the user’s search criteria may be found or may have been in the past. In one example, in a dating or single mingling practical application of the disclosed principles, a user may conduct a search for social prospects based, at least in part, on search criteria 410 including, but not limited to, city 410A, date 410B, time 410C, and/or type of venue 410D where the social prospects would be met. Once these selections have been made, the user may execute a search using a search button 410E. Results from these search criteria 410, as well as any other search criteria desired by an implementor of a platform or service as disclosed herein, may be further filtered using filters 420. Search results filters 420 may include one or more category, tag, etc. from a database(s) where information is stored or derived from.

In a dating or single mingling practical application example, a user may filter by a rating factor 420A of potential prospects. In advantageous embodiments, the rating factor 410A may be a specialized rating factor pertaining to how likely or unlikely social prospects matching a searching user’s desired characteristics will be or are at a specific location. This specialized rating factor may be comprised, for example, of both an objective and subjective component. In an example embodiment, an objective component may be based, at least in part, on data that is gathered by a platform or service pertaining to characteristics of social prospects that are located at a specific location. A subjective component may be based, at least in part, on data that is provided by one or more other users of a platform or service, and also pertains to characteristics of social prospects that are located at a specific location. As a result, this rating factor may change based, at least in part, on specific characteristics of social prospects a specific user is searching for based, at least in part, on the density of prospects at a specific location that match those specific characteristics. Moreover, a rating factor including both an objective and subjective component provides a more accurate measure of specific characteristics of potential social prospects at a particular location. In some embodiments, objective and subjective components of this unique rating factor may be provided separately.

In one or more embodiments, a host application may electronically calculate, for one or more particular second in-memory configurations (establishment profile), a composite score comprising a first score and a second score. A first score may be calculated based, at least in part, on a particular second in-memory configurations having a threshold number of elements corresponding to one or more input parameters of a searching user. A first score may be a substantially objectively quantifiable value, derived from one or more of the following: an artificial intelligence analysis of data associated with the establishment profile; an independent third-party analysis; an industry-wide analysis of comparable establishments; or any combination thereof. A first score may incorporate data obtained from third-party external data sources via a communications network, including geographic data points, visit data points, demographic characteristic data points, socioeconomic characteristic data points, or any combination thereof, as described further herein. A composite score described herein may correspond to a rating factor referred to elsewhere in this disclosure as the “Z Score,” “Z Rating,” “Z Factor,” or “GDF,” and a first score may correspond to the objective component of that rating factor.

A second score may be calculated based, at least in part, on input values received from external data sources via a communications network for particular second in-memory configurations. A second score may be a substantially subjectively quantifiable value, reflecting qualitative assessments of an establishment by other users of a platform. Specifically, a second score may be derived from subjective ratings, referred to herein as “Z-star ratings” or equivalent rating designations, submitted by first in-memory configurations (user profiles) having stored elements corresponding to those of a requesting first in-memory configuration. That is, a subjective ratings contributing to a second score for a given establishment may be drawn from users whose personal characteristics, temporal context, and socialization preferences correspond to those of a searching user, ensuring that the second score reflects assessments from users who are similarly situated and thus most relevant to the searching user's experience. A subjective rating may reflect elements pertaining to a suitability of a respective establishment for socialization purposes corresponding to a searching user’s preferences, and may exclude elements pertaining to non-corresponding characteristics of the establishment, such as food quality, general service, or other non-socialization factors.

In one or more embodiments, a derivation of a second score may further comprise, for example, the following operations performed by the host application. First, subjective ratings received from a corresponding first in-memory configuration may be associated with one or more temporal parameters comprising the date, time, and day of week at which the rating was submitted. Second, subjective ratings may be weighted based, at least in part, on temporal relevance, such that ratings submitted during temporal parameters comparable to those of a requesting first in-memory configuration. For example, ratings submitted on a Friday evening when a searching user is also conducting a Friday evening search may receive greater weight than ratings submitted during non-comparable temporal parameters. This temporal weighting ensures that a second score reflects an establishment’s socialization suitability during conditions most similar to those experienced by a searching user, rather than averaging across disparate temporal conditions that may not be representative of the searching user’s experience.

In one or more embodiments, a weighting of subjective ratings may further comprise, for example, electronically applying, via a host application, a seasonal weighting factor to the subjective ratings. Specifically, ratings submitted during a season, month, and/or date range corresponding to a current search period, as indicated by one or more temporal parameters of a structured string of values received from a requesting remote user device, may receive greater weight than ratings submitted during non-corresponding seasons, months, and/or date ranges. This seasonal weighting may account for temporal variation in venue attendance patterns, recognizing that characteristics and density of social prospects at a given establishment may vary significantly across different seasons, holidays, calendar periods, or the like. For example, a rooftop bar may attract a fundamentally different crowd in summer than in winter, and a seasonal weighting factor may ensures that a second score presented to a searching user reflects subjective ratings from temporal conditions most analogous to those of a current search, which may improve the accuracy and relevance of a composite score for the searching user’s specific temporal context.

In this illustrated embodiment, a rating factor is provided as “GDF”, which colloquially means “Goddamn Factor,” and thus can be seen as a measure of how impressive a potential social prospects at a certain location and having a given set of searched characteristics actually is. A GDF may provide a searching user an additional component when searching for locations for meeting prospects that match the searching user’s desired characteristics by allowing a filtering of search results based, at least in part, on a level of GDF. More specifically, while a number of search result locations may be presented that have prospects matching many of a user’s desired characteristics, filtering results by a higher GDF may narrow search result locations to those locations having an increased density of prospects matching the user’s search criteria, and/or to those locations having prospects matching a greater number of the user’s search criteria. Moreover, that filtering may be a sliding scale based, at least in part, on a higher or lower GDP as selected by a searching user. Additional details regarding this rating factor, or GDF, are provided below.

Other filters may also be provided, including those based, at least in part, on more objective or empirical factors. These may include an age parameter 420B, which may be provided as a scale or range of ages for potential prospects. The ability to filter potential social prospects may be important not just in a dating application of the disclosed principles, but also in other areas involving meeting social prospects. For example, if a platform or service as disclosed herein is used to search for play friends for children, filtering search results by age may be crucial. Another filter for search results may include a “search within results” filter 420C, which may allow a user to further filter search results using a criteria such as limiting results to within a specific geographic location or distance. Yet another filter could include filtering the potential social prospects by ethnicity 420D or perhaps race. Of course, other filters may be included to narrow down search results, and a user interface in accordance with the disclosed principles may include any number of advantageous filters that assist users in narrowing down their searches to potential social prospects that more closely fall within the user’s desired results. Once a user selects the desired filtering criteria, the user may apply those filters to a search result by selecting an “Apply” button 420E. Alternatively, if a user desires to try different filters on his search results, the user may select a “Reset” button 420F, which may reset the filters in order to start over again.

In one or more embodiments, a host application may electronically match one or more input parameters of the structured string of values, corresponding to a search query submitted by a searching user, against one or more of the following: the respective first collections of elements of a plurality of first in-memory configurations (i.e., the personal characteristics stored in user profiles); respective second collections of elements of the plurality of second in-memory configurations (i.e., socialization characteristics stored in establishment profiles); aggregated data points described above; or any combination thereof. This matching operation may be performed to identify a subset of second in-memory configurations, that is, a threshold number of establishment profiles, having a sufficient number of second collection elements corresponding to one or more input parameters of a requesting first in-memory configuration. In parallel or subsequently, a matching operation may also performed to identify a subset of first in-memory configurations, such as other user profiles, that are associated with one or more of the identified establishment profiles and that share a threshold number of first collection elements with the requesting first in-memory configuration (i.e., other users whose personal characteristics match a searching user’s desired characteristics and who are associated with one or more of identified establishments). A threshold number of matching elements may be predetermined or dynamically determined by a host application based, at least in part, on search parameters provided by a searching user or inferred from their profile or prior interactions with a platform.

Filtered results may generate a visual display of search results 440 in a user interface of a platform or service as disclosed herein. In this illustrated embodiment, there are a first result 440A, a second result 440B, and a third result 440C, and these results may be location where social prospects meeting a user’s search criteria may be located. Such determination may be made on a likelihood that matching social prospects will be at a displayed locations based, at least in part, on documented past experiences. As such, the disclosed principles may provide a prediction that matching social prospects are likely to be at a same location again. Alternatively, a disclosed platform or service may provide results indicating that matching social prospects are currently at a displayed locations. The manners in which these techniques generate search results are described in detail below.

As shown in FIG. 4, example displayed location results 440 may provide specific establishments where matching social prospects may be found. In addition to providing a list of establishments, specific information related to a user’s search criteria and how it relates to listed establishments may also be displayed. For example, in this illustrated embodiment the “GDF” for a particular search result is provided by particular listings. This GDF for results may be derived by providing an average or a mean of GDF scores that have been generated for one or more particular locations. As mentioned above, a GDF for any particular place may be a combination of collection objective data and received subjective feedback, and pertains to the density of social prospects matching a particular set of searched characteristics at that particular place. Also provided with search results may be a Check In button 440D. This button may be used by a user to notify a platform or service that they are actually present at a particular location. By “checking in,” a platform or service may permit a user to not only confirm their location at a selected establishment, but also to provide feedback regarding the accuracy of search results provided by the platform or service. Additional details of such a feedback option are provided below.

In one or more embodiments, a host application may electronically rank particular establishment profiles based, at least in part, on one or more elements of their respective second set-data structures or aggregated data points, including composite scores as described below. Concurrently or subsequently, a host application may electronically rank matching user profiles based, at least in part, on a popularity score derived from one or more of the following: a social network reach associated with a given user profile, reflecting the extent of that user’s connections across the platform or integrated social media accounts; a frequency at which a given user profile is associated with identified establishment profiles, reflecting how often that user appears at or is linked to matching venues; a demand for access to a given user profile, reflecting the number of other users who have searched for, requested access to, or otherwise expressed interest in that user's profile or network; or any combination thereof. A resulting ranked set of establishment profiles and user profiles may be electronically transmitted by a host application as one or more digital signals to a requesting remote user device via a communications network, where they are rendered via the graphical user interface of a platform’s mobile application, facilitating in-person real-world socialization by presenting a searching user with prioritized establishments and compatible social prospects.

In addition to an illustrated list view of search results 440, filtered search results may also be provided on a map 450 generated and displayed, and having map highlights 450A, 450B. The map highlights 450A, 450B illustrate multiple establishments or venues matching a user’s search criteria and within a predetermined proximity. In addition to providing a visual indicator of matching venues’ locations, such a view also allows a user to see the proximity of matching venues from one another, and thus the user can move between multiple venues if desired social prospects are not available at a single venue when visited.

An example user interface for use with a platform or service as disclosed herein may also have any number of additional buttons that allow users to interact or engage with the platform or service. For example, a My Account button 460A may be used by a user to access his account information to modify, edit, and/or create additional information regarding his account. A Logout button 460B may be used to allow a user to log out of their account with a platform or service, which thereafter the button 460B may become a Login button usable to log back into their account.

FIG. 4A is a screen view illustration of an additional search criterion 400A that may be included with a search screen 400 such as the screen of FIG. 4. Specifically, the additional search criterion 400A may be to search for a particular location type. For example, a dropdown menu for selecting an establishment type may provide multiple options from which the searching user may select. A user may then scroll through the available options of establishment type, and once a desired establishment type is found the user may simply click on a selected type to add to his search. In some embodiments, multiple selections from a dropdown menu may be made, thereby increasing the number of establishments displayed in search results of FIG. 4. Although in the illustrated embodiment the selection options are Arts, Entertainment, Indoor, Miscellaneous, Nightlife, Online Activity, additional or other types of establishments may be included in such a dropdown menu.

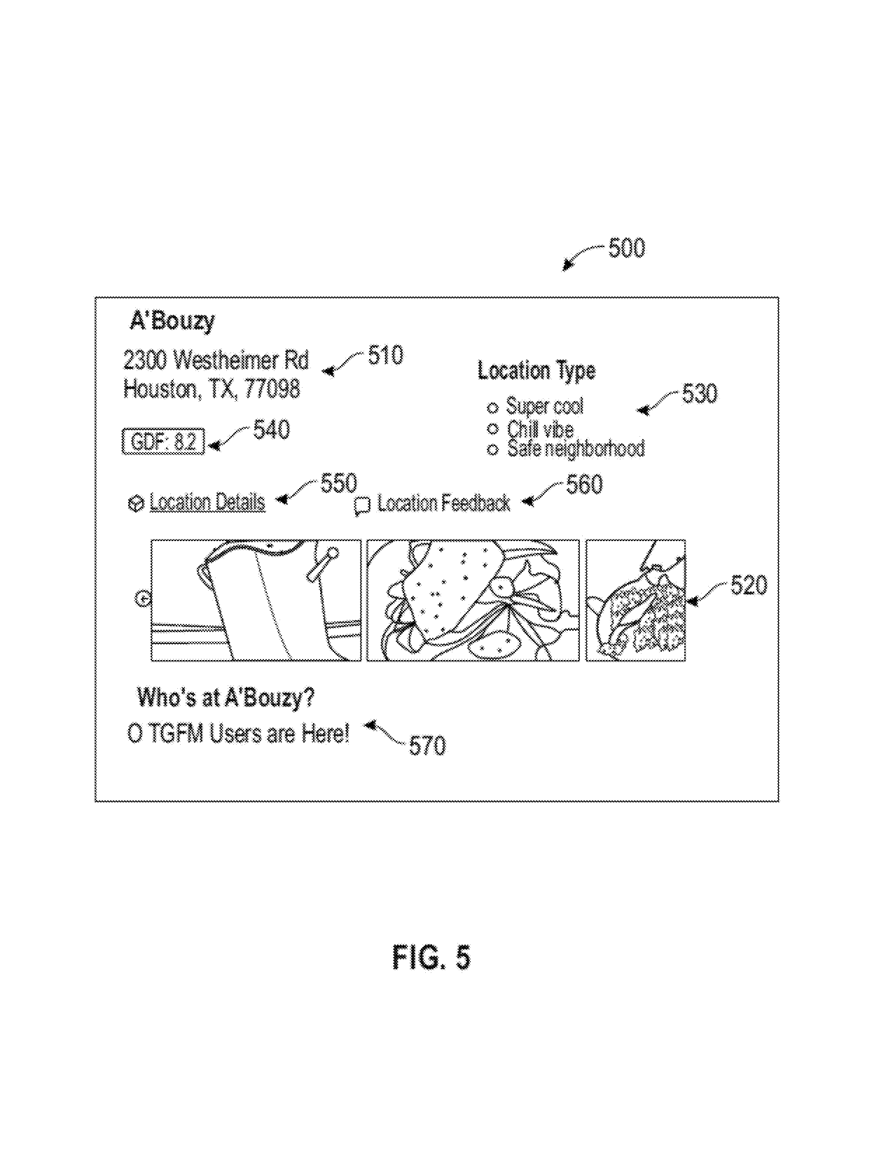

FIG. 5 is a screen view illustration of a search result detail screen 500, which may be among the results of a search conducted using the user interface of FIG. 4. A search result detail screen 500 not only provides the name and address 510 of the location, but also may present specific details regarding a location that can allow a user to decide whether to visit the location in search of desired social prospects. Among details may be a gallery of images 520 taken at a location, which may provide a look at the décor, the food, the drinks, and the atmosphere of the location. Commentary 530 regarding the “type” of location may also be provided. The rating factor 410A discussed above may also be provided, which may also be selectable by a user in order to learn more details on how the rating factor 410A was derived. For example, if the rating factor 410A is a GDF or similar rating factor, selecting the button 410A may provide a user details on the individual rating scores provided by ranking users or other persons. There may also be a link 550 to obtain additional location details, such as directions thereto, features and/or services provided by a venue, the venue’s location, the venue’s website, and other contact information for the venue. Another link 560 may also be provided for obtaining feedback on a specific location that may have been provided by patrons of the location to allow a user to see what others have said about a venue. Finally, a details page may also include information 570 regarding certain persons or groups of person currently visiting a location, including other users of a disclosed platform or service.

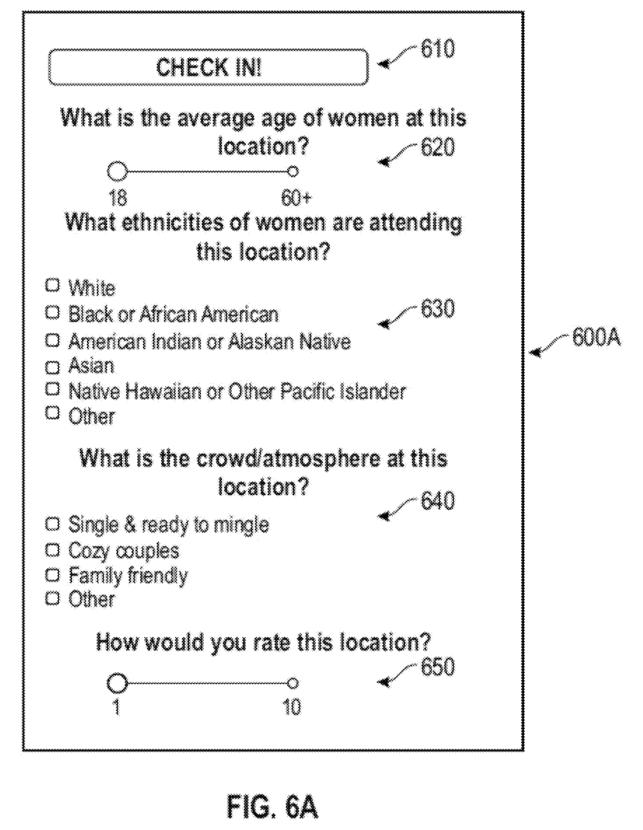

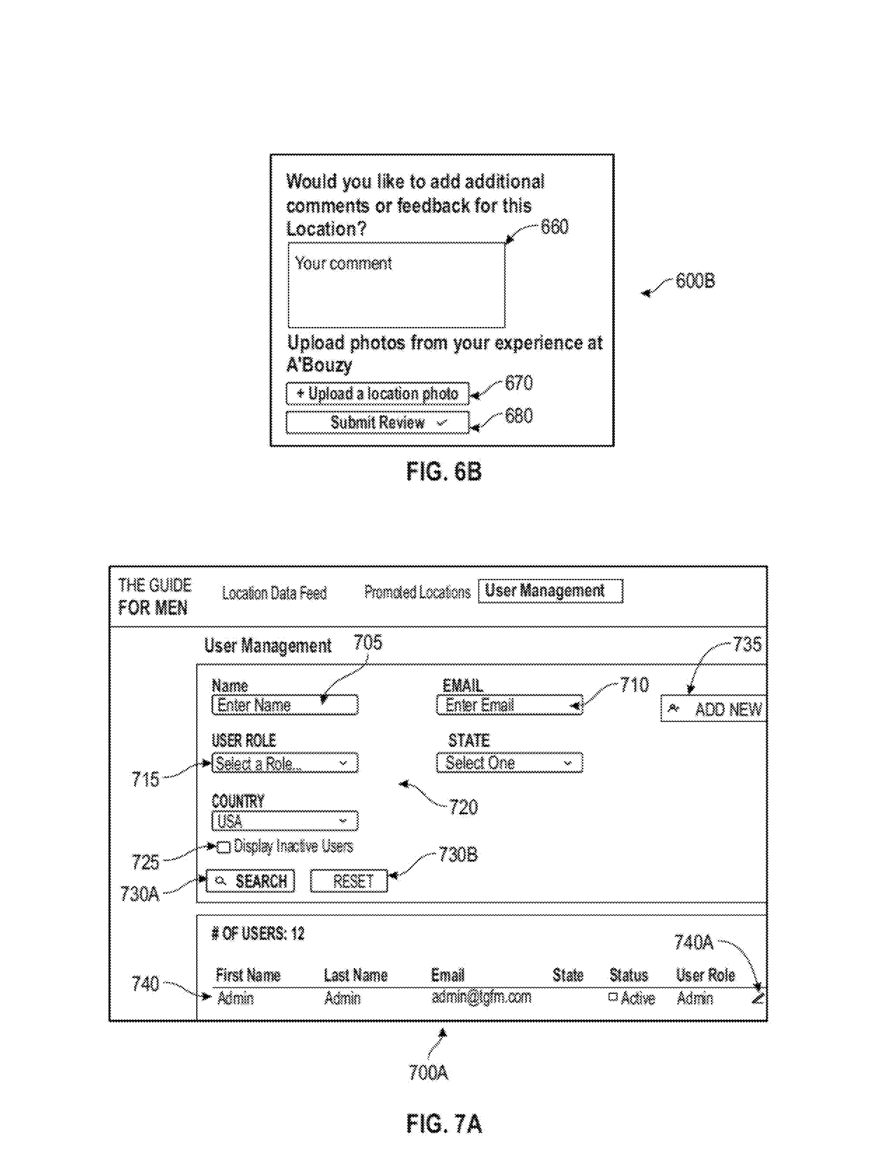

FIG. 6A is a screen view illustration of a Check In feedback screen 600A that may be employed by a user of a platform or service in accordance with an embodiment of the disclosed principles. The Check In screen 600A may be provided via a mobile application executing on a user’s mobile computing device, and/or could be provided via a webpage or website accessible by a user via their computing device’s browser software. As discussed above, a user can “check in” at a particular location in order to inform a platform or service that he is present at the location, as well as to potentially provide his feedback about the location. Such feedback can then be used to improve the accuracy of search results provided to future users. In some embodiments, GPS confirmation, for example, via a user’s phone, and/or other geolocation services and equipment, may be employed to ensure that a user is actually at a particular venue when checking in.

Looking at this illustrated embodiment, a Check In button 610 may be provided for use by a user when he is ready to check in. However, additional information may be provided by a user before selecting the Check In button 610. For example, a user may provide information regarding the age of women or other social prospects they see at a location via an age range selector 620. Also, various ethnicities of social prospects at a location may be selected from a list of ethnicity options 630. Moreover, a user can provide information about the crowd and/or atmosphere from a list of options 640. A user may also provide their overall personal ranking of the venue such as by using a 1-10 ranking scale 650. Of course, other types of sliders, lists and scales may also be employed for these illustrated Check In feedback options. When a user has finished making his various selections on the Check In screen 600A he may then select the Check In button 610 to complete a check in process.

By checking in and providing both subjective and objective information about a specific location, and/or social prospects at a specific location, a platform or service as disclosed herein can provide more accurate search results for other users employing the platform or service to search for social prospect they desire to meet. In some embodiments, a user checking in has not previously used a platform or service to search for social prospects, but instead is a prior user that elects to provide feedback information or perhaps is a provider of feedback sponsored by the platform or service. In embodiments where a user has previously employed a platform or service to search for venues having desired social prospects, the platform or service compiles information from the user’s prior search(es) and information provided by the user via a check in process to further hone the accuracy of future search results.

FIG. 6B illustrates a screen view of an additional Check In screen 600B. This additional screen may be provided along with the Check In screen 600A discuss with respect to FIG. 6A or may be a screen provided to a user when they are ready to leave a particular venue or has already left the venue. Among the additional information a user may provide via this additional screen 600B is a text box 660 where a user can provide a review of a location or other additional feedback via a narrative. Additionally, an Upload Photo button 670 may also be provided where a user can upload to a disclosed platform or service any photos the user may have taken at a location. Once a user has completed the additional information, he may submit the information via a Submit Review button 680.

In one or more embodiments, a host application may electronically process one or more revised elements received from a requesting remote user device via the communications network pertaining to a given first in-memory configuration, that is, another user profile, observed by a searching user while both are confirmed to be associated with the same second in-memory configuration (establishment). For example, upon checking in at an establishment, a searching user may observe an identified other user and provide updated or corrected personal characteristic information about that user through a platform’s feedback interface. A host application may then electronically update a first set-data structure of a given first in-memory configuration to incorporate one or more revised elements into a subjective component of a popularity score associated with a given first in-memory configuration. This embodiment allows a platform to continually refine the accuracy of user profiles through real-world, in-person observations provided by searching users, improving the quality of matching results for future searches.

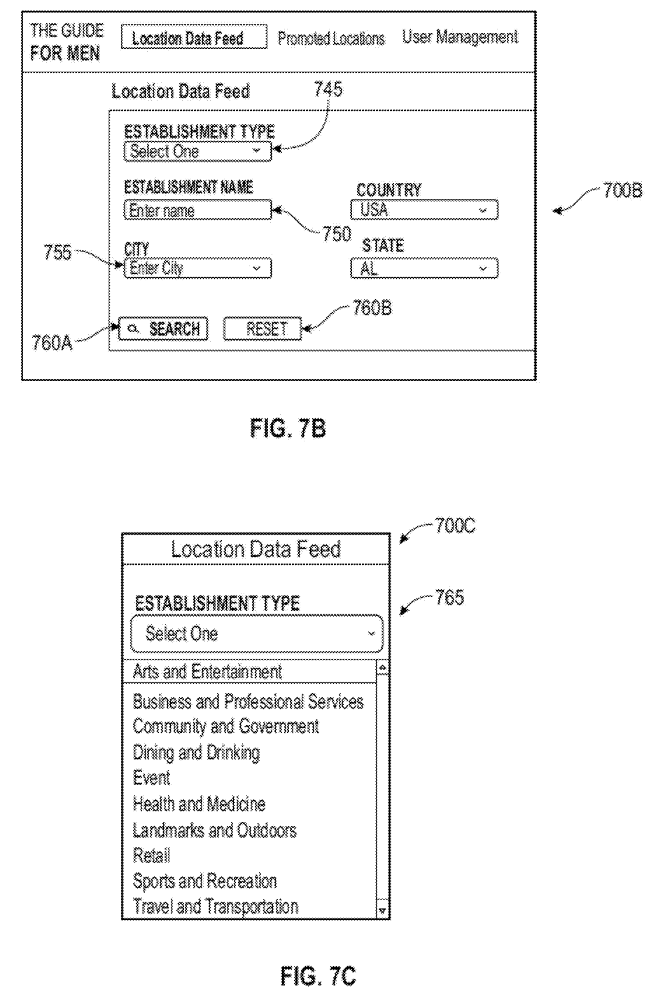

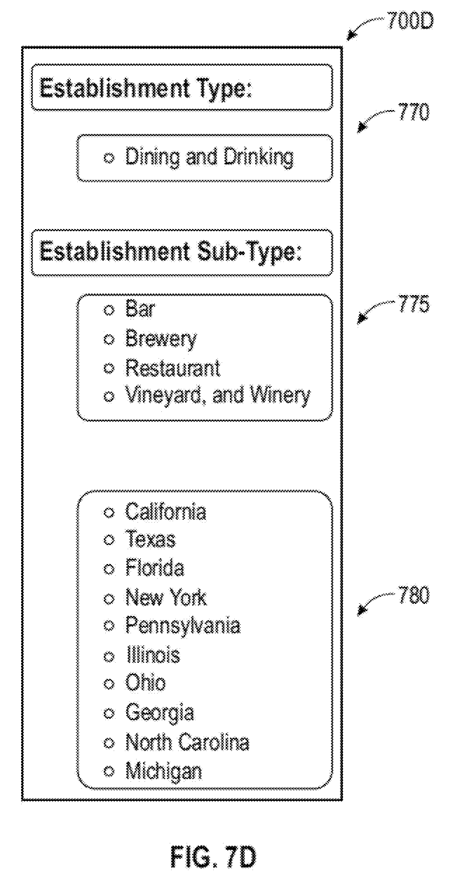

FIG. 7A is a screen view illustration of a User Management screen 700A accessible by an administrator of a platform or service in accordance with an embodiment of the disclosed principles. An example User Management screen 700A may have multiple sections with one or more fields to enter data. Through such an example User Management screen 700A, an administrator can search for users or add new users. Additionally, administrators may also search for users by user “role”, such as Admin, Staff, User, etc. Of course, other types of roles in relation to a platform or service as disclosed herein may also be included in a User Management screen 700A.

The User Management screen 700A can include a name field 705 that may allow for a new user’s or a current user’s name to be added, edited, deleted, and/or simply searched. An email field 710 may allow for a user email to be added, edited, deleted, and/or searched. A user role field 715 may allow a user’s role within an organization (company, venue, and/or other group) to be added, edited, deleted, and/or searched as well. Moreover, various address fields 720 may allow for a user’s address/location to be added, edited, deleted, and/or searched. An option 725 to only display current users or display even inactive users may also be provided. A Search button 730A may allow for displayed information of a particular user to be searched, while a Reset button 730B can be used to clear search fields in order to begin entering information for a new user search. An Add New User button 735 may allow for fields provided on the User Management screen 700A to be cleared and new information to be added for adding a new user to a platform or service. A displayed list 740 of search results of users matching search criteria discussed above may be displayed, from which an administrator may select a particular user. An edit button 740A may also be used by an administrator to edit information in a list of users.

FIG. 7B is a screen view illustration of a Location Data Feed screen 700B accessible by an administrator or user of a platform or service in accordance with an embodiment of the disclosed principles. An example Location Data Feed screen 700B may have multiple sections with one or more fields to enter data. Through such an example screen 700B, an administrator or user can search for establishments that are affiliated with a disclosed platform or service. In some embodiments, the Location Data Feed screen 700B may simply be used by an administrator or even a user to simply search for establishments in a given geographic location. Alternatively, in some embodiments, an administrator may use a Location Data Feed screen 700B to add new establishments to a disclosed platform or service as affiliates of the platform or service.

The Location Data Feed screen 700B can include any of a number of information fields, such as an establishment type 745, which could include a dropdown menu presenting multiple options from which to select a type, an establishment name 750, and location information 755 about the establishment. A Search button 760A may allow for displayed information of a potential establishment to be searched, while a Reset button 760B can be used to clear search fields in order to begin entering information for a new establishment.

FIG. 7C is a screen view illustration of a close up view 700C of a dropdown menu for selecting an establishment type from the Location Data Feed screen of FIG. 7B. Once a user or an administrator selects a dropdown icon or caret, a dropdown menu 765 may be presented. A user or administrator may then scroll through available options of establishment types. Once a correct or desired establishment type is found, a user or administrator may simply click on the selected type. In some embodiments where the Location Data Feed screen is used to search for multiple establishments, multiple selections from a dropdown menu may be made, thereby increasing a number of establishments displayed in search results. Although in the illustrated embodiment the selection options are Arts and Entertainment, Business and Professional Services, Community and Government, Dining and Drinking, Event, Health and Medicine, Landmarks and Outdoors, Retail, Sports and Recreation, Travel and Transportation, additional or other types of establishments may of course be included in such a dropdown menu.

FIG. 7D is a screen view illustration of an Establishment Sub-Type selection screen 700D. In this illustrated embodiment, once a user has selected an establishment type 770 from, for example, a dropdown menu like the one illustrated in FIG. 7C, establishment “sub-types” may then be provided to a user so as to provide another level of detail for a desired search.

In this example, the selected establishment type 770 is a Dining and Drinking establishment, which then presents a list of possible establishment sub-types 775 for the selected type of establishment. Such sub-types may be presented in any of a number of manners, such as an additional dropdown menu. Although the presented establishment sub-types are Bar, Brewery, Restaurant, and Vineyard and Winery, additional or other types of establishment sub-types may of course be included. Additionally, an establishment search may also include further filtering based, at least in part, on geographic location 780. For example, as illustrated, a presented geographic location filter options may be based, at least in part, on U.S. state; however, other options for geographically filtering establishment search results may also be provided. Such searching by geographic location can allow users to look for locations not only near them, but also to look ahead for trips to particular states and/or locations.

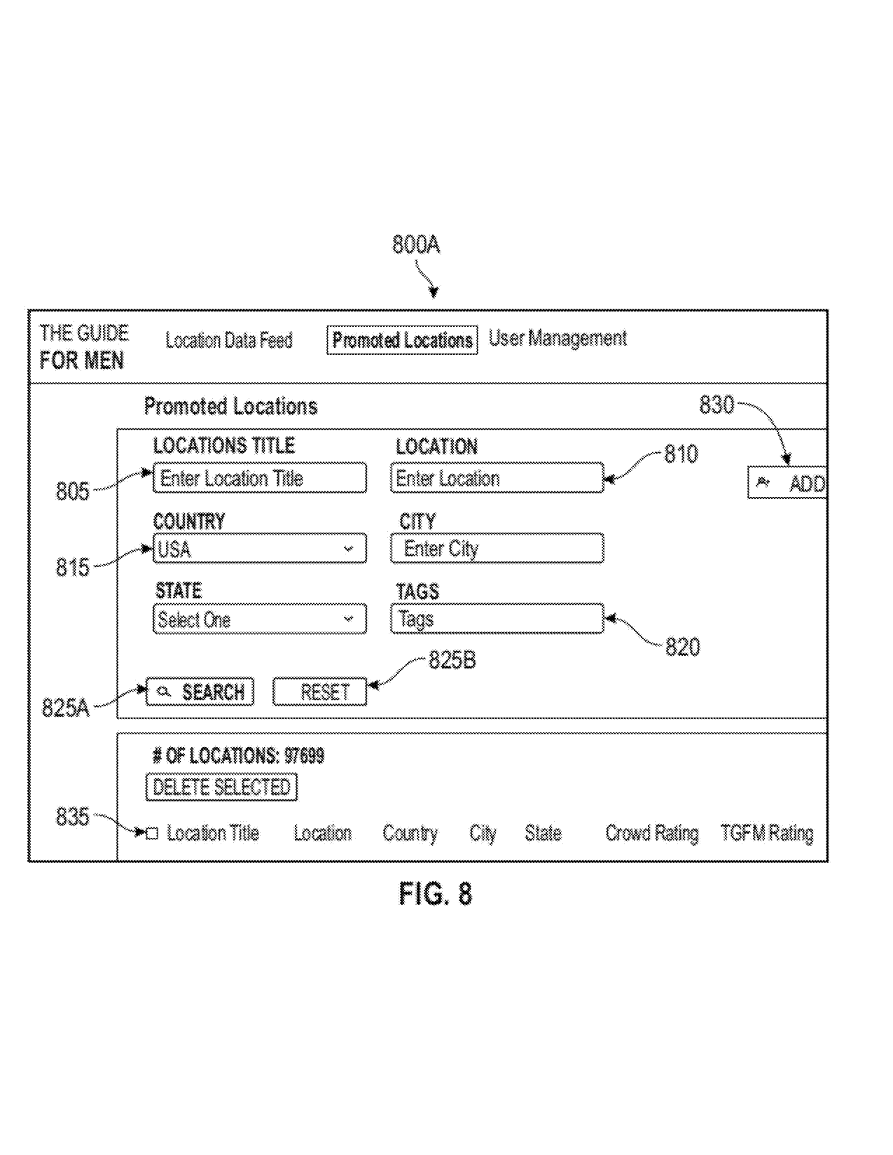

FIG. 8 is a screen view illustration of a Promoted Locations screen 800 accessible by a user of a platform or service in accordance with an embodiment of the disclosed principles. Promoted Locations screen 800 may be employed by a user or administrator to search for establishments that are previously affiliated with a platform or service as disclosed herein, and/or to add such an affiliated establishment.

An example Promoted Locations screen 800 may include multiple sections with one or more fields to enter data. Through such an example screen 800, an administrator or user can search for establishments that are being promoted by a disclosed platform or service. In some embodiments, the Promoted Locations screen 800 may be used by an administrator or a user to search for promoted establishments in a given geographic location. Alternatively, in some embodiments, an administrator may use a Promoted Locations screen 800 to add new establishments to a disclosed platform or service as locations being promoted by the platform or service.

The Promoted Locations screen 800 can include any of a number of information fields, such as a promoted location’s title 805, which could include a dropdown menu presenting multiple options from which to select a type of location, a promoted location’s geographic location 810, and location information 815 about the promoted location(s). Additionally, a field 820 for entering a “tag” associated with promoted locations may also be provided. A Search button 825A may allow for displayed information of a potential promoted location to be searched, while a Reset button 825B can be used to clear search fields in order to begin entering information for a new promoted location.

An Add New promoted location button 830 may allow for fields provided on the Promoted Locations screen 800 to be cleared and new information to be added for adding a new promoted location to a platform or service. A displayed list 835 of search results of promoted locations matching search criteria discussed above may be displayed, from which a user or administrator may select a particular promoted locations. Additional information regarding presented promoted locations may also be displayed in the list 835, such as a Crowd Rating or a rating of the location in general provided by a platform or service (illustrated as a “TGFM Rating”). Of course, other or additional information regarding the presented promoted locations may also be provided. Further, a Delete button 840 may also be used by an administrator to delete promoted locations, for example, if they are no longer being promoted by the platform or service.

In one or more embodiments, prior to adding a new establishment to a platform’s database of second in-memory configurations, a host application may execute an onboarding and verification process. A host application may electronically process an onboarding request received from a remote user device via a communications network. An onboarding request may comprise, for example, one or more identifying elements and one or more socialization characteristic elements associated with a candidate second in-memory configuration, that is, the name, address, type, and socialization characteristics of an establishment proposed for inclusion. An onboarding request may be submitted by a user of a platform, an establishment proprietor, an administrator of the platform, or the like. Upon receipt, a host application may electronically execute one or more verification operations on an onboarding request to confirm the legitimacy of a candidate second in-memory configuration prior to inclusion in the plurality of second in-memory configurations. Verification operations may include, but are not limited to, cross-referencing submitted identifying elements against one or more third-party databases, confirming an establishment’s physical existence at a specified geographic location, conducting an administrative review of submitted information, and the like. Upon successful completion of one or more verification operations, a host application may electronically generate a new second in-memory configuration comprising a corresponding second set-data structure having a second collection of elements derived from an onboarding request. A new second in-memory configuration may be stored in the platform’s database and made available for inclusion in particular second in-memory configurations generated in response to future search queries, as well as for inclusion in composite score calculations as described herein.

### Feedback and Information Databases

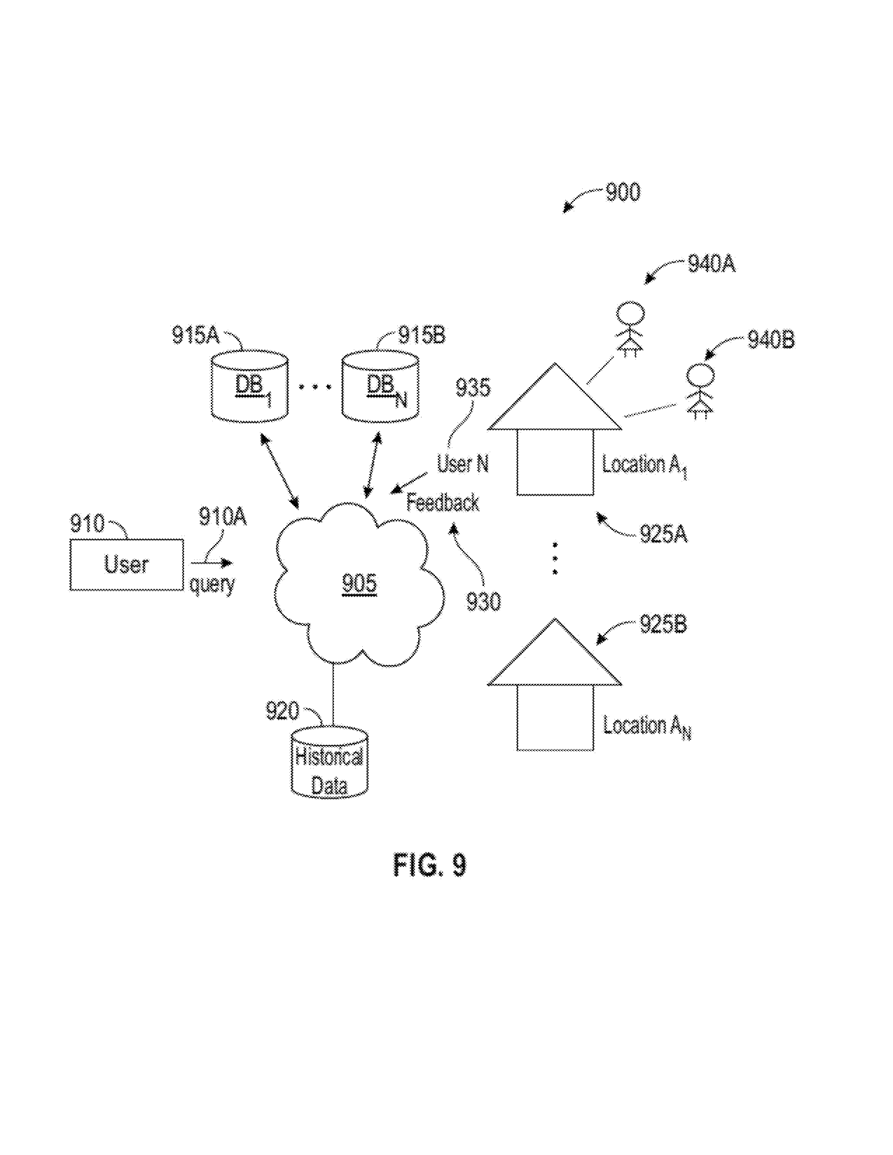

FIG. 9 illustrates a block diagram of a social networking system 900 incorporating a platform or system in accordance with an embodiment of the disclosed principles. The social networking system 900 can rely on users (e.g., individuals) that both use a system or operate businesses or other groups or events that engage or interact with the social networking system 900. The social networking system 900 can utilize a network 905, such as a computer network like the internet, that allows for user devices, processors, computing devices, databases, and other computer equipment to be interconnected. For example, a user 910 can access a platform or hosted service in accordance with the disclosed principles via the network 905.

In one or more embodiments, a host application may electronically process data points received from external data sources via a communications network. External data sources may include remote user devices executing a platform’s mobile application, third-party databases, network-connected devices such as point-of-sale systems or sensor systems, and the like. Processing a plurality of data points may include generating aggregated data points via one or more aggregation operations. Such aggregation operations may include one or more of the following: temporal data points aggregation, where data points are grouped, binned, and/or otherwise combined according to temporal parameters such as time of day, day of week, month, season, etc.; spatial data points aggregation, where data points are grouped according to geographic proximity or location; statistical data points aggregation, where data points are summarized using statistical measures such as mean, median, frequency, distribution, etc.; categorical data points aggregation, where data points are grouped according to one or more categorical attributes such as establishment type, demographic category, socialization purpose, and the like; identifier data points aggregation, where data points are grouped or associated according to unique identifiers corresponding to user profiles or establishment profiles; or any combination thereof. Data points subject to aggregation may include historical check-in data, real-time check-in data, geolocation data, user-submitted feedback scores, and data obtained from third-party databases, as further described herein. Resulting aggregated data points may be stored in one or more data structures accessible to a host application and used in matching and scoring operations as described below.

A platform or service as disclosed herein can access one or more databases 915A, 915B (collectively 915), which would store and/or categorize information such as data, images, video, audio, and other types of information usable by a disclosed platform or system as disclosed herein. Additionally, the user 910 can query 910A a platform or service using their computing device in a manner that causes one or more processors or computing devices associated with the platform or service to access the at least one database 915 in response to the query 910A. In addition to the informational databases 915, an example system 900 may also include one or more historical databases 920, discuss in further detail below.

As discussed in detail above, the user’s query 910A of the system 900 may comprise, for example, a search for one or more locations that meet the user’s desired and selected search criteria. In one example embodiment, the user 910 may be searching for bars or nightclub, within a selected geographic region, and which are anticipated to have patrons meeting the user’s 910 selected gender, age, ethnicity, attractiveness factor (e.g., the “GDF” component introduced above), and other characteristics of prospects the user 910 desired to meet in person. Various locations 925A, 925B, which could be any number of locations (collectively 925), are discoverable via the social networking system 900 using searches by a querying user 910 performed through a platform or service as disclosed herein.

While providing search results comprising locations, the social networking system 900 can employ feedback 930 to assist with providing of search results to querying users 910, as described above. In particular, feedback 930 may be used within the system 900 to provide a platform or service information regarding both the demographic and personal characteristics of the social “prospects” or “targets” that users of the disclosed principles desired to meet, but also information regarding the type, ambience, features, etc. of locations that are comprised within the search results of users. For example, feedback 930 may be provided by other users 935 acting as reviewers at certain locations 925 searchable by the system 900 in order to help confirm that search results provided to a specific user are accurate. In such embodiments, a user/reviewer may provide real-time information into the system 900 via a platform or service as disclosed herein, such as via an application running on the user/reviewer’s mobile computing device. Such user/reviewers may be specially selected and designated as authorized reviewers by a platform or service, and/or such reviewers may simply be random and voluntary users. In some embodiments, such reviewers may also include the prospects or targets (940A, 940B) querying users are hoping to meet using the disclosed principles. In such embodiments, these reviewers/targets (collectively 940) can confirm that they are at a location 925 and that they possess certain characteristics that are searchable by users of a platform or service. In some embodiments, geolocation data can be used in combination with such reviewers/targets to not only ensure they are at a location that claim to be or are checking in from, but also to ensure they possess some or all of the characteristics they are alleged to have and have been searched for by a user. In some embodiments, provider(s) of feedback to a platform or service may be provided by an agent or agents affiliated with one or more of the locations that are searchable by querying users of the platform or service. As before, this location feedback can be provided to a disclosed platform of service to assist in providing accurate search results to querying users, and may include information such as the personal characteristics of the people at a reporting agent’s location, as well as confirming a type of location, ambience (and vibe/feel) of the location, features of the location, crowd size currently at the location, and other information usable by users to search for potential targets.

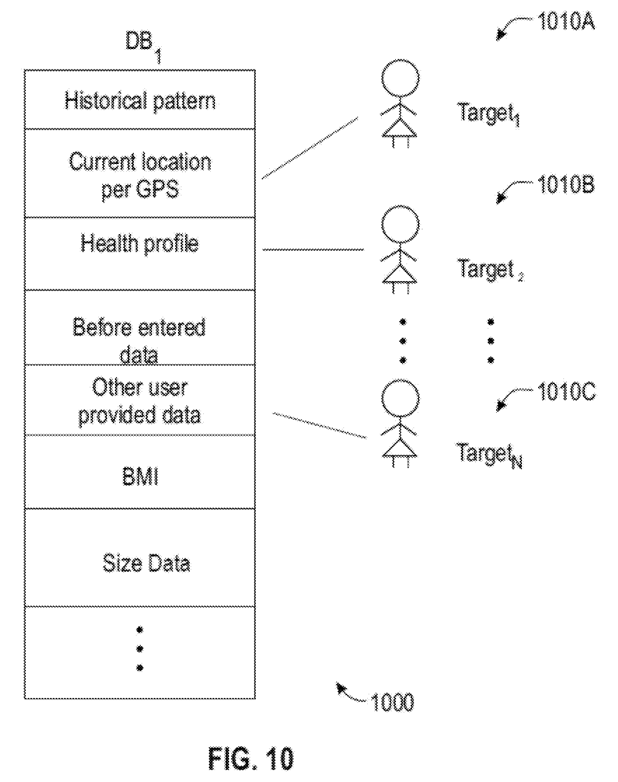

FIG. 10 illustrates a block diagram of a social networking system database 1000 for use with a platform or service in accordance with an embodiment of the disclosed principles. Specifically, in this embodiment, the system database 1000 is a personal information database, which may store data regarding personal information of one or more potential user prospects or targets (1010A, 1010B, 1010C; collectively 1010). In some embodiments, the database 1000 may be comprised, for example, of multiple databases, which in turn may be housed in distinct geographic locations.

Information stored in the one or more database 1000 can comprise, for example, any personal or otherwise usable information on potential targets users of the disclosed principles desire to meet in person, such as current location (e.g., via GPS data from their mobile device), historical pattern of locations visited, health profile, BMI, clothing size, etc. Of course, other types of personal information not illustrated may also be found in the one or more databases 1000, such as gender, race, ethnicity, education, occupation, whether they have children, marital status, religious affiliation, and other information. All such personal information may be found in various databases, such as mobile phone carrier records, education records, tax records, various medical records, medical facility records, social media accounts (including employing recognition technology to scan posted photos/images), purchase histories, and other unique information sources, and which may be accessible by a platform or service as disclosed herein via Terms of Service agreements that people typically agree to without review or objection, or even voluntary disclosure of some or all such personal information in exchange for something of value provided by a platform or service, or by any other party or entity.

Such personal information regarding potential prospects or targets of searching users may be employed by a disclosed platform or service to confirm information provided by user targets. More specifically, in embodiments where potential targets provide feedback to a platform or service by “checking in” at a particular location, such targets may provide not only feedback regarding the location they are at, but also feedback regarding their personal demographics and personal characteristics. However, such targets may provide false or misleading information about themselves, whether intentionally or not, and thus a target database or databases may be employed and queried to corroborate such provided personal information. Such corroboration is again used by a platform or service as disclosed herein to assist in providing as accurate of data as possible to searching users. In fact, even a target’s current GPS information can be used to confirm that they are actually at the location about which they are providing feedback.

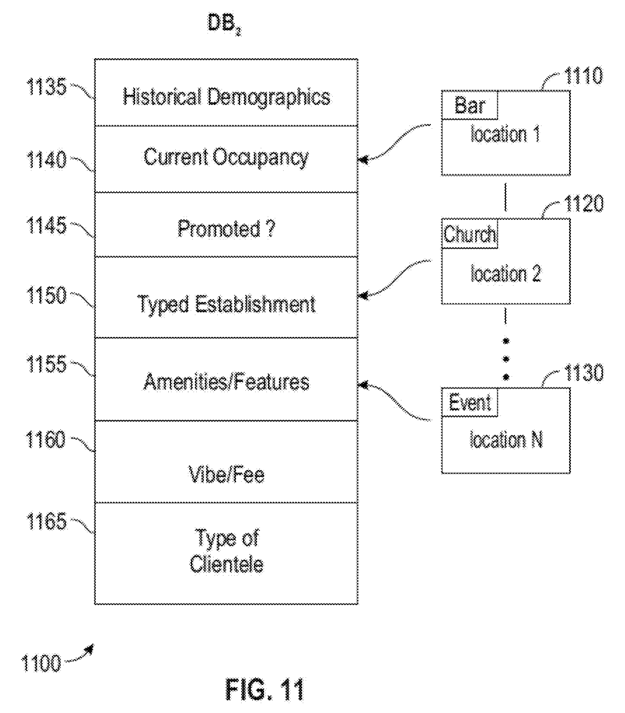

FIG. 11 illustrates a block diagram of a social networking location database 1100 for use with a platform or service in accordance with an embodiment of the disclosed principles. Specifically, in this embodiment, a location database, which stores data regarding information on various locations (1110, 1120 1130) that may be provided as search results to users using a platform or service. In some embodiments, the database 1100 may be comprised, for example, of multiple databases, which in turn may be housed in distinct geographic locations.

In the illustrated embodiment, the location database(s) 1110 may store information related to locations such as a bar 1110, a church 1120, and event venue 1130, and/or any number of locations or location types. For example, for a location there can be data, images, video, audio, and other information categorized and/or tagged with information such as, but not limited to, historical demographics 1135, current occupancy at the location 1140, whether the location is a promoted location 1145 of a platform or system, the type of establishment 1150, amenities or features 1155 of the location, vibe/feel 1160 at the location, the type of clientele typically (or currently) 1165 at the location, and other information that might be relevant to a searching user. Information regarding locations may be obtained from any of a number of sources, such as governmental records, social media accounts and posts, company websites, and/or any database or source having information regarding a possible location. Indeed, information regarding a location may be provided by users and/or targets affiliated with a platform or service as disclosed herein. As before, such location information may also be corroborated with information obtained from users and/or targets affiliated with the disclosed platform or service via their own feedback or through databases of information associated with those users/targets.

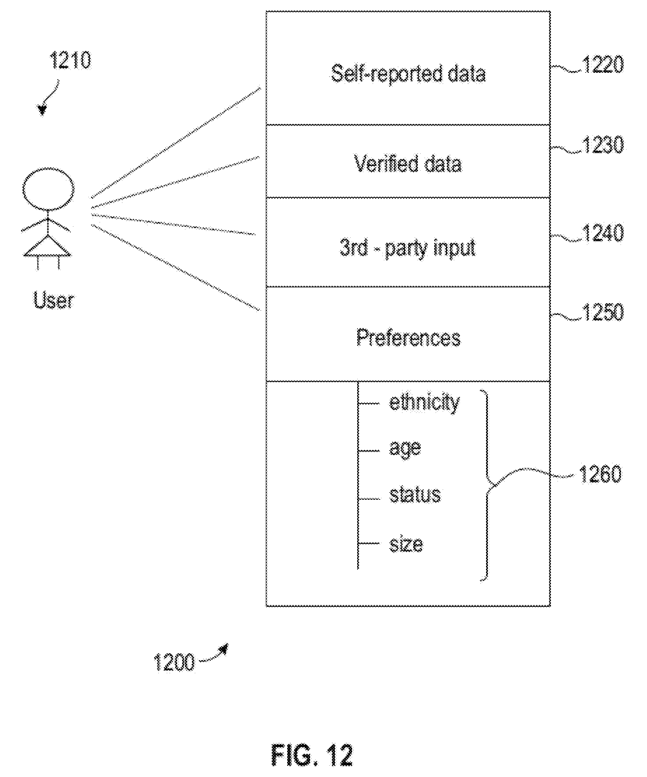

FIG. 12 illustrates a block diagram of a social networking user database system 1200 for use with a platform or service in accordance with an embodiment of the disclosed principles. Specifically, in this embodiment, the user database 1200, which may store data regarding information on users 1210 of a disclosed platform or service to search for social targets. In some embodiments, the user database 1200 may be comprised, for example, of multiple databases, which in turn may be housed in distinct geographic locations.

Information stored in the one or more databases 1200 can comprise, for example, any personal or otherwise usable information, such as the illustrated data self-reported by a user 1220, data about the user 1210 that has been verified 1230, data about the user 1210 provided by a 3rd Party 1240, and search preferences 1250 of the user 1210. For example, in embodiments where the user 1210 employs a platform or service to search for social targets of a romantic nature, stored user information may include the user’s 1210 personal preferences for potential targets, such as ethnicity, age, marital status, body size, and/or other personal information 1260 of desirable targets.

Additional information about a user 1210 that may be stored in the database(s) 1200 may include information similar to that stored on targets, such as current location (e.g., via GPS data from their mobile device), historical pattern of locations visited, health profile, BMI, clothing size, gender, race, ethnicity, education, occupation, whether they have children, marital status, religious affiliation, and other information. As such, in embodiments where a user is a potential social target for a different user, such information may be readily stored and may thus be corroborated.

As is the case with information regarding targets, stored information regarding a user 1210 obtained from or verified using (in cases where the user provided the information) various databases, such as mobile phone carrier records, education records, tax records, various medical records, medical facility records, social media accounts (including employing recognition technology to scan posted photos/images), purchase histories, and other unique information sources. Also as before, such information may be accessible by a platform or service as disclosed herein via Terms of Service or other similar agreements, as discussed above. Furthermore, corroborating information about a user 1210 may be provided by other users or targets at a location where the user 1210 is present as part of the feedback that can be provided to a disclosed platform or service.

### Monetization

Systems, platforms or services constructed and implemented in accordance with the disclosed principles provide a number of ways for monetization. Revenue may be generated through paid advertisements from establishments, such as restaurants, bars and clubs that may comprise, for example, locations that form part of the search results for a searching user. Moreover, certain brands and retailers of various industries, such as alcohol, travel, ride sharing companies, etc., which may be displayed on any of various screens presented to users and reviewers, may also provide paid advertisements for a disclosed platform or service.

In one or more embodiments, a platform or service as disclosed herein may enable a first in-memory configuration, that is, a user registered with the platform, to designate their profile or associated network as monetized. A monetization designation may be received from a given first in-memory configuration and processed by a host application via one or more processors. A monetization designation may condition access to one or more of the following: a given first in-memory configuration itself (i.e., a user’s full profile and personal information); network connections associated with a given first in-memory configuration (i.e., a user’s social or professional network within a platform); or data outputs derived from the given first in-memory configuration, such as personalized venue recommendations generated based, at least in part, on that user’s attendance history and preferences; upon receipt of a fee parameter specified by the given first in-memory configuration. A fee parameter may be set by a user as a fixed amount, a recurring subscription rate, and/or another pricing structure, and may be updated by the user at any time. Upon processing the monetization designation, a given first in-memory configuration may be designated a monetized first in-memory configuration within a platform’s data structures.

When a requesting first in-memory configuration (searching user) seeks access to a monetized first in-memory configuration, a host application may electronically process a payment transaction received from a requesting remote user device in connection with the fee parameter specified by the monetized first in-memory configuration. Upon confirmation of a payment transaction, a host application may electronically transmit one or more digital signals granting a requesting first in-memory configuration access to a monetized first in-memory configuration via a communications network. This user-driven monetization model provides a mechanism by which higher-ranked users, those with elevated popularity scores as described in connection with the leaderboard embodiments, may derive financial value from their prominence on a platform, while also incentivizing other users to maintain high-quality profiles and active engagement with the platform’s features.

Also, a premium (paid) version of a platform or service may be provided, which for a periodic fee can remove the presentation of some or all advertisements to users. Although removing the advertisements, etc., periodic fees still provide a level of monetization for a platform or service as described herein. However, even with premium versions of a platform or service that remove advertisements, monetization may still be possible via other means as our known and understood in the art.

### Premium Versions

A premium version may be configured to provide certain advantages over free or ad-supported versions of a disclosed platform or service. For example, a premium version may provide real-time results of social prospects a user is searching for. Specifically, a non-paid version of a platform or service as disclosed herein could be configured to only provide past/historical information on where searched—for social prospects have been found. Such a version may still provide users valuable information regarding where their desired prospects have historically been found, as well as the days and times they have historically been at certain locations. However, in a premium version, users may be provided real-time information regarding where their desired social prospects may currently be found. Such real-time information provides an incredible advantage to paying users in meeting their desired prospects.

Also, in addition to simply charging such premium users a fee for the premium version of a platform or service, such premium features may be obtained by other means. For example, users may be rewarded for provided reviews, confirmations, and/or other types of feedback to a platform or service. Even high levels of use of a platform or service as disclosed herein can warrant rewarding a user simply due to the number of advertising impressions they’ve been served. In some embodiments, such rewards may be in the form of points or other accumulating units, where earning a predetermined level of points permits access to one or more premium features, and/or to a premium version of the platform or service overall, but perhaps for only a limited time. In some embodiments, instead of earning points, users may be permitted to retain access to a premium version only if they provide a minimum amount of feedback within a predetermined period, such as monthly. In advantageous embodiments, such rewards, points, and/or other means for earning access to a premium version of a platform or service may not be actually earned until the feedback or review information provided a user has been confirmed. In some embodiments, a combination of one or more of the above-discussed ways of obtaining premium access may also be implemented.

### Gamification

In some embodiments of a platform or service in accordance with the disclosed principles, “gamification” of the use of a platform or service may also be employed. Any of a variety of ways to “gamify” a platform or service can be used, for example, to encourage feedback, to reward users for premium status level, or to simply encourage more use of a platform or service in general. In one embodiment, such gamification may be similar to Pokemon Go® where users can earn points for using a platform or service to search for social prospects, for meeting people using the platform or service, or providing verifiable feedback for the platform or service. Additionally, in some embodiments, users may be encouraged/rewarded for posting their personal characteristics on a platform or service, for example, to see if other users would like to meet them. Promotions held by particular locations could similarly reward users for visiting their particular establishment as one of many possible search result locations for potentially meeting desired social prospects. Such rewards could be in the form of points, and/or perhaps other financial incentives like free drinks or other discounts at a location.

In some embodiments, a socialization component of a platform or service as disclosed herein could provide a gamification aspect. For example, instead of a single person looking to meet single social prospects, a user may instead be able to denote that he or she is one of a group of three or some other number in a group looking to meet desirable social prospects. A disclosed platform or service could then be used to provide locations where the same number of social prospects matching searched for characteristics are located in a group. In such embodiments, a group of social prospects who use a platform or service can earn points or other rewards for alerting the platform or service about the size of their group. Moreover, in some embodiments, providing a searching user that is part of a group looking to meet the same or similarly numbered group of social prospects this capability may be a premium feature of a disclosed platform or service, as discussed above.

In one or more embodiments, a platform or service as disclosed herein may electronically maintain, via a host application, one or more leaderboard data structures ranking first in-memory configurations, that is, user profiles registered with the platform, by a computed popularity score within one or more geographic regions. Leaderboard data structures may be stored in one or more databases accessible to a host application and updated in real time or at periodic intervals as new data points are received. A leaderboard may provide a gamification mechanism that incentivizes platform engagement by surfacing the most socially active, sought-after, and community-validated users within a given geographic area, thereby encouraging users to maintain active and accurate profiles and to participate regularly in a platform’s socialization features.

A popularity score associated with a given first in-memory configuration may be computed based, at least in part, on one or more of the following signals: (i) a number of requesting first in-memory configurations that have accessed or requested access to a particular first in-memory configuration, reflecting how frequently other users have sought out or viewed the particular user’s profile; (ii) a frequency at which a particular first in-memory configuration appears in identified subsets corresponding to other requesting first in-memory configurations, reflecting how often the particular user appears as a matching social prospect in other users’ search results; (iii) community-contributed ratings associated with a particular first in-memory configuration, reflecting qualitative assessments of the particular user’s socialization value submitted by other users of the platform; or any combination thereof. A popularity score may be normalized, weighted, and/or otherwise transformed to produce a consistent ranking metric across users within a particular geographic region.

In one or more embodiments, one or more leaderboard data structures may be filtered according to one or more categorical parameters associated with respective first collections of elements of first in-memory configurations. Such categorical parameters may include one or more of the following socialization categories: friendship, reflecting users seeking non-romantic social connections; business networking, reflecting users seeking professional contacts or collaborators; romance, reflecting users seeking romantic social prospects; or any combination thereof. By filtering a leaderboard according to socialization category, a searching user may identify the most popular and sought-after users within their geographic region whose socialization goals align with their own, enabling more targeted and purposeful in-person social connections. Filtered leaderboard data structures may be electronically transmitted by a host application as one or more digital signals to a requesting remote user device via a communications network for display within a graphical user interface of a platform.

### Metaverse Applications

In addition to providing users of a platform or service as described herein unprecedented information on geographical locations to meet social prospects that match their desired characteristics, the disclosed principles are not limited to physical locations. In some embodiments, a platform or service as disclosed herein can provide users information on where and when to meet desired social prospects in virtual locations. More people in today’s online age are meeting, or hoping to meet, others in a virtual setting rather than in person. A platform or service as disclosed herein can provide the same unique advantages and features discussed above for geographic locations in virtual environments. As such, a searching user could search for metaverse locations having potential social prospects that match their desired characteristics. Moreover, where searches for meeting social prospects in-person may focus on characteristics related to the physical world, such as physical appearance, income, marital status, whether they have any children, etc., characteristics for users searching for social prospects in the metaverse may instead focus on characteristics of a social prospect’s avatar, a social prospect’s status in a particular game or location in the metaverse, or other characteristics related more towards virtual environments rather than physical realms. Of course, a combination of such real-world and metaverse characteristics may also be employed by a searching user.

The present disclosure may include a computing device that can include any of an application specific integrated circuit (ASIC), a microprocessor, a microcontroller, a digital signal processor (DSP), a field-programmable gate array (FPGA), and/or equivalent discrete or integrated logic circuitry. In some examples, a system may include multiple components, such as any combination of one or more microprocessors, one or more microcontrollers, one or more DSPs, one or more ASICs, or one or more FPGAs. It would also be understood that multiples of circuits, processors, and/or controllers could be used in combination or in tandem, or multithreading. Additionally, it would be understood that a browser or program could be implemented on a mobile device or mobile computing device, such as, a phone, a mobile phone, a cell phone, a tablet, a laptop, a mobile computer, a personal digital assistant (“PDA”), a processor, a microprocessor, a micro controller, and/or other devices or electronic systems capable of connecting to a user interface and/or display system. A mobile computing device or mobile device may also operate on or in the same manner as a computing device disclosed herein or be based on improvements thereof.

Components of the present disclosure may include any discrete and/or integrated electronic circuit components that implement analog and/or digital circuits capable of producing the functions attributed to the modules herein. For example, components may include analog circuits, e.g., amplification circuits, filtering circuits, and/or other signal conditioning circuits. Components may also include digital circuits, e.g., combinational or sequential logic circuits, memory devices, etc. Furthermore, modules may comprise, for example, memory that may include computer-readable instructions that, when executed cause the modules to perform various functions attributed to the modules herein.

Memory may include any volatile, non-volatile, magnetic, and/or electrical media, such as a random-access memory (RAM), dynamic random-access memory (DRAM), static random-access memory (SRAM), read-only memory (ROM), non-volatile RAM (NVRAM), electrically-erasable programmable ROM (EEPROM), flash memory, hard disks, and/or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, and/or any other number of possible drives or discs, that are executed by the internal logic of a computing device. It would be understood that a tangible non-transitory computer readable medium could also be considered a form of memory or storage media.

It should be noted that the term “button” has been utilized in an inclusive manner and may also be utilized to indicate an area that allows a user to engage or link to additional data, information, webpages, operations, actions, and/or otherwise engage with a computing or mobile computing device.

### Example Mobile Device Application

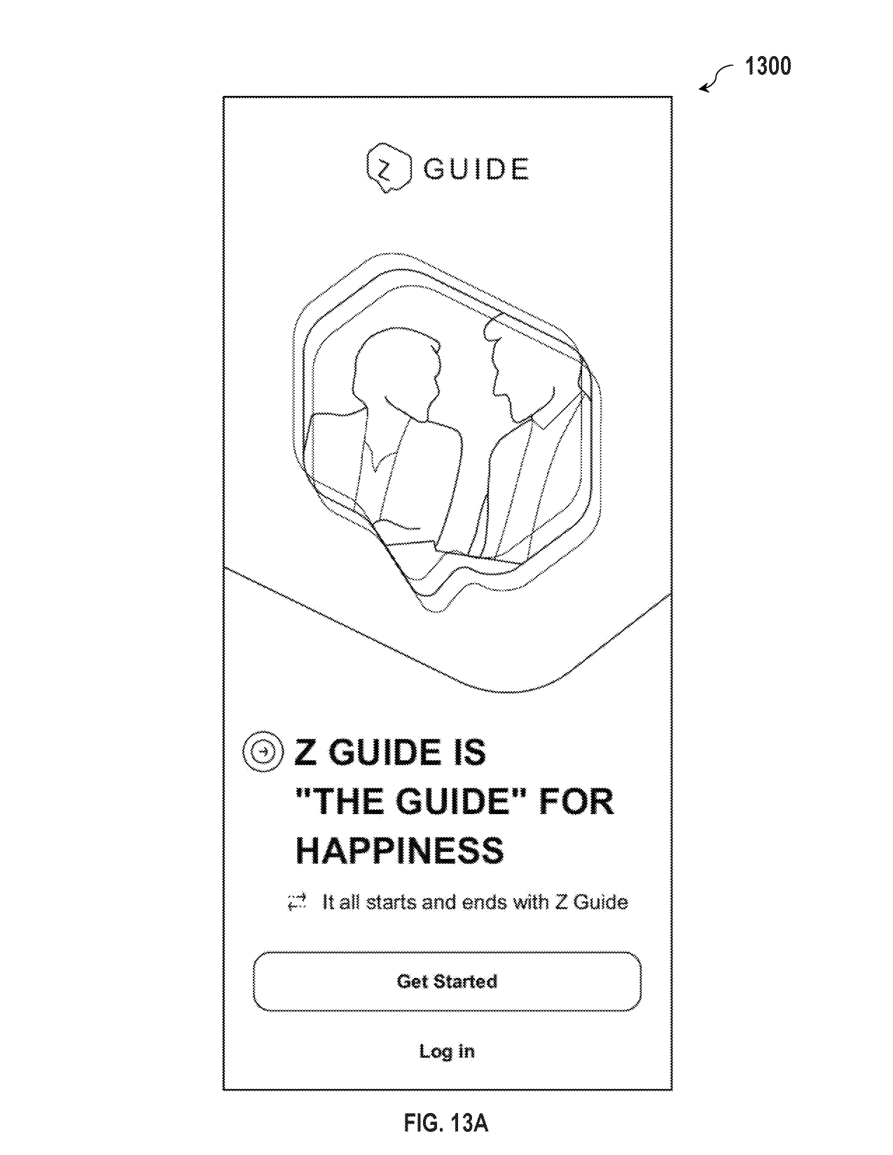

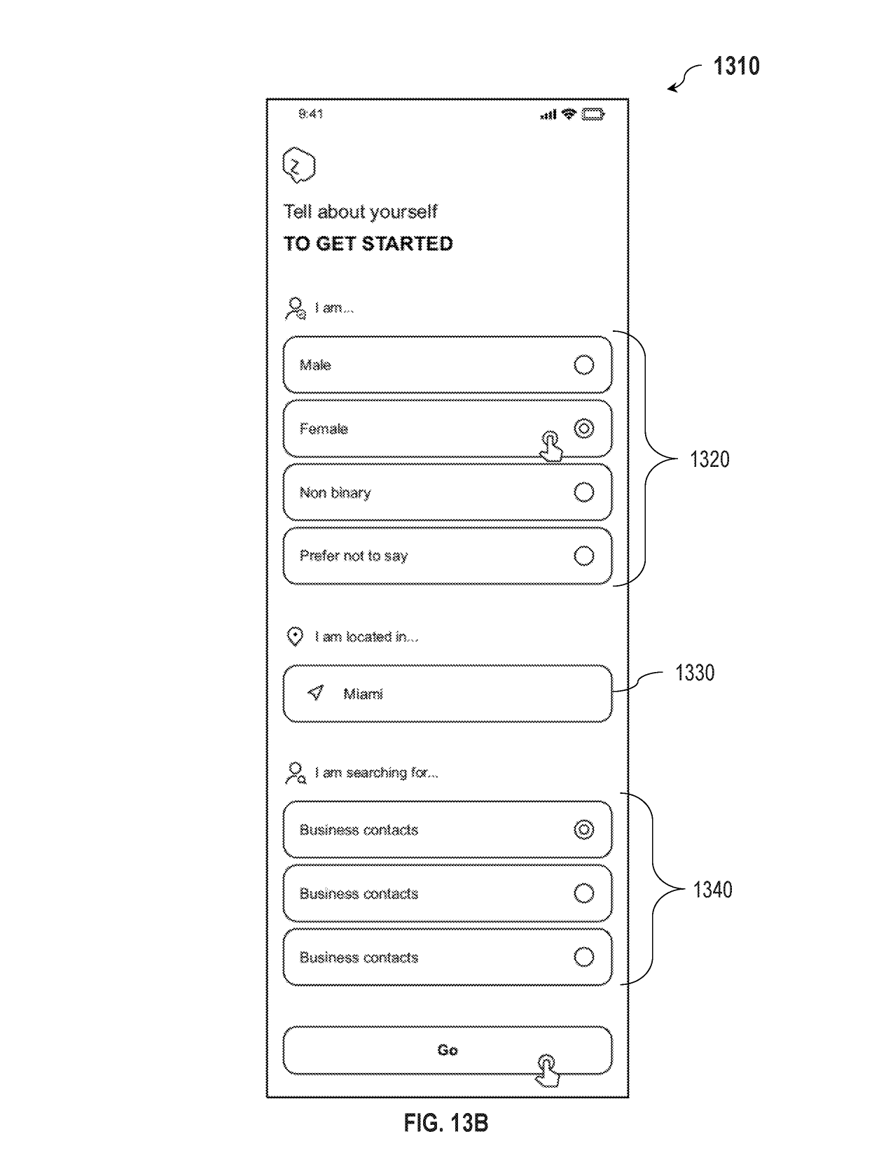

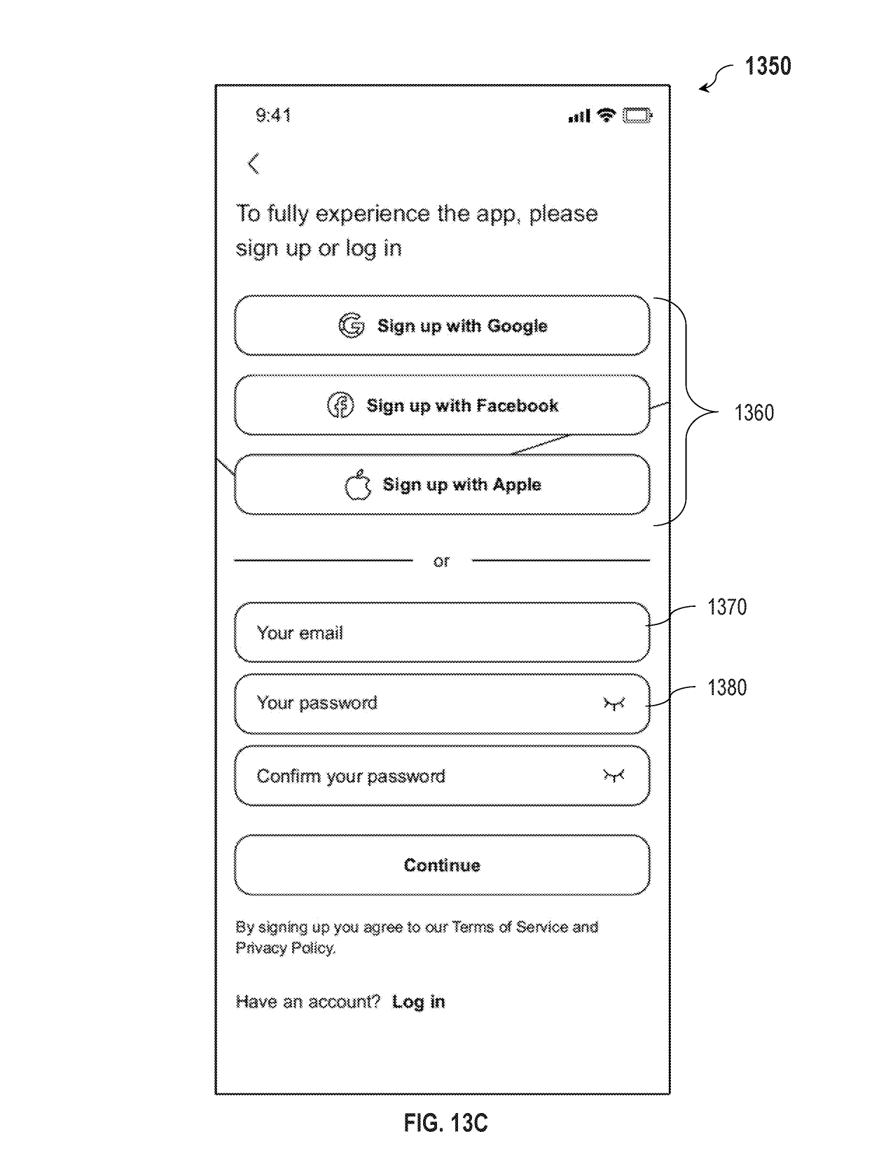

FIGS. 13A-13C illustrate example screenshots of various account login and signup options from a mobile device application for use with a platform or service in accordance with the disclosed principles. FIG. 13A provides a screenshot 1300 of one embodiment of an introductory welcome screen for a user or potential user of a platform or service associated with a mobile application. On such a screen, the user may have the option to log in with their personal credentials if they already have an account with a platform or service, and/or to create such an account in the first instance.

FIG. 13B illustrates a screenshot 1310 of one embodiment of a page where a new user may input their personal information in order to create an account on a platform or service. In this embodiment, a user may provide their gender information 1320, their geographic location 1330, and their intended purpose 1340 for becoming a user of a platform or service. For example, as discussed in detail above, a user may wish to join in order to search for and find potential romantic prospects, potential new friends, and/or potential business prospects, all of which are social prospects as disclosed herein. A user may select one or more such options for using a platform or service as disclosed herein, and then tailor their future searches and matches of social prospects while using a platform or service.

FIG. 13C illustrates a screenshot 1350 of one embodiment of a page where a new user may provide their personal information in order to create an account on a platform or service by linking one or more previously existing accounts 1360 of the user. In this embodiment, a user may create their account by using their sign in credentials and information associated with their Google account, with their Facebook account, or with their Apple account. Of course, any preexisting account of a user may be used in this manner, such as an Instagram account, a Twitter account, a LinkedIn account, etc. Once a user has provided login credentials to a platform or service via a mobile application, the user may then provide their email address 1370 or other contact information, as well as a secure password 1380 for accessing their newly created account.

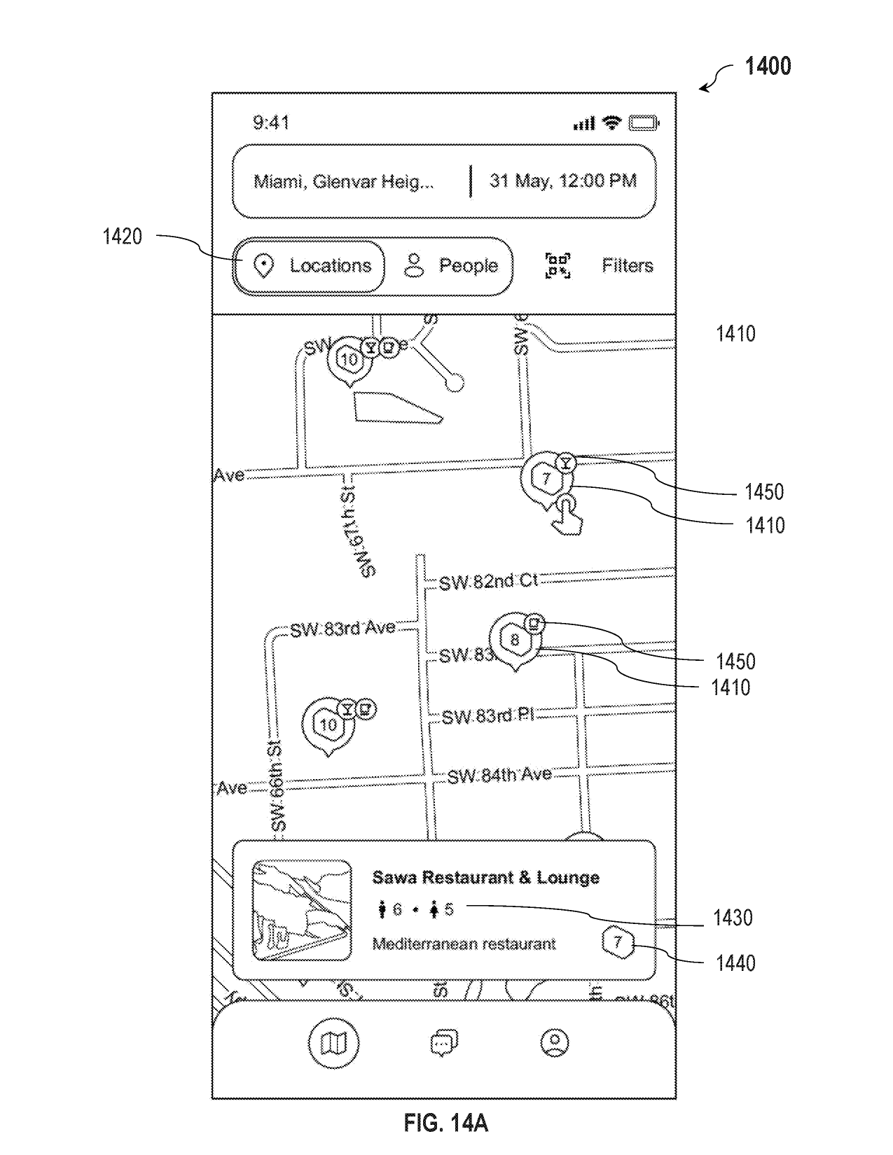

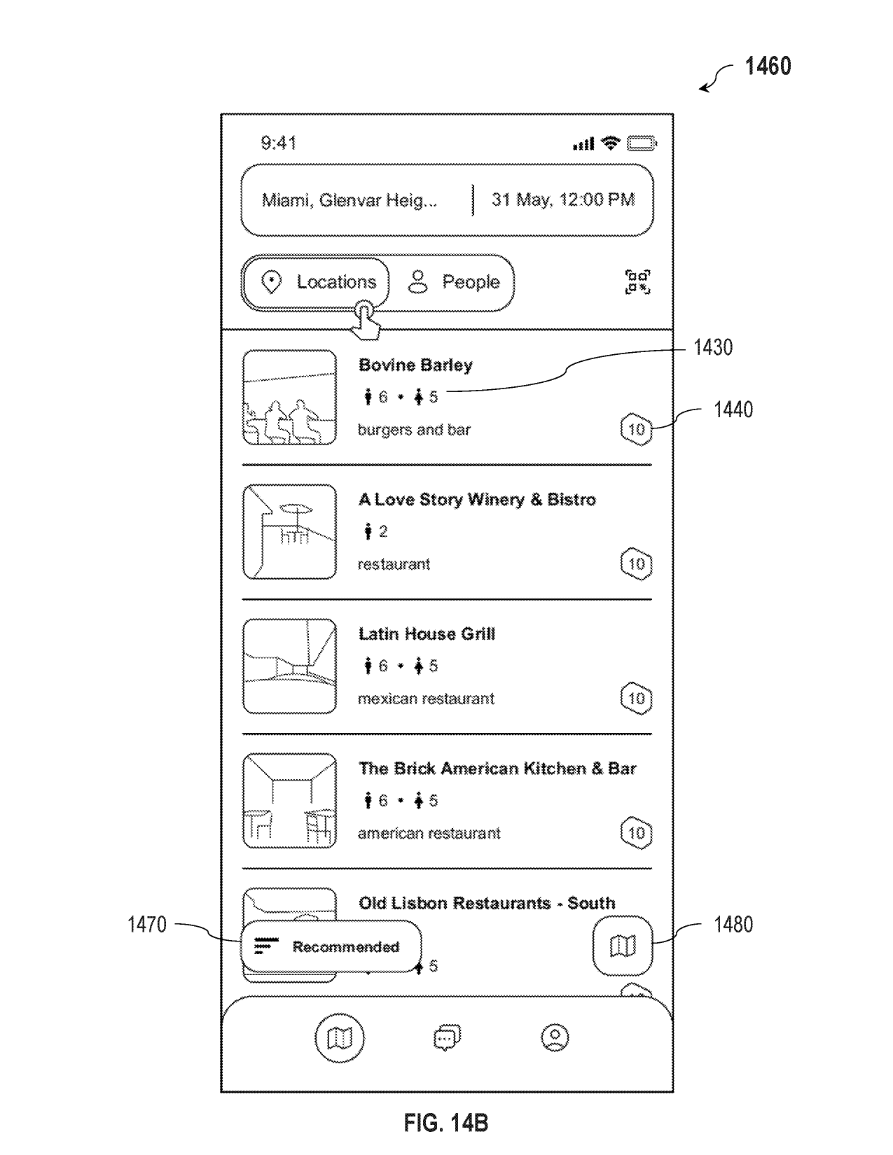

FIG. 14A illustrates an example screenshot 1400 from a mobile application, for use with a platform or service in accordance with the disclosed principles, of an interactive map presenting establishments 1410 matching search criteria of a user of the mobile application. In particular, the “Locations” button may be selected by a user so that icons representing the geographic location of the matching establishments 1410 are shown.

To find matching establishments, a user may enter search criteria of desired social prospects, and a platform or service as disclosed herein provides search results in the form of geographic locations 1410 where prospects matching the user’s search criteria may be found or may have been in the past. Searches may be conducted in the manner discussed above, and/or artificial intelligence (AI) may be employed to develop a search on behalf of a user. AI implementations are discussed in further detail below.

As illustrated, locations/establishments 1410 matching a user’s search criteria are not only illustrated using interactive icons, but such icons may include a rating factor, such as those discussed above, of the establishment 1410 in the manner discussed above as well. In this illustrated embodiment, ratings may be different from one establishment 1410 to another, and may be developed in any of a number of different ways. For example, establishment ratings (which may colloquially be known as a “Z Score” or “Z Rating” or “Z Factor”, in addition to example labels mentioned above) may be a conglomeration of ratings provided by users of a platform or service. In other embodiments, a provided rating may be determined by a platform or service, and may also be determined at least in part by information provided or garnered from the establishments’ 1410 interaction with the platform or service. In yet other embodiments, AI may be implemented to determine ratings of individual establishments by scraping information from any applicable source to provide an appropriate rating to one or more establishments 1410. In even further embodiments, establishment ratings may differ when displayed to individual users of a platform or service, where each may be determined with influence from each particular user’s profile/personal information and/or their interaction with the platform or service. Of course, any technique for developing a rating for a particular establishment may be employed.

Additionally, presented icons of one or more establishments comprising search results may be interactive. For example, a user may click on a particular icon to view more details about that establishment, as illustrated at the bottom of the screen in FIG. 14A. Also as illustrated, further details about a selected establishment may include the number of other users 1430 currently present at the establishment, and may display the number of users present by gender or other categories. Moreover, an icon displaying the rating 1440 of an establishment may be interactive so as to display to a user more details about that rating, what comprises the rating, and perhaps even how the rating for that establishment was developed.

Also illustrated in relation to rating icons for one or more establishments are additional icons 1450. These are shown as a martini glass or a coffee cup, although any shape or item may comprise, for example, these additional icons 1450. The meaning of these additional icons 1450 are “offers” presently being extended by other users (i.e., potential social prospects) at one or more particular establishments. In example embodiments, a martini glass icon may be displayed at a particular establishment to indicate that another user currently has extended an “offer to buy a drink” to a social prospect of theirs. This may or may not be an original user viewing the screenshot of FIG. 14A, based, at least in part, on criteria a user extending a drink offer. Similarly, a coffee cup icon may be displayed at a particular establishment to indicate that another user currently has extended an “offer to have a cup a coffee” to a social prospect of theirs. Again, this may or may not be an original user viewing the screenshot based, at least in part, on criteria a user extending an offer. Moreover, a type of offer being extended may be based, at least in part, on a goal of a user extending an offer. Thus, an “offer to buy a drink” could mean that a user has a romantic interest in meeting a social prospect, while an “offer to have a cup of coffee” could mean that a user would like to meet social prospects for business networking. Of course, any type of icon can be used to indicate these intentions of users currently located at displayed establishments.

Moreover, additional icons 1450 may be displayed to indicate other intentions for meeting social prospects, such as meeting prospects for friendly reasons (e.g., participating in activity together, such as tennis or chess), meeting prospects that children for the purpose of finding playmates for a user’s child or children, and/or for any reason that a user may want to meet another user socially. In yet other embodiments, a number may be included in such additional icons 1450 to indicate a number of particular offer types extended at a particular establishment, while in some embodiments, the additional icons 1450 may be clickable to find out such information. Doing so may cause another screen indicating such information to be displayed to a user.

Turning briefly to FIG. 14B, illustrated is a screenshot 1460 presenting a list view of establishments displayed geographically on a map of FIG. 14A. Such a list view may permit a user of a mobile application to quickly scroll through all establishments comprising search results without having to click on an icon of an establishment displayed on a prior map view. A list of establishments may also be sortable using any of a number of criteria, such as alphabetical sorting or sorting based, at least in part, on the magnitude of the rating 1440 particular establishments have. Other sorting criteria may include a number of potential social prospects 1430 at particular locations (even the number of a certain gender), a type of establishment (e.g., bar vs. restaurant vs. nightclub), AI providing a sorting of the list based, at least in part, on a user’s search criteria, and/or any other desirable sorting criteria. Also, a “Recommended” button 1470 may be provided for such sorting based, at least in part, on a user’s previously determined search criteria or their interactions with a platform or service when searching previously. Finally, a map view button 1480 may be provided so that a user may switch back to the map view of FIG. 14A, when desired.

In one or more embodiments, a host application may electronically identify a subset of second in-memory configurations (establishment profiles) as hotspot configurations. A hotspot configuration may be an establishment profile at which a concentration of user profiles having elements corresponding to those of the requesting first in-memory configuration, are currently associated, predicted to be associated, and/or have historically been associated during comparable temporal parameters with a respective establishment. A determination of hotspot status may be based, at least in part, on one or more of the following: real-time check-in data points reflecting current attendance by matching users; predicted attendance data points generated by a computational inference model described herein; historical check-in data points corresponding to one or more temporal parameters comparable to those of the current search; or any combination thereof. Upon identification, one or more digital signals may be electronically transmitted by a host application to a requesting remote user device via a communications network, causing an identified hotspot configurations to be rendered with elevated prominence relative to non-hotspot establishment profiles within a graphical user interface of a requesting device. Such elevated prominence may be expressed visually through, for example, a distinct icon, a highlighted map marker, a top-ranked position in list views, and/or other visual differentiators that draw a searching user’s attention to establishments most likely to have the highest concentration of compatible social prospects.

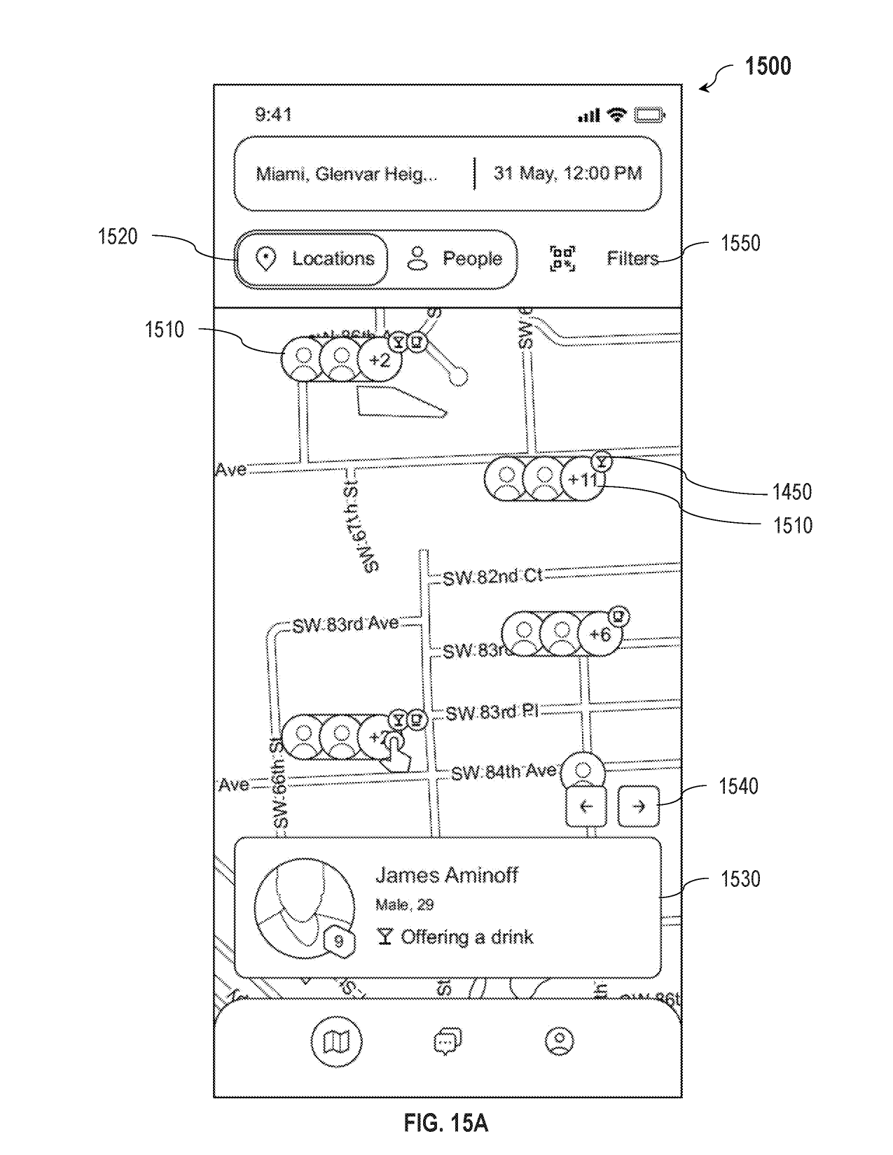

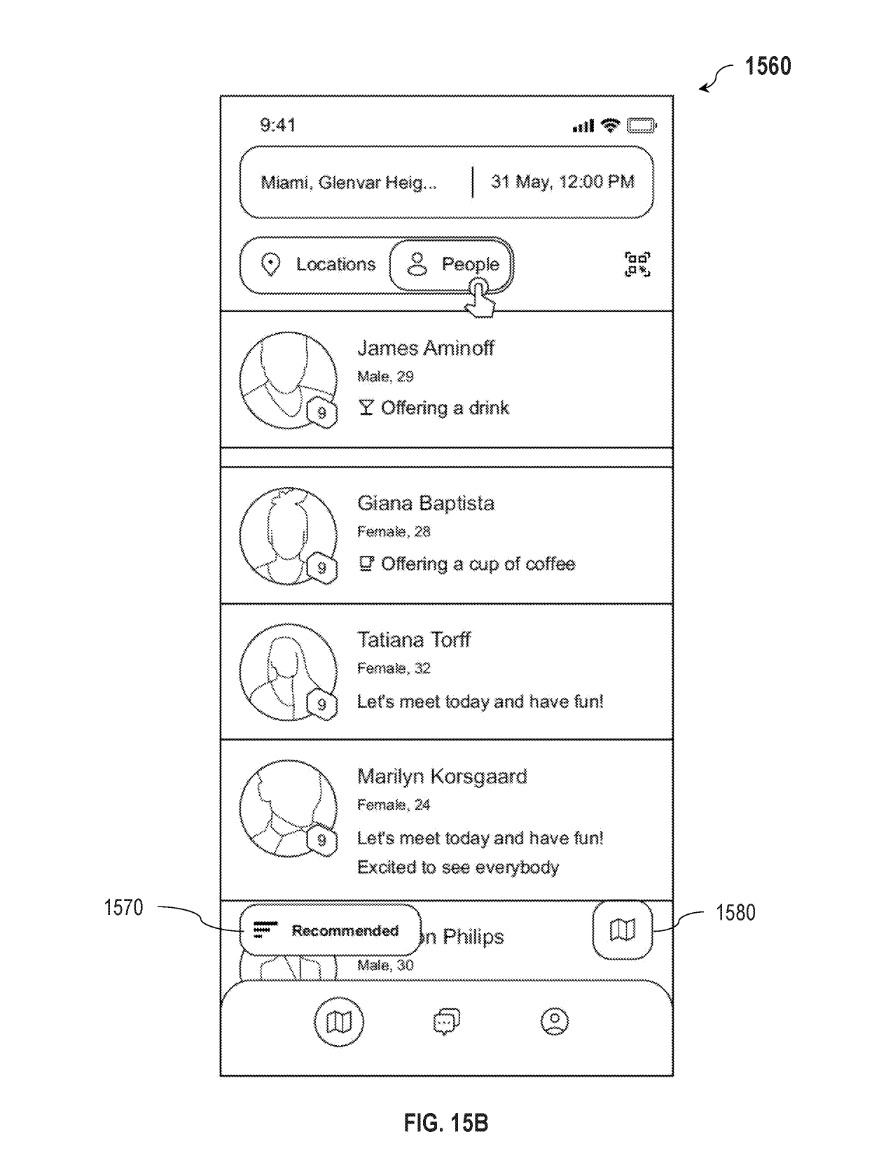

Looking now at FIG. 15A, illustrated is an example screenshot 1500 from a mobile application, for use with a platform or service in accordance with the disclosed principles, of an interactive map presenting social prospects 1510 (e.g., other users) matching search criteria of a user of a mobile application. In particular, the “People” button 1520 is selected by a user so that icons representing specific prospects at particular geographic locations of matching establishments are shown. As illustrated, icons representing prospects at particular establishments, which in this example are profile pictures of the individual prospects 1510. Additionally, the number of potential social prospects 1510 may also be displayed as part of icons, and in situations where the number of prospects 1510 at a particular establishment is too large to display all of their profile images, only the first few prospects’ images may be displayed on a map. Moreover, the few that are displayed may be selected by a platform or service (via AI or other means) to be prospects that most closely match a user’s search criteria. In other embodiments, the few that are displayed may be selected randomly.

Also illustrated on or proximate to icons representing prospects at particular establishments are the additional icons 1450 discussed above. Specifically, these additional icons 1450 may comprise, for example, the aforementioned martini glass or coffee cup icons (or other possible icons having different meanings) discussed in detail above. Also illustrated in FIG. 15A at the bottom of the screenshot is a pop up 1530 of a particular prospect currently at an establishment. In this embodiment, a user has clicked one of the icons 1510 to display on the pop up 1530 having more information about a particular social prospect. Example information that may be displayed in the pop up 1530 can include one or more profile images, a specific rating factor of a prospect, personal information about the prospect, and whether the prospect is a user who has “offered to buy a drink” or “offered to buy a cup of coffee”. Moreover, in some embodiments, a user may be able to click the pop up 1530 to access an entire profile of a prospect. Also as illustrated, navigation buttons 1540 may be provided so that a user may progress forward or backward through the prospects 1510 present at the various displayed establishments, where particular prospects may appear in the pop up window 1530 as the user progresses through the present prospects 1510.

A “Filters” button 1550 may be provided so that a user may also filter displayed icons and associated prospects 1510 based, at least in part, on any of a number of criteria selectable by the user. For example, a user may wish to filter displayed results so that only a certain gender of prospects is displayed and/or perhaps only those prospects offering a drink or a cup of coffee. In some embodiments, prospects may be filtered based, at least in part, on a rating factor of present prospects. In yet other embodiments, AI may be used to filter displayed prospects at particular establishments such that only those likely to match a user’s criteria will be displayed. In such embodiments, a choice to manually filter or filter using AI may be provided via clicking the Filters button, which in turn may display or pop up a filtering screen, which may be interactive with a user.

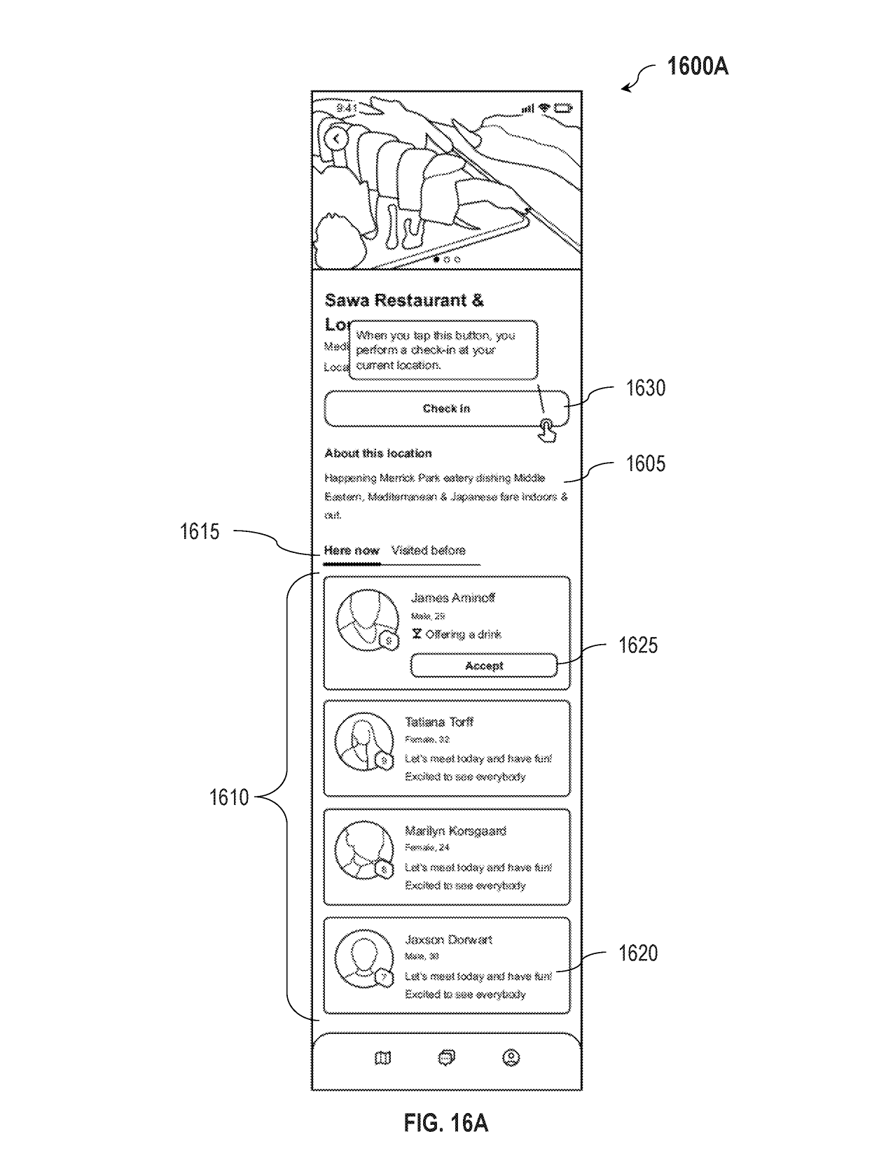

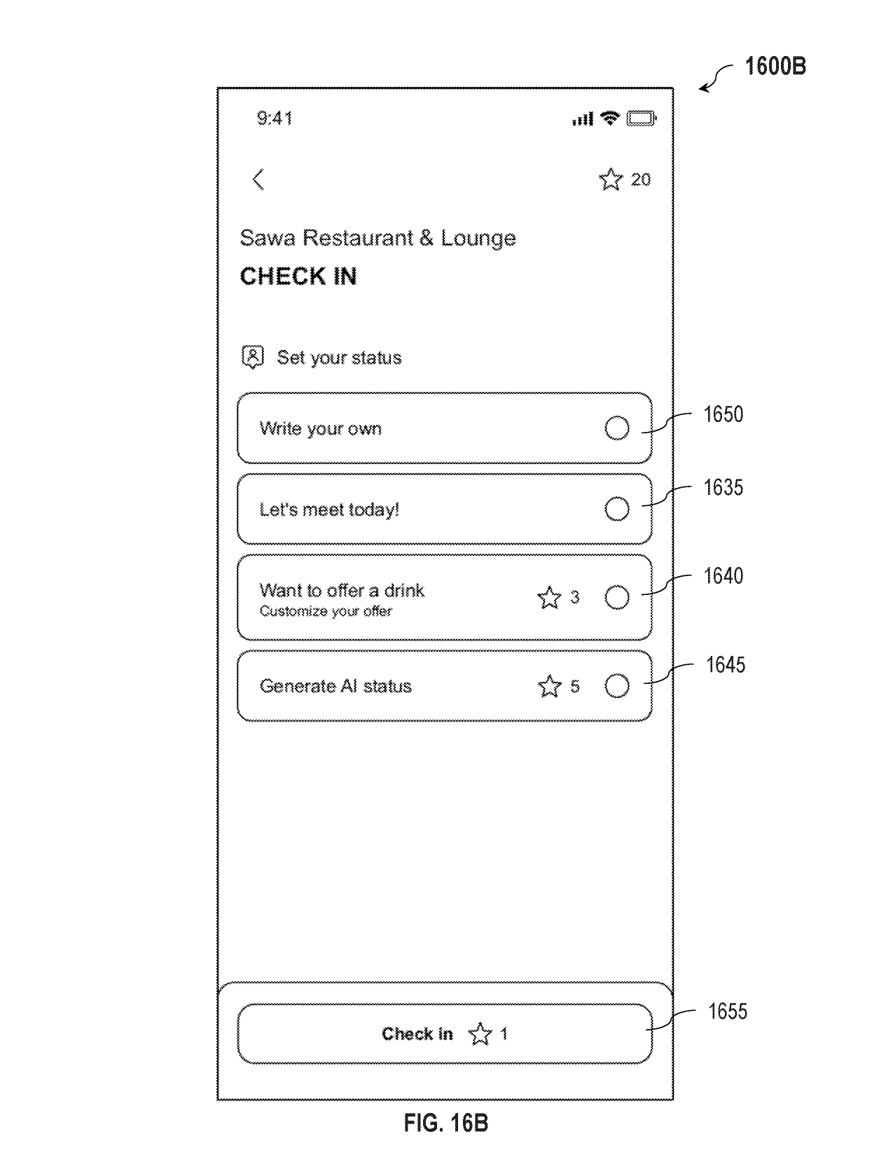

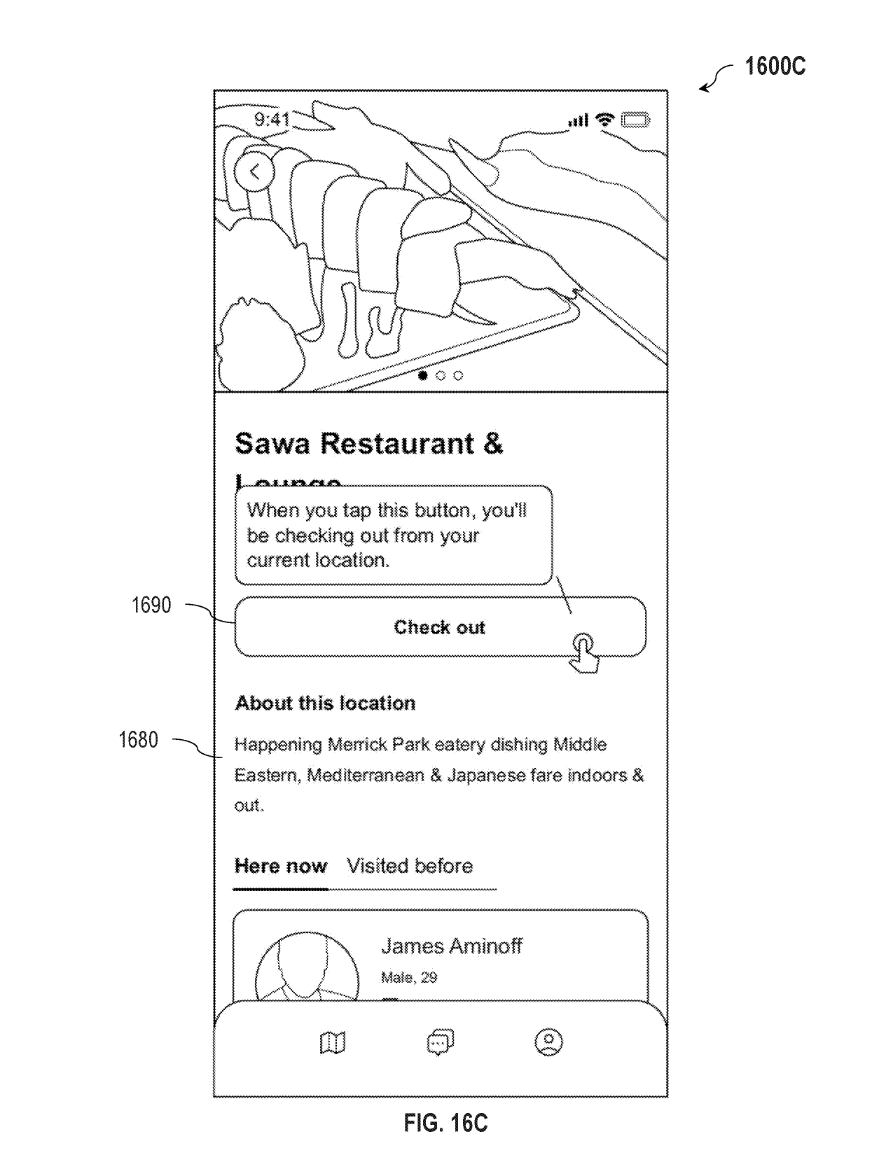

Turning to FIG. 15B, illustrated is an example screenshot 1560 from a mobile application of a list view for the social prospects matching search criteria of a user of a mobile application and illustrated in the map view of FIG. 15A. Such a list view permits a user of a mobile application to quickly scroll through all presented social prospects comprising search results without having to click on an icon of particular prospects displayed on a prior map view. A list of prospects may also be sortable using any of a number of criteria, such as alphabetical sorting or sorting based, at least in part, on the magnitude of a rating particular prospects have. Other sorting criteria may include the gender or other personal characteristics of potential social prospects, AI providing a sorting of a list based, at least in part, on a user’s search criteria or previous interaction with a platform or service, and/or any other desirable sorting criteria. Also, a “Recommended” button 1570 may be provided for such sorting based, at least in part, on a user’s previously determined search criteria or their interactions with the platform or service when searching previously. Finally, a map view button 1580 may be provided so that a user may switch back to the FIG. 16A illustrates an example screenshot 1600A from a mobile application, for use with a platform or service in accordance with the disclosed principles, of details associated with a single establishment matching search criteria of a user of the mobile application and selected by the user. An example screenshot 1600A may provide detailed information 1605 about an establishment. In some embodiments, a rating factor of a selected establishment may be presented to a user. As before, an icon (not illustrated) displaying a rating factor may be selected by a user to display details of how a rating factor for an establishment was determined.

Additionally, as illustrated, such a screenshot 1600A can provide a user a list 1610 of social prospects currently located at a same establishment. More specifically, a “Here now” tab 1615 may be selected by a user to present a list of currently present social prospects. Such a list, as in the examples discussed above, may be organized, sorted, and filtered as desired by a user. Within the list 1610 of social prospects, additional details 1620 of particular prospects displayed to a user may be provided. Such details may include, for example, a rating factor of particular prospects, personal characteristics of particular prospects, and whether or not particular prospects have indicated a desire to meet other people while they are at an establishment. As before, the list 1610 may be clickable by a user to access a full profile of a selected prospect, if desired. Also, as illustrated, if a social prospect has indicated their desire to meet other people by “offering a drink” or “offering a cup of coffee”, and/or any other means of providing such an indication, a button 1625 may be provided to a user so that they can accept that prospect’s invitation. In the illustrated example, a button 1625 marked “Accept” is provided so that a user can accept that prospect’s offering of a drink to someone. In other embodiments, buttons or other means (not illustrated) may be provided to a user so that the user may select to “offer a drink” or “offer a cup of coffee” to a present prospect.

Also illustrated in this embodiment of the screenshot 1600A is a “Check in” button 1630, which may function as the Check In button(s) discuss in detail above. For example, a user can “check in” once they are at a geographical location of a particular establishment. As before, an example mobile application may work with a location technology of the mobile device on which it is executing, such as GPS, to ensure that a user is actually at a geographic location of an establishment when they are checking in. By “checking in,” a platform or service may permit a user to not only confirm their location at a selected establishment, but also to provide feedback regarding the accuracy of search results provided by the platform or service, as described above. Advantageously, once a user “checks in” at a location, other mobile applications executing on other users’ devices, which are also in communication with a platform or services as disclosed herein, may be updated to indicate to those other users the presence of a checked in user at an establishment.

Looking briefly at FIG. 16B, illustrated is a screenshot 1600B of a “Check In” screen of the mobile application of FIG. 16A. On this screen 1600B, a user may provide their “status” while at an establish at which they are checking in. Example statuses may include indicating to other users 1635 (which may be limited to only matching users found during a search for prospects as disclosed herein), indicating that the user is “offering a drink” 1640 to other (matching) users, and/or the user can elect to have an AI engine generate their status 1645 for them. Alternatively, a user may elect to write their own status 1650, for example, if any available option or an AI generated status is not acceptable to the user. Once a user has set their status, or perhaps elected not to set a status at all, the user can click the “Check In” button 1655 to complete a check in process at an establishment. Such status information may then be available to other users of a platform or service disclosed herein.

Returning to FIG. 16A, also illustrated in the screenshot 1600 is a “Visited before” tab 1670. This tab 1670 may be selected by a user to display a different list of social prospects, which are prospects that have visited an establishment in the past. As with the prior lists, this list of prospects may also be sorted or organized in any advantageous manner. Similarly, this list of prospects may again be interactive such that a user may select a display of a prospect in order to access that prospect’s full profile. A platform or service as disclosed herein can determine that a prior user/prospect has previously visited an establishment in a number of different ways. For example, a prospect may have checked in at an establishment in the manner disclosed herein, and a date and time that the prospect checked in and was at the establishment in the past may also be presented to a user. Additionally or alternatively, a prior location of prospects at a particular establishment may be determined via location technology of a device on which a mobile application in accordance with the disclosed principles is executing. Information regarding these users that previously visited an establishment can include personal characteristics of a person, images of the person, whether the person offered or accepted any drinks or cups of coffee (or similar offers/acceptances), a rating factor attributed to that person, and/or any other useful information as disclosed herein.

In one or more embodiments, locations associated with identified first in-memory configurations (other user profiles associated with matching establishments) may be predicted future locations electronically generated by a computational inference model executed by a host application. Such predicted future locations may be computed based, at least in part, on aggregated data points indexed according to one or more temporal parameters and reflecting behavioral patterns associated with identified first in-memory configurations. Specifically, a computational inference model may analyze historical check-in data points of the plurality of data points reflecting prior visits by respective users at one or more identified establishments, organize those data points according to temporal parameters such as day of week, time of day, seasonal period, etc., and/or generate predictions regarding the likely future presence of those users at identified establishments during temporal conditions corresponding to a searching user’s query. Resulting predicted future locations allow a searching user to identify not only where desired social prospects have been in the past, but where they are statistically likely to be in the future, enabling the searching user to plan their visit to an establishment at a time most likely to result in encountering compatible social prospects in person.

FIG. 16C illustrates an example screenshot 1600C from a mobile application of a “check out” feature associated with a single establishment matching search criteria of a user of a mobile application. As with the screenshot 1600A in FIG. 16A, this screenshot 1600C again illustrates a particular establishment selected by a user. As such, details 1680 about an establishment may again be provided to a user. This screen 1600C may be presented to a user after the user has checked in at a selected establishment. While remaining at an establishment, the user may remain checked in. As such, this screen 1600C may present a “Check out” button 1690 that a user may select when they are leaving an establishment. As with the “Check in” button discussed above, when a user checks out from an establishment, his mobile application may provide his checked out status to a platform or service, which in turn may provide that status to other mobile applications of other users. In some embodiments, an application can automatically check out a user when that user leaves an establishment. For example, location technology on a mobile device on which an application is executing can confirm that a user’s geographic location no longer coincides with an establishment. Such embodiments are advantageous in situations when users forget to select the Check out button 1690 when they leave an establishment so that other users are not falsely informed that the user is located at the establishment after they have left.

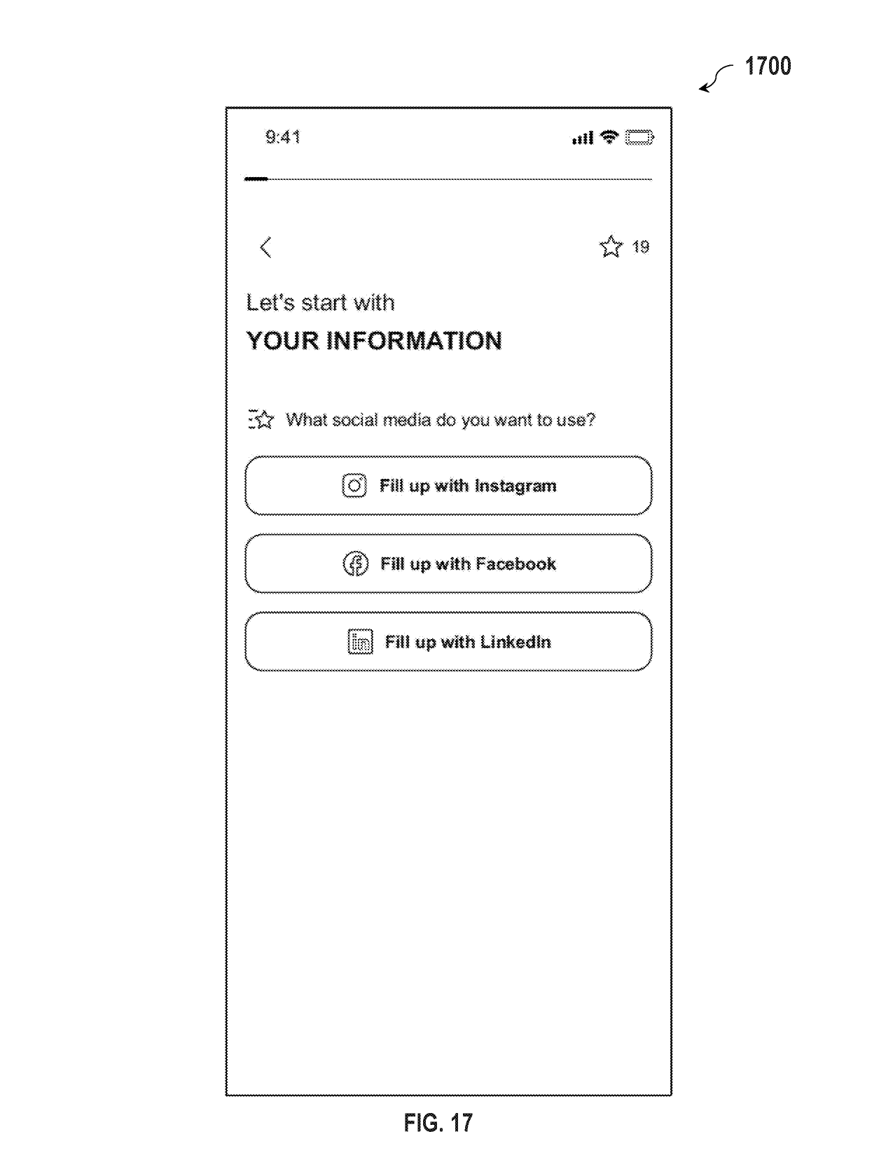

Referring now to FIG. 17, illustrated is an example screenshot 1700 from a mobile application, for use with a platform or service in accordance with the disclosed principles, presenting a user of the mobile application an option to integrate with one or more social media profiles of the user. As with situations described above where a user may use one or more of their social media profiles to create an account with a platform or service, the user can elect to integrate one or more of their social media profiles with the platform or service via a mobile application to assist with providing information about the user to other users and assisting with determining search criteria that would be desirable to the user.

After a user integrates a social media profile with a platform or service, his mobile application or the platform or service can scrape data from the users integrated profile. This scraped data can not only be used to create a users account, but may be used to automatically determine certain search criteria associated with the user. For example, such search criteria may be determined based, at least in part, on interests and other information gathered from a user’s integrated social media profile. In addition to traditional data scraping tools, AI may be employed to determine characteristics, interests, and other information personal to a user and which may be used to determine what characteristics potential social prospects should have that would be attractive to the user. For example, if a data scraping or AI tool can detect that a user has posted about certain types of pets or certain activities, then that information can be used to find potential matches for the user. Such determinations may be advantageous in situations where a user employs the disclosed platform or service for romantic goals; however, similar determinations may be used to determine other types of prospects that may be of interest to the user. For example, if a user’s social media profile revealed he or she was in a particular business, then prospects having characteristics that may be advantageous for the user to meet for business purposes can also be determined.

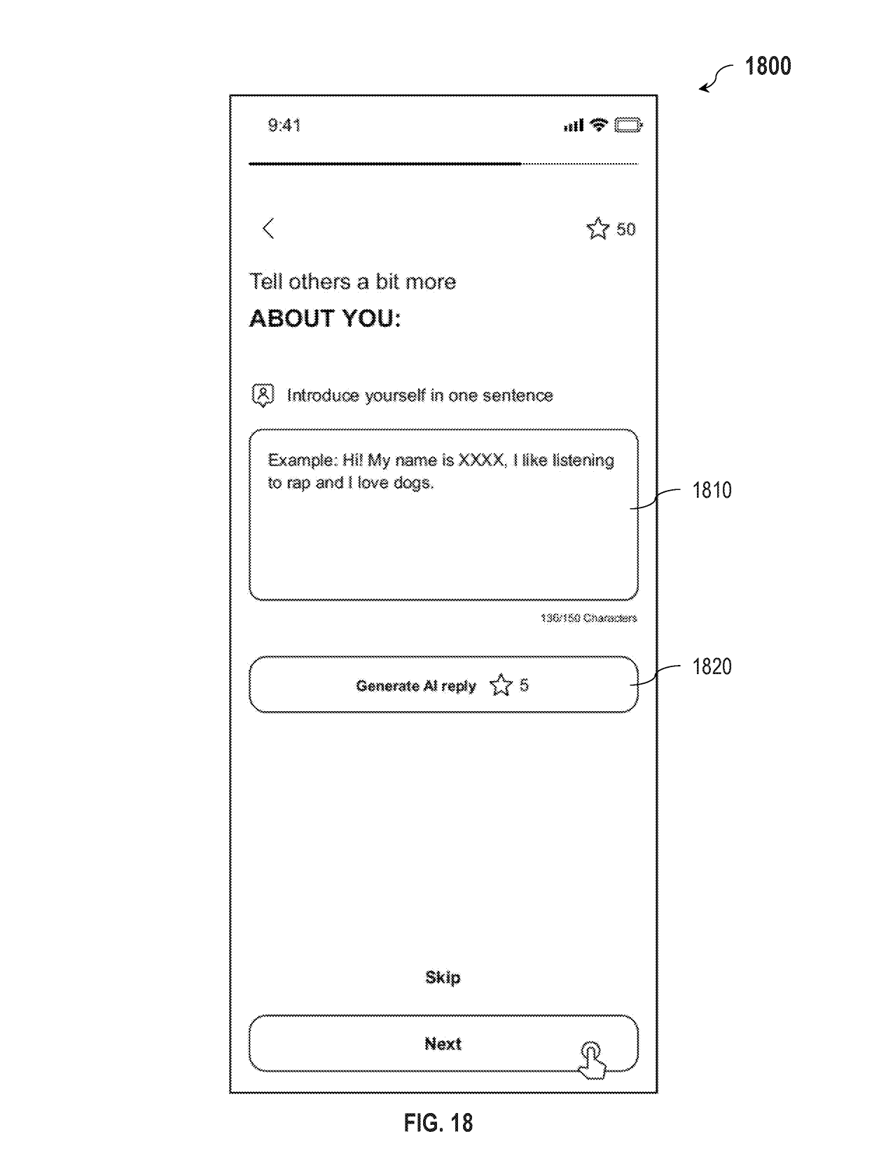

Looking now at FIG. 18, illustrated is an example screenshot 1800 from a mobile application, for use with a platform or service in accordance with the disclosed principles, presenting a user of the mobile application an option to have an AI engine determine search criteria for social prospects on behalf of the user. As mentioned above, users of a mobile application may integrate one or more of their social media accounts with a platform or service to import information about a particular user into their account. After doing so, an application may offer a user the opportunity to provide a description in a text box 1810 about themselves, including personal characteristics, interests, and perhaps details regarding what characteristics found in potential social prospects would interest them.

Alternatively, a mobile application may offer a user the opportunity, for example, via a button 1820, to have an AI engine create such a description about the user. If an AI option is selected by a user, an AI can evaluate the user’s integrated social media account(s) to develop a description about the user’s personality, interests, and the characteristics the user would likely like to see in potential social prospects they would meet through a platform or service. As discussed above, this may comprise, for example, an AI evaluating details about a user found in their integrated account(s), the user’s posts and messaging, images the user posted, “liked” or commented on, what others have comments or “liked” about the user or his/her posts, and any other information the AI can garner regarding the user. An AI may then use that information to determine search criteria on behalf of a user that the AI “believes” will find good matches for the user. As mentioned above, an AI engine may also be useful in helping a user write or develop or adjust the detail of his/her profile to promote characteristics the AI engine determines may be attractive to other users on a platform or service, and thus help those potential social prospects seek out the user.

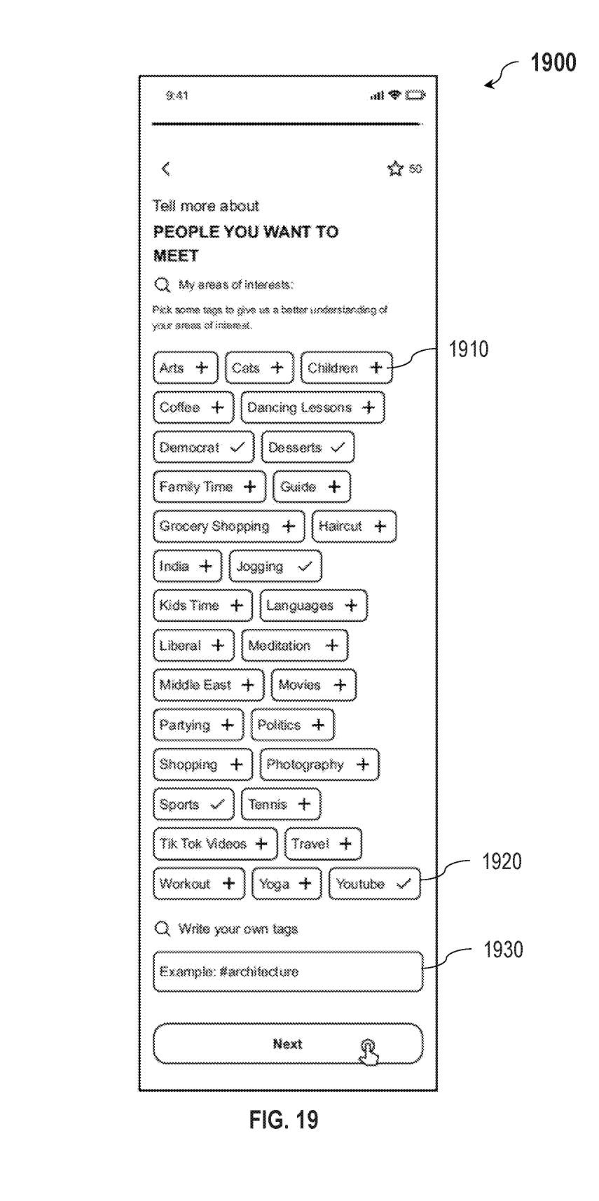

Turning to FIG. 19, illustrated is an example screenshot 1900 from a mobile application, for use with a platform or service in accordance with the disclosed principles, presenting a user of a mobile application selection options from available search criteria for finding social prospects. In this embodiment, an AI engine has scraped one or more of a user’s social media accounts and determined a plurality of characteristics the AI thinks would be of interest to the user if found in social prospects. As mentioned above, an AI engine can determine these potential interests by evaluating information found in a user’s integrated social media accounts.

As illustrated, a mobile application can permit a user to select which characteristics the user fells are most important for him/her to find in potential social prospects. Such selected tags 1920 may then be given greater weight by a search engine of a platform or service when conducting searches for social prospects on behalf of the user. A user may also be given the ability to delete certain presented characteristics if the user believes those attributes are not of interest to him/her, or perhaps does not what them taken into account during a search for prospects. Additionally, a dialog box 1930 may be provided via an application so that users may input other characteristics not previously displayed. Any number of characteristics may be employed by an application and/or platform or service, as desired. Moreover, characteristics may be presented in separated categories, and presented on multiple pages, as needed or desired.

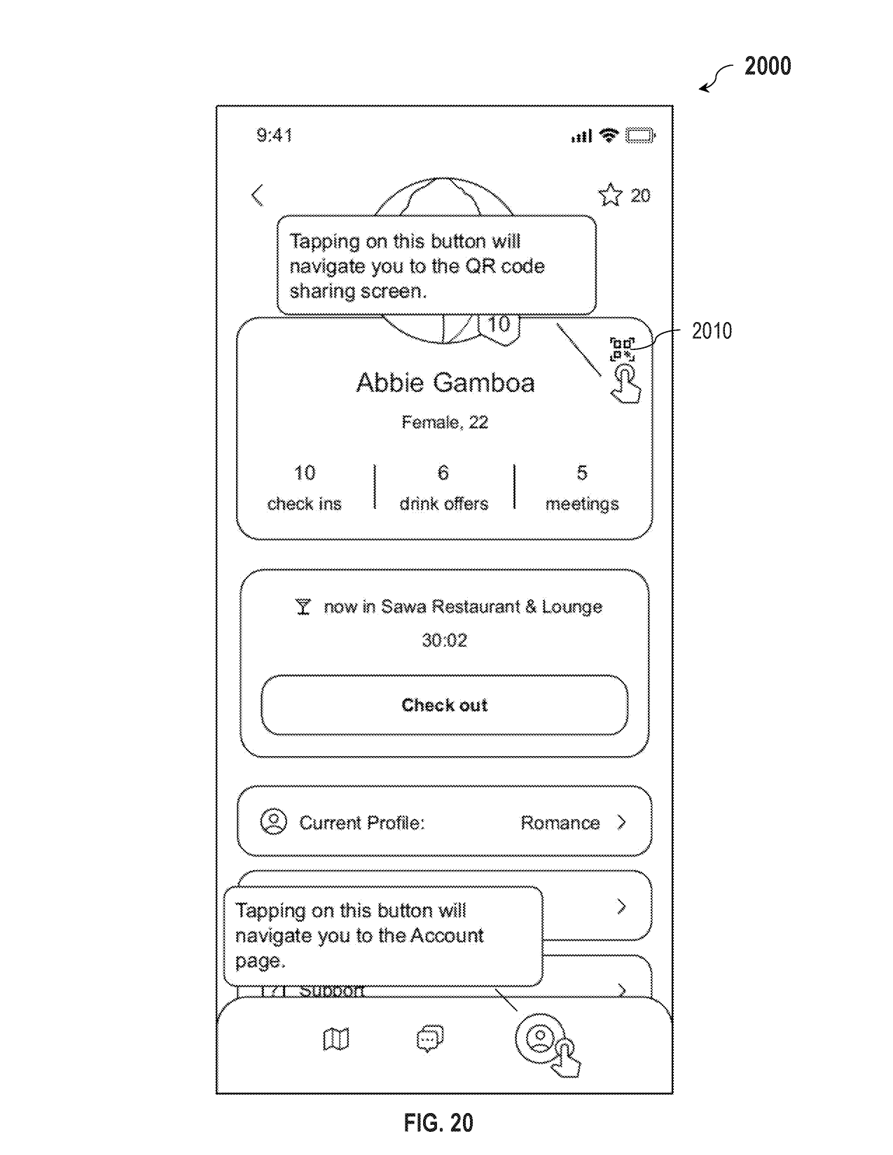

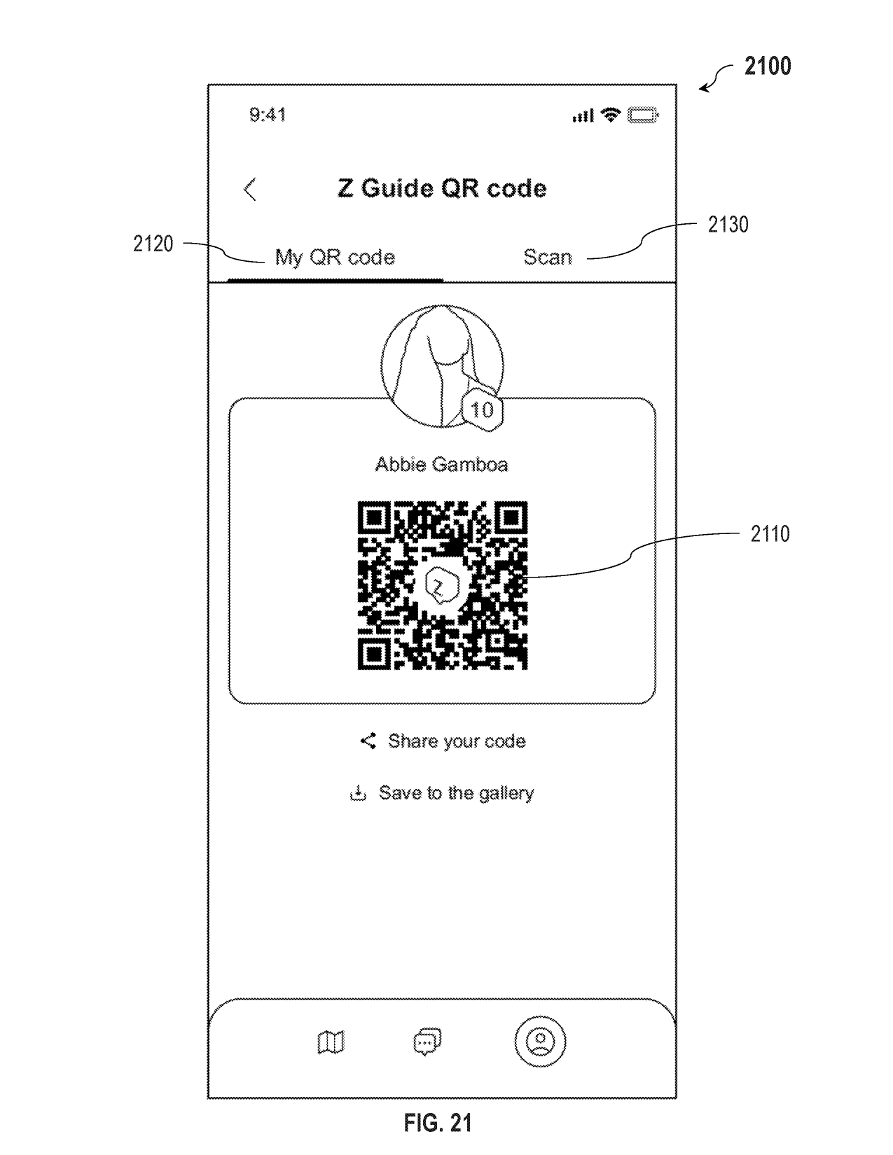

FIG. 20 illustrates an example screenshot 2000 from a mobile application, for use with a platform or service in accordance with the disclosed principles, of the profile page of a user of an application who has checked in at a particular establishment. The illustrated profile page is similar to those discussed above; however, now an illustration of the selection of a QR code button 2010 is shown. Selecting the QR code button 2010 may open a new screen, shown in FIG. 21, and/or present a pop up screen that displays a QR code that is unique to a particular user.

Looking at FIG. 21, illustrated is an example screenshot 2100 from a mobile application of a QR Code 2110 associated with a user of the mobile application shown in FIG. 20. Displaying a user’s QR code 2110, e.g., via a “My QR code” tab or button, 2120, may allow other users to scan their QR code 2110, which in turn can provide useful information about the user to the scanning user. This information may then be automatically saved in a mobile application of a scanning user or otherwise linked to the scanning user’s application via connection to a platform or service. Also on this page is a “Scan” tab or button 2130 that may permit a particular user to scan another user’s QR code (not illustrated).

Such information may include, but is not limited to, personal details about a user (e.g., name, age, gender, sexual orientation, religion, etc.), contact information of the user (e.g., email address, phone number, physical address, etc.), interests of the user, characteristics associated with the user (e.g., determined by an AI engine for the user), current and historical activity of the user on a platform or service, reason(s) the user is on the platform or service, the user’s occupation and perhaps work schedule, and any other information that may be useful or of interest to other users/social prospects on the platform or service. Also, users may have the ability to amend information that is shared to other users via their QR code 2110. Further, certain categories of users on a platform or service may share only certain types of information via their QR code 2110. For example, workers or other people associated with a particular establishment may have just their first names and work schedule to scanning users so that their “regulars” will know when the person is working at their particular establishment. In a business networking embodiment, a user’s QR code may be scanned by another business prospect such a user’s occupation, position, work schedule, etc., may be provided to a scanning user, and perhaps also the type of business interest(s) the user is hoping to find in other prospects via a platform or service. In a child playmate embodiment, a user’s QR code may provide information to a scanning user such as the user’s name and/or parent’s name, the activities a child is participating in (and perhaps their schedule for such activities), the child’s school information, the child’s parent’s preferred days, time and location for playdates, and any other information that would be useful for children to connect as friends or playmates via the platform or service.

In one or more embodiments, a platform may support a specialized designation for users associated with particular establishments, such as service workers or staff members, herein referred to as service worker configurations. A user may receive or self-designate a service worker designation via a platform. Upon receiving such a designation, a host application may electronically process an availability designation received from a particular first in-memory configuration. An availability designation may specify one or more establishment profiles for establishments at which a service worker is employed or scheduled to be present, along with one or more temporal parameters reflecting the service worker’s scheduled availability, such as specific dates, times, and/or recurring schedules. Importantly, an availability designation excludes personal contact information associated with a given first in-memory configuration, such as a service worker’s personal phone number or personal email address, thereby protecting the service worker’s privacy while still enabling their patrons and interested users to know when they will be present at a given establishment.

A host application may electronically transmit one or more digital signals comprising an availability designation to one or more requesting remote user devices associated with first in-memory configurations that have a prior confirmed association with, or expressed interest in, a particular service worker in-memory configuration. In addition, a host application may electronically generate one or more notification signals transmitted to requesting remote user devices upon a determination that one or more temporal parameters of an availability designation correspond to one or more input parameters of a structured string of values (search query) received from those requesting remote user devices, that is, when a service worker’s scheduled availability matches a time period that an interested user is searching for or has indicated interest in. This functionality is particularly useful in social contexts where users form preferences for specific service workers at establishments, enabling them to plan their visits around a service worker’s schedule and increasing the likelihood of a desired in-person social interaction.

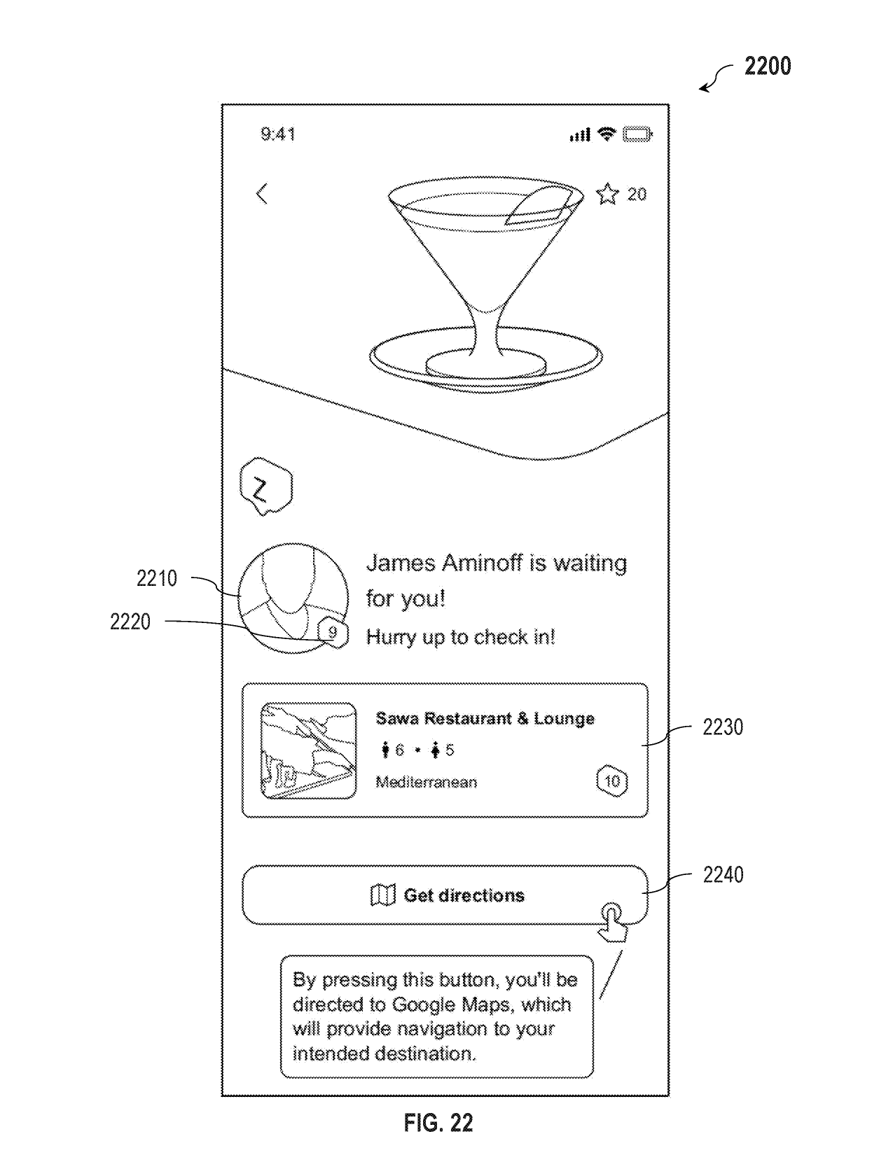

FIG. 22 illustrates an example screenshot 2200 from a mobile application, for use with a platform or service in accordance with the disclosed principles, presenting a user of a mobile application a social prospect matching the search criteria of the user as well as their current location at an establishment. Such an example screen of an application may provide images of the prospect 2210, the prospect’s rating factor 2220, and an establishment at which the prospect is currently located 2230. Additionally, such a screen may inform a user if a prospect is “offering a drink”, “offering a cup of coffee”, and/or any other status information the prospect has elected to share. A “Get directions” button 2240 may also be provided so that a user can quickly receive directions, e.g., via a navigation application on the user’s mobile device, to an establishment where the prospect is currently located. To obtain additional information about a prospect, a user may click or select an image of the prospect.

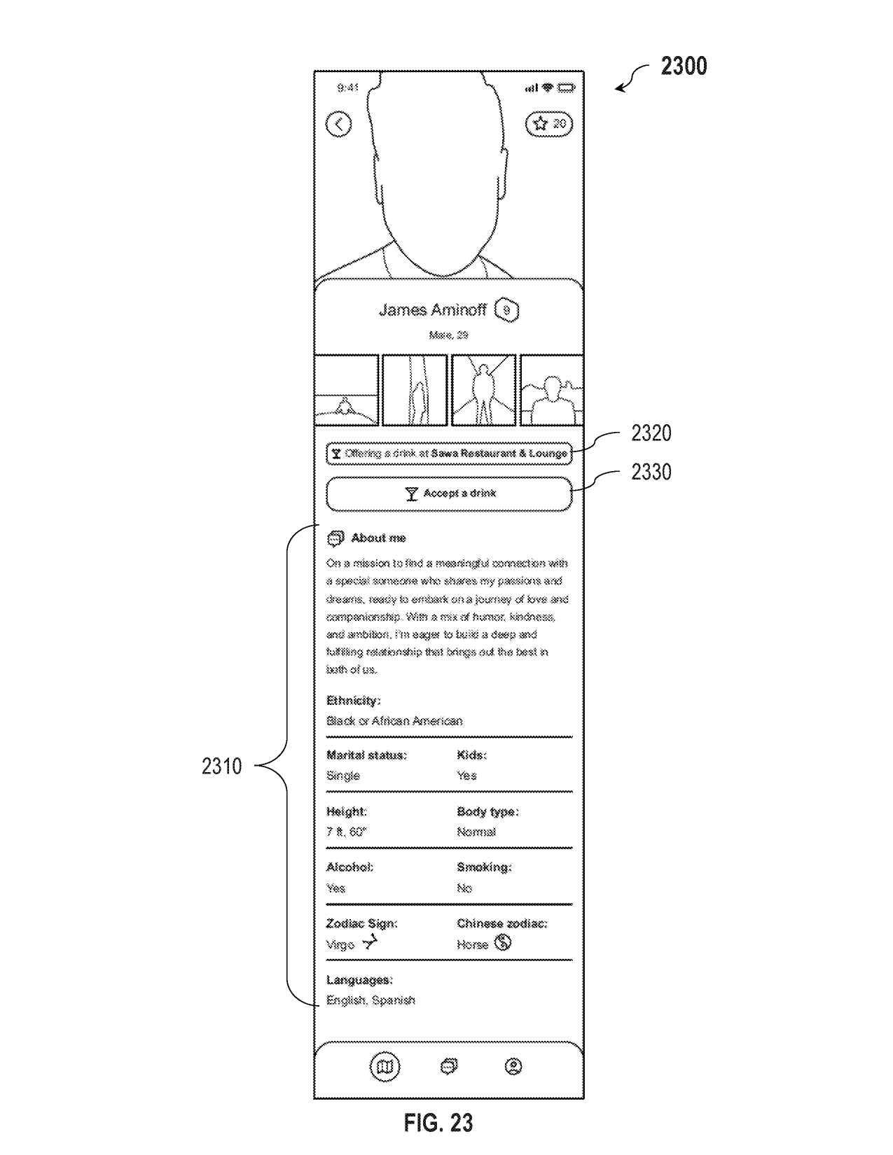

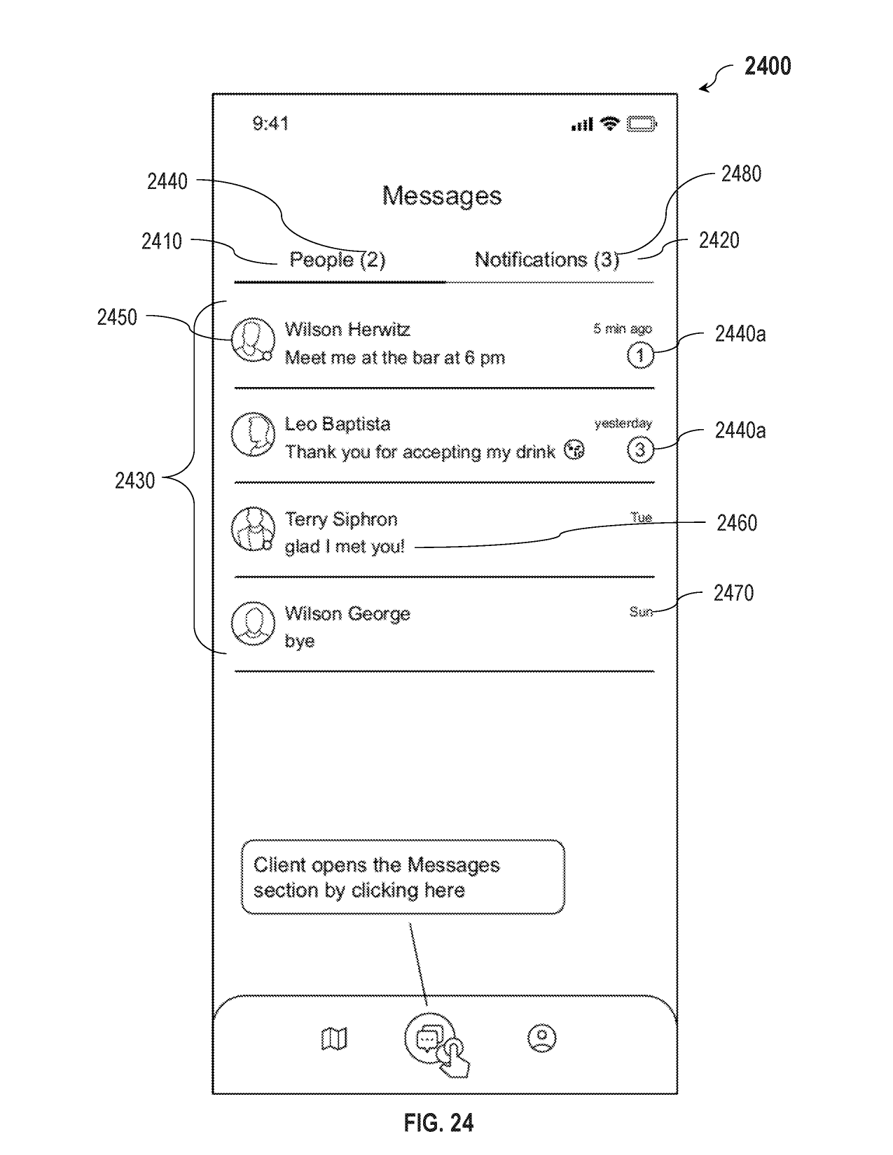

FIG. 23 illustrates an example screenshot 2300 from a mobile application of FIG. 22 and which is presenting to a user of the mobile application a public profile of a social prospect of FIG. 22. A viewable profile of a prospect can provide a user a number of additional details 2310 about the prospect. Also, other images a prospect has elected to post on his profile may also be accessible to a user. This screen may also inform a user if a prospect is “offering a drink” 2320 or “offering a cup of coffee”. Additionally, a screen may permit a user to “Accept a drink” via button 2330, where doing so would send a message or notification to a prospect indicating the user’s “acceptance” of a drink (or cup of coffee or to simply to meet up). Such an acceptance or similar communication from a user to the prospect may also allow messaging or other direct communication with a prospect, such as the messaging illustrated in FIG. 24 and discussed below. Alternatively or additionally, messaging with a prospect may be initiated by a user via a messaging button 2340 on a screen. A map button 2350 may also allow a user to get directions to a prospect’s current location, as discussed above. A contacts button 2360 may also be provided on this and other screens discussed herein.

Turning finally to FIG. 24, illustrated is an example screenshot 2400 from a mobile application of a messaging feature for a user of a mobile application to communicate with potential social prospects associated with a platform or service as disclosed herein. A Messages screen, which may be accessed by a button at the bottom of a screen, may include two tabs, a “People” tab 2410 and a “Notifications” tab 2420. When the People tab 2410 is selected, as illustrated, a list 2430 of social prospects the user has been messaging with may be displayed. The label of the tab 2410 may also have an indicator 2440 indicating a number of prospects found in a list of people a user has messaged with, and/or it may indicate a number of unread messages 2440 a from a list of prospects. In other embodiments, both may be indicated on the People tab 2410.

When the list of prospects is displayed, settings on a Messages screen may display not only names of particular prospects a user has messaged with, but also an image 2450 of the prospects, and perhaps a preview of the last message 2460 received from the prospects. As shown, emojis may also be available. Still further, the date and/or time 2470 of messages exchanged with particular prospects may also be displayed. Clicking on a prospect in the list can open a new page or produce a pop up window (not illustrated) that displays the entire conversation of messages with the selected prospect. Message conversations may be deleted or saved, or only certain messages may be deleted or saved.

In one or more embodiments, a messaging feature of the platform may be used by a searching user to send a direct communication to another particular user profile that has a historical association with one or more identified establishments, even if that user is not currently present at an establishment. In such embodiments, a host application may electronically process a direct communication received from a requesting remote user device, the direct communication comprising an invitation to establish a confirmed association between a recipient profile and a specified second profile, that is, an invitation to meet in person at a specified establishment at one or more specified temporal parameters, such as a proposed date and time. A host application may electronically process a response to a direct communication received from a remote user device associated with a recipient profile. A response may comprise, for example, either an acceptance or a declination of a proposed in-person meeting. A host application may then electronically transmit one or more digital signals comprising a response to a requesting remote user device via a communications network, allowing a searching user to receive a recipient’s answer and make plans accordingly. This feature leverages the platform’s establishment and user matching functionality to facilitate purposeful, location-specific in-person socialization, rather than requiring users to determine a meeting place independently.

When the Notifications tab 2420 is selected by the user, a list of notifications received by the user may be displayed. For example, notifications may include only prompts by prospects to a user, but in other embodiments notifications may even include notifications from a platform or service as well. As with the People tab 2410, the Notifications tab 2420 may also have an indicator 2480 indicating the number of notifications found in a list of notifications, and/or it may indicate the number of unread notifications received from a user’s prospects. In other embodiments, both may be indicated on the Notifications tab 2420.

### Example Incentive System

Another advantage of a platform or service in accordance with the disclosed principles, and which may also be implemented via a mobile application as discussed above, is the use of an incentive system to assist users with finding and meeting potential social prospects. This incentive system may function as a type of virtual currency within a platform or service, and incentivizes users to be open and honest with other users, and to encourage good behavior and deter bad behavior on a platform or service. In example embodiments, an incentive system can start users with an introductory number of stars or any other type of points or currency, where users earn such stars by performing certain actions on a platform or service, and can lose stars by doing certain actions that are considered at least somewhat detrimental.

In some embodiments, incentive currency may be called “Z Stars”, keeping with the branding of “Z Guide” for the mobile application example embodiment discussed in FIGS. 13A-24 above. Of course, any name may be adopted for the virtual currency or points implemented on a platform or service as disclosed herein. Looking briefly back at FIG. 16B, the example embodiment disclosed therein illustrates a user starting with a default of 20 Z Stars, shown at the top-right corner of an application screen. In some embodiments, the beginning amount of Z Stars may be a maximum permitted, and users can only lose stars and earn them back via their actions on a platform or service. In other embodiments, users may start with a default number of Z Stars, and then can gain or lose stars to an ongoing number of Z Stars above or below that beginning number. In such embodiments, a maximum number of stars may be set, while in other embodiments, no maximum of potential stars a user may earn is set.

As shown in the example embodiment of FIG. 16B, a user may earn one or more Z Stars by simply “checking in” at a particular establishment. This may be considered positive or beneficial behavior since it involves a user being active on a platform or service, and, in particular, may allow other users to know that the initial user has made public their presence at an establishment. Additionally, if a user not only checks in but also sets their status as desiring to “offer a drink” in general or to a particular user, the offering user may earn a predetermined number of Z Stars since this is activity that promotes social interaction on a platform or service. In some embodiments, offering a drink may be detrimental, for example, if a user is determined by a platform to offer too many drinks. Other actions that can cost users stars could be a lack of interaction on a platform, as well as ignoring some or any “offers” of a drink or cup of coffee, etc. by other users.

As also illustrated, if a user let’s AI write their check in status, this may cost the user a certain number of stars since this may be considered lazy behavior, as opposed to the user taking the time to prepare a personalized status. Of course, in other embodiments, using an AI engine for taking some actions on the platform may be seen as helpful, and thus rewards a user with new stars. This could be if a user employs AI to conduct a search for potential social prospects, and/or employs AI to assist the user in setting up their profile so that they may be more attractive to other searching users. In other embodiments, these actions may be deemed detrimental in certain situations, and thus would cost a user a predetermined number of stars rather than earning stars. In some embodiments, earning or costing stars for certain actions may be determined by a platform or service on a user-by-user basis, based, at least in part, on the history of particular users’ actions on the platform.

Additional examples of behavior by a user that could cost that user stars could be if the user hides their age on their profile, does not provide a profile picture, and/or if the user is determined by other users (e.g., rated) to not look like their provided profile photo, and thus is seen as deceiving to other users. Conversely, users may earn stars by providing updated profile photos, which can be corroborated by the time/date, as well as location, capabilities of a user’s mobile device. In some embodiments, a platform or service in accordance with the disclosed principles may require users to provide a new profile photo, such as a “selfie”, every so often (e.g., one a year), and users may be rewarded for doing so. In such embodiments, facial recognition, AI, and other technologies may also be employed by a platform or service, such as through a mobile application as disclosed herein, to confirm that a photo is in fact of a user.

In some embodiments, establishments that are users of a platform or service as disclosed herein may also have an incentive-based system. For example, locations/establishments may be incentivized to use a platform (e.g., through a mobile application as discussed above or by another means) to encourage users to visit their establishments. Additionally, such encouragement may be a monetization opportunity for a platform or service. For example, establishments may pay a fee (single or recurring) to have their location promoted to users of a platform or service, and who are conducting a search for locations to meet potential social prospects. Also, establishments may, depending on their membership with the platform or service, advertise specials and events they may have. Such establishment users may also earn or lose stars in a virtual currency based, at least in part, on their activities (or lack thereof) on a platform. For example, establishments may earn stars by participating in promotions and for offering specials to users of a platform, but may lose stars for not regularly doing so. Still further, establishments may earn stars from users that visit their location, which may be by rating the establishments using any advantageous criteria. Establishments may even provide incentives to users for taking the time to rate an establishment, such as awarding free drinks or food, etc. in exchange for providing ratings. Similarly, establishments may lose stars if ratings provided by users are negative, but also gain stars if the ratings are positive.

### Example Artificial Intelligence Implementations

Advantageously, most or all of the functionality of a platform, service and mobile application discussed above may be implemented or assisted by the use of artificial intelligence. Those skilled in the pertinent fields of art are knowledgeable about the development and use of artificial intelligence, and thus a detailed discussion of these will not be included here. However, the implementation of AI into some or all the unique functionality of a platform or service designed or constructed in accordance with the disclosed principles results in novel applications and results. For example, as mentioned above, AI may be used by users of a platform or service to help draft details of a profile, which would be visible to other users/social prospects. In such embodiments, AI may be used to examine other online information about a user creating an account, such as the user’s various social media profiles. AI may not only do a better job of including all relevant information about a user that the user may forget to put in his new profile, but may also better present that information. Such better presentation may also be tailored to a user’s purpose for using a platform or service, such as tailoring his profile for the best presentation to potential romantic prospects, and/or tailoring his profile for the best most professional presentation to potential business prospects he could meet on the platform.

Other potential implementations of AI for users creating or updating their profiles on a platform or service is the use of AI to help craft a message to a specific social prospect a user would like to meet. In such embodiments, the AI engine could examiner a prospect’s profile in order to craft an ideal message to that person to meet/impress them, whether for romantic or business purposes, and/or perhaps even simply to find common activities to invite the person to do. In other similar implementations, AI may be used to update users’ profiles based, at least in part, on what the AI determines might be more attractive to what other people using a platform or service seem to like or what they are or have been looking for when using the platform or service. In such embodiments, an AI engine may examine a user’s profile and then make suggestions that a user could accept or reject, as desired. Similarly, AI may be implemented to update a user’s profile based, at least in part, on what might be more attractive to another specific profile found by the user. For example, a user could select that found profile of a person they would like to meet, and then ask an AI to suggest changes to the user’s profile to make user a better “match” for that person. Then, when that person searches on a platform or service for potential social prospect matches, there is a greater likelihood that the user’s profile will be found in that search as a potential match.

In one or more embodiments, a host application may electronically update a computational inference model and composite score calculations described herein based, at least in part, on one or more of the following categories of incoming data points: real-time aggregated data points received from remote user devices and external data sources via the communications network; confirmed associations between first and second profiles, such as confirmed check-ins by users at identified establishments; subjective ratings received from first profiles reflecting qualitative assessments of establishments or other users; user-reported feedback submitted via a platform’s feedback interface; or any combination thereof. Continuous updating of a computational inference model with incoming real-time data may ensure that search results, composite scores, and predicted future locations reflect the most current available information about establishment attendance patterns and user characteristics.

In such embodiments, updates to a computational inference model may be applied in a temporally segmented manner. Specifically, incoming data points associated with one or more temporal parameters, such as a particular time of day, day of week, month, season, etc., may update only a temporal segment of a computational inference model corresponding to those temporal parameters, rather than updating the model globally across all temporal conditions. For example, feedback received on a Saturday night at 11:00 PM updates only a temporal segment of the model associated with Saturday nights, leaving temporal segments corresponding to weekday mornings or other distinct periods unaffected. This temporally segmented updating approach preserves the integrity of time-specific behavioral patterns captured in the model, ensuring that temporal variation in venue attendance and social prospect availability is accurately reflected across different search conditions. Composite score calculations may similarly be updated in a temporally segmented manner, such that subjective and objective components of scores presented to searching users are continually refined based, at least in part, on the most recently received and temporally relevant data.

In yet other implementations, AI could be used to suggest what locations during a user’s geographic search for social prospects might be better to meet certain types of people. Such AI-based customization may be based, at least in part, on a user’s past visitation history to certain establishments, a history of people/users that have visited certain establishments, and a history of the characteristics associated with the people that visit certain types of establishments. Also, AI may be implemented to find additional potential matches for a user once that user has previously found a matching prospects. For example, once a user finds a matching prospect, the user could query the AI to find additional people who are similar to an original matching prospect. The AI may also be implemented to suggest certain people as potential matches for a user based, at least in part, on that user’s past searches for certain characteristics of people, such as age, interests, body types, whether they have children or not, income, job type, etc. In such embodiments, the AI may assist a user in finding certain characteristics in potential matches that the user did not realize they were attracted to. In short, AI may be implemented into facets of the disclosed principles to bolster the benefits and advantages of platforms and services as disclosed herein. In this respect, a platform or service as disclosed herein can provide users the unique and novel capabilities of searching for and finding potential social prospects, and AI can assist with that searching and finding in a manner that would provide benefits to users that their searches alone may not enjoy.

While this disclosure has been particularly shown and described with reference to preferred embodiments, it will be understood by those skilled in the art that various changes in form and detail may be made therein without departing from the spirit and scope of the present disclosure. It is expected that skilled artisans employ such variations as appropriate, and it is intended that the present disclosure is practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described example embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Section headings herein are provided for consistency with the suggestions under 37 C.F.R. 1.77 or otherwise to provide organizational cues. These headings shall not limit or characterize the present disclosure(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in the claims. Rather, as the claims reflect, inventive subject matter lies in less than all features of a single disclosed embodiment. Thus, the following claims are hereby incorporated into the Detailed Description, with the claims standing on their own as separate embodiments.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
electronically processing, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically processing a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof; and
electronically maintaining, via the host application, one or more leaderboard data structures ranking the plurality of first in-memory configurations by a first score computed for one or more geographic regions, the popularity score being computed based, at least in part, on one or more of the following: a number of first in-memory configurations that have accessed or requested access to a particular first in-memory configuration; a statistical frequency at which the particular first in-memory configuration appears in identified search results generated in response to structured strings of values received from other requesting first in-memory configurations; an electronically-verifiable collective assessment provided via the host application; or any combination thereof.

2. The method of claim 1, and further comprising:
electronically matching the one or more input parameters against one or more of the following: the respective first collection of elements; the respective second collection of elements; the aggregated data points; or any combination thereof, to identify a subset of second in-memory configurations having a threshold number of elements corresponding to the one or more input parameters, and to identify a subset of first in-memory configurations associated with the identified subset of second in-memory configurations and sharing a threshold number of elements with the requesting first in-memory configuration.

3. The method of claim 2, and further comprising:
electronically ranking the identified subset of first in-memory configurations based, at least in part, on a popularity score derived from one or more of the following: a social network reach associated with a given first in-memory configuration; a frequency at which the given first in-memory configuration is associated with identified second in-memory configurations; a demand for access to the given first in-memory configuration; or any combination thereof;
electronically ranking the identified subset of second in-memory configurations based, at least in part, on one or more elements of the respective second set-data structures or the aggregated data points; and
electronically transmitting, via the host application, one or more digital signals comprising the ranked subset of first in-memory configurations and the ranked subset of second in-memory configurations to the requesting remote user device via the communications network.

4. The method of claim 3, and further comprising:
electronically calculating, via the host application, composite scores for the identified subset of second in-memory configurations, the composite scores respectively comprising a first score and a second score, wherein:
the first score is calculated based, at least in part, on the identified subset of second in-memory configurations having a threshold number of elements corresponding to the one or more input parameters, the first score being a substantially objectively quantifiable value; and
the second score is calculated based, at least in part, on input values received from the external data sources via the communications network for the identified subset of second in-memory configurations, the second score being a substantially subjectively quantifiable value.

5. The method of claim 4, and further comprising:
electronically updating, via the host application, a computational inference model and the composite score calculations based, at least in part, on one or more of the following incoming data points: real-time aggregated data points; confirmed associations between first in-memory configurations and second in-memory configurations; subjective ratings received from first in-memory configurations; user-reported feedback; or any combination thereof;
wherein updates are applied in a temporally segmented manner such that incoming data points associated with one or more temporal parameters update only the temporal segment of the computational inference model corresponding to the one or more temporal parameters associated with the incoming data points.

6. The method of claim 4, wherein the second score is further derived by:
receiving subjective ratings from first in-memory configurations having stored elements corresponding to those of the requesting first in-memory configuration;
associating the received subjective ratings with one or more temporal parameters comprising a date, time, and day of week at which the ratings were submitted; and
weighting the received subjective ratings based, at least in part, on temporal relevance such that ratings submitted during temporal parameters comparable to those of the requesting first in-memory configuration receive greater weight than ratings submitted during non-comparable temporal parameters;
wherein the received subjective ratings reflect exclusively elements pertaining to the suitability of the respective second in-memory configuration for purposes corresponding to the elements of the requesting first in-memory configuration, and expressly exclude elements pertaining to non-corresponding characteristics of the respective second in-memory configuration.

7. The method of claim 5, wherein the weighting of the received subjective ratings further comprises:
electronically applying, via the host application, a seasonal weighting factor to the received subjective ratings such that ratings submitted during a season, month, or date range corresponding to one or more temporal parameters of the structured string of values receive greater weight than ratings submitted during non-corresponding seasons, months, or date ranges.

8. The method of claim 2, wherein the locations associated with the identified subset of first in-memory configurations are predicted future locations electronically generated by a computational inference model based, at least in part, on aggregated data points indexed according to one or more temporal parameters and reflecting behavioral patterns associated with the identified subset of first in-memory configurations.

9. The method of claim 1, and further comprising:
electronically identifying, via the host application, a subset of second in-memory configurations as hotspot configurations based, at least in part, on a concentration of first in-memory configurations having elements corresponding to those of the requesting first in-memory configuration that are currently associated, predicted to be associated, or have historically been associated during comparable temporal parameters with the respective second in-memory configurations; and
electronically transmitting, via the host application, one or more digital signals comprising the identified hotspot configurations with elevated prominence relative to non-hotspot second in-memory configurations to the requesting remote user device via the communications network.

10. The method of claim 1, and further comprising:
electronically transmitting, via the host application, one or more digital signals comprising the one or more leaderboard data structures filtered according to one or more categorical parameters associated with the respective first collection of elements, the one or more categorical parameters comprising one or more of the following: friendship; business networking; romance; or any combination thereof, to the requesting remote user device via the communications network.

11. The method of claim 9, and further comprising:
electronically processing, via the host application, a monetization designation received from a given first in-memory configuration, the monetization designation conditioning access to one or more of the following: the given first in-memory configuration; network connections associated with the given first in-memory configuration; or data outputs derived from the given first in-memory configuration; upon receipt of a fee parameter specified by the given first in-memory configuration, the given first in-memory configuration thereby being designated a monetized first in-memory configuration;
electronically processing, via the host application, a payment transaction received from the requesting remote user device in connection with the fee parameter; and
electronically transmitting, via the host application, upon confirmation of the payment transaction, one or more digital signals granting the requesting first in-memory configuration access to the monetized first in-memory configuration to the requesting remote user device via the communications network.

12. The method of claim 1, and further comprising:
electronically processing, via the host application, a direct communication received from the requesting remote user device addressed to a given first in-memory configuration having a historical association with one or more second in-memory configurations, the direct communication comprising an invitation to establish a confirmed association between the given first in-memory configuration and a specified second in-memory configuration at one or more specified temporal parameters;
electronically processing, via the host application, a response to the direct communication received from a remote user device associated with the given first in-memory configuration, the response comprising one or more of the following: an acceptance; or a declination; and
electronically transmitting, via the host application, one or more digital signals comprising the response to the requesting remote user device via the communications network.

13. The method of claim 1, and further comprising:
electronically processing, via the host application, an availability designation received from a given first in-memory configuration designating the given first in-memory configuration as a service worker configuration, the availability designation comprising one or more second in-memory configurations, and one or more temporal parameters, and excluding personal contact information associated with the given first in-memory configuration;
electronically transmitting, via the host application, one or more digital signals comprising the availability designation to one or more requesting remote user devices associated with first in-memory configurations having a prior confirmed association with, or expressed interest in, the given first in-memory configuration via the communications network; and
electronically generating, via the host application, one or more notification signals transmitted to the one or more requesting remote user devices upon a determination that the one or more temporal parameters of the availability designation correspond to one or more input parameters of a structured string of values received from the respective requesting remote user devices.

14. The method of claim 1, and further comprising:
electronically processing, via the host application, an onboarding request received from a remote user device via the communications network, the onboarding request comprising one or more identifying elements and one or more socialization characteristic elements associated with a candidate second in-memory configuration;
electronically executing, via the host application, one or more verification operations on the onboarding request to confirm a legitimacy of the candidate second in-memory configuration prior to inclusion in the plurality of second in-memory configurations; and
electronically generating, via the host application, upon successful completion of the one or more verification operations, a new second in-memory configuration comprising a corresponding second set-data structure having a second collection of elements derived from the onboarding request, the new second in-memory configuration being made available for inclusion in identified subsets of second in-memory configurations and composite score calculations.

15. The method of claim 1, and further comprising:
electronically processing, via the host application, one or more revised elements received from the requesting remote user device via the communications network pertaining to a given first in-memory configuration observed in association with a confirmed second in-memory configuration; and
electronically updating, via the host application, the first set-data structure of the given first in-memory configuration to incorporate the one or more revised elements into a subjective component of the popularity score associated with the given first in-memory configuration.

16. The method of claim 1, further comprising:
electronically processing, via the host application, a structured string of values comprising one or more input parameters received, from a requesting remote user device associated with a requesting first in-memory configuration via the communications network, the one or more input parameters comprising one or more of the following: one or more personal characteristic parameters; and one or more temporal parameters; or any combination thereof.

17. The method of claim 1, wherein the first score comprises a popularity score.

18. An apparatus, comprising:
a processor coupled to a memory of at least one computing device, the processor to:
electronically process, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically process a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof; and
electronically maintain, via the host application, one or more leaderboard data structures ranking the plurality of first in-memory configurations by a first score computed for one or more geographic regions, the popularity score being computed based, at least in part, on one or more of the following: a number of first in-memory configurations that have accessed or requested access to a particular first in-memory configuration; a statistical frequency at which the particular first in-memory configuration appears in identified search results generated in response to structured strings of values received from other requesting first in-memory configurations; an electronically-verifiable collective assessment provided via the host application; or any combination thereof.

19. The apparatus of claim 18, wherein the processor is further to:
electronically transmit, via the host application, one or more digital signals comprising the one or more leaderboard data structures filtered according to one or more categorical parameters associated with the respective first collection of elements, the one or more categorical parameters comprising one or more of the following: friendship; business networking; romance; or any combination thereof, to the requesting remote user device via the communications network.

20. The apparatus of claim 19, wherein the processor is further to:
electronically process, via the host application, a monetization designation received from a given first in-memory configuration, the monetization designation conditioning access to one or more of the following: the given first in-memory configuration; network connections associated with the given first in-memory configuration; or data outputs derived from the given first in-memory configuration; upon receipt of a fee parameter specified by the given first in-memory configuration, the given first in-memory configuration thereby being designated a monetized first in-memory configuration;
electronically process, via the host application, a payment transaction received from the requesting remote user device in connection with the fee parameter; and
electronically transmit, via the host application, upon confirmation of the payment transaction, one or more digital signals granting the requesting first in-memory configuration access to the monetized first in-memory configuration to the requesting remote user device via the communications network.

21. An article, comprising
a computer-readable medium having stored thereon instructions executable by a computing device to:
electronically process, via a host application of a computing device on a communications network, one or more digital signals to generate a plurality of in-memory configurations comprising at least a plurality of first in-memory configurations and a plurality of second in-memory configurations,
the plurality of first in-memory configurations comprising corresponding first set-data structures having respective first collection of elements specific to on-line representations of off-line individual identities, and
the plurality of second in-memory configurations comprising corresponding second-set data structures having respective second collection of elements specific to on-line representations of off-line establishment identities;
electronically process a plurality of data points from external data sources, the data points processing including generating aggregated data points via one or more aggregation operations comprising one or more of the following: temporal data points aggregation; spatial data points aggregation; statistical data points aggregation; categorical data points aggregation; identifier data points aggregation; or any combination thereof; and
electronically maintain, via the host application, one or more leaderboard data structures ranking the plurality of first in-memory configurations by a first score computed for one or more geographic regions, the popularity score being computed based, at least in part, on one or more of the following: a number of first in-memory configurations that have accessed or requested access to a particular first in-memory configuration; a statistical frequency at which the particular first in-memory configuration appears in identified search results generated in response to structured strings of values received from other requesting first in-memory configurations; an electronically-verifiable collective assessment provided via the host application; or any combination thereof.

22. The article of claim 21, wherein the instructions are further to:
electronically transmit, via the host application, one or more digital signals comprising the one or more leaderboard data structures filtered according to one or more categorical parameters associated with the respective first collection of elements, the one or more categorical parameters comprising one or more of the following: friendship; business networking; romance; or any combination thereof, to the requesting remote user device via the communications network.

23. The article of claim 22, wherein the instructions are further to:
electronically process, via the host application, a monetization designation received from a given first in-memory configuration, the monetization designation conditioning access to one or more of the following: the given first in-memory configuration; network connections associated with the given first in-memory configuration; or data outputs derived from the given first in-memory configuration; upon receipt of a fee parameter specified by the given first in-memory configuration, the given first in-memory configuration thereby being designated a monetized first in-memory configuration;
electronically process, via the host application, a payment transaction received from the requesting remote user device in connection with the fee parameter; and
electronically transmit, via the host application, upon confirmation of the payment transaction, one or more digital signals granting the requesting first in-memory configuration access to the monetized first in-memory configuration to the requesting remote user device via the communications network.
